(19) United States
(12) Patent Application Publication
(10) Pub. No.: US 2010/0241507 A1
(43) Pub. Date: Sep. 23, 2010

(54) System and method for searching, advertising, producing and displaying geographic territory-specific content in inter-operable co-located user-interface components

(76) Inventors: Michael Joseph Quinn, Austin, TX (US); Darrell Jay Metcalf, Fillmore, CA (US)

Correspondence Address: Darrell Metcalf, 905 N. Oak Avenue, Fillmore, CA, 93015, US

(21) Appl. No.: 12/217,108

(22) Filed: Jul. 2, 2008

(51) Int. Cl. G06Q 30/00; G06Q 10/00; G06Q 20/00; G06F 3/048

(52) U.S. Cl. 705/14.42; 705/14.43; 705/14.47; 705/14.54; 715/777; 715/786; 715/835; 715/781

(57) ABSTRACT

A network-based, integrated advertising and data searching system, and method for implementing the system, the system enhances the advertising exposure probability of transaction-enabling, associative discernible content ‘ADC’ elements proximately arranged on a website by storing, accessing and displaying transaction-enabling ADC element-related files in accordance with search criteria which matches geographic-territory specific data-files and optionally matches, category or subject data-files. The ADC element-related files are configurable for display in one or more groupings or word-cloud like arrangements within a single user interface or webpage, and in one embodiment, display one or more transactionable offerings, for a product, service or activity associated with at least one advertiser/seller according to user-specified criteria, or in response to input made via a user input device in communication with browser-equipped apparatus. The ADC elements are co-locatable with inter-operable, and selectable co-locatable software application tools ‘CSATs’, and with selectable search user interface elements.

### CROSS-REFERENCE TO PREVIOUSLY-FILED PATENT APPLICATION

The present non-provisional patent application is related to and relies on provisional patent application 60/937,606, filed on Jun. 29, 2007, entitled “System and Method for Searching, Advertising, Producing and Displaying Geographic Territory-Specific Content in Inter-Operable Co-Located User-Interface Components”

### FIELD OF THE INVENTION

The invention relates to the field of information searching, advertising and online commerce, and more particularly to a system and method for enhancing the exposure probability and geographical territory relevancy of groupings of commerce-enabled advertising content simultaneously displayable with and contextually related to content generated by one or more co-located software application tool(s) shared among a community of network users.

### BACKGROUND OF THE INVENTION

Since the emergence of Web sites and browser equipped apparatus as the accepted software graphical user interface and equipment providing access to and navigation within a large-scale publicly-accessible network such as the internet, one of the primary challenges facing any Web site enterprise remains getting ‘eyeballs’ or an ongoing, predictable stream of Web site visitors to a given Web site or ‘site.’ Accordingly, the sites that have a track record of doing well, are the ones having one or more compelling ‘draws’ or reasons for attracting visitors and gaining customer loyalty among a multitude of internet users.

One method of improving the exposure probability of a Web site is to provide a utility or usefulness to its users which are more effective and/or easier to use than what those same users can find or use at another Web site. A good example of this principle can be illustrated in the evolution of the internet search-engine, with its compelling draw being: quickly getting users the information that they need when it is needed. In the earlier days of the search-engine, the results of interne searches were often poor if not quite frustrating to the user. For example, one might have entered the word “aircraft” as a search criterion and got a multitude of alleged pertinent ‘hits’ that listed completely unrelated subject matter perhaps as broad as ‘aquariums’ and ‘vacuum cleaners’. Such poor implementation, along with a real desire and need to search through voluminous amounts of information made available on the internet, created a real opportunity for aspiring search engine companies to try to create and implement the best way to index and search the internet.

Internet entrepreneurs also began to realize that because a multitude of users had a regular need to search internet-available information, there was an opportunity for a site effectively serving that need to display and charge for advertisements that would be seen by a regular traffic flow of search-performing visitors. By determining ways to accurately monitor and report user interactions during such visitations, search-engine entrepreneurs implemented ways they could charge for advertising, for example, proportionate to the number of times a Web site was visited or an advertising element of the site was seen. As the advertising model evolved such entrepreneurs also implemented ways to charge for advertising according to the number of times users clicked-on, or otherwise interacted with, advertising-related content at their Web sites. As more and more users gravitated to one or another search-performing site, it was soon widely acknowledged that such Web sites had emerged as primary internet ad-revenue generators. This awareness quickly attracted the attention of the technology investment community and by the late 1990s there were numerous Web site choices having much-improved search-engines with various types of browser displayable advertisements.

Following this rapid search-engine funding, development and internet ad-revenue implementation period, an Internet-related business launched a search-engine having a proprietary algorithm which substantially increased the effectiveness by which users could perform online searches. Using the new search engine, users could search through billions of references maintained in centralized and/or distributed databases, and instantly have scores of variably-related subject matter or ‘hits’ presented to them. While the relevance of a good deal of such search results were often less than ideal, the search-engine methodology also accommodated the adding of additional search alpha-numeric text criteria to the same search string field so that the user could, through the taking of a number of added steps, narrow down broad search results into increasingly narrower results. In view of the speed and relative ease-of-use of some search-engines, they gained widespread acceptance winning a substantial share of internet-searching users. Internet based advertising exposure probability also improved in that users were immediately presented with rudimentary forms of advertising which was generally or sometimes loosely related to search criteria enter by those users.

While such search-engine approaches have been successful, they are nonetheless at present, less than ideal, particularly in the area of getting a range of search results (and advertising content) specific to a geographic-territory of interest to a user. For example, a conventional text search approach might produce tens of millions of searches ‘hits’ for the geographic-territory of Paris, Tex. or a million or so hits for “Paris, Tex.” (i.e., with the latter search string being enclosed in quotes). However, among the first Web page of hits listed in such a search are numerous results that are not related to a geographic-territory, for example, there are links to a movie called Paris, Tex., and links to Web pages selling the DVD of the Paris, Tex. movie, or links to a band from New York City called Paris Tex., and so on. Indeed, of the first ten listings produced by a popular Internet search-engine, only three (30%) are actually related to the geographic-territory of Paris, Tex.

One problem in search-engine approaches producing a minority of geographic-territory relevant search-result hits is that such results are less than ideal for creating an association (in the mind of a user) between the minority of geographic-territory specific results and geographic-territory specific content generated by the user viewable in one or more co-locatable software programs or components simultaneously displayable in a single user interface (‘SUI’) or single Web page. As the relevance or relationship between search-result hits and a user's content decreases, the opportunity to enhance exposure probability and/or increase user awareness of such co-locatable content also decreases. In contrast, it is an object of the search-engine approach of the present system to provide a majority of, or all, search hits having geographic-territory specific relevance of interest to a user, and to provide in a single user interface (‘SUI’) or single Web page, a simultaneous displaying of one or more co-locatable software components each with content having the same geographic-territory specific relevance as the search hits.

Other problems persist in the status quo search-engine approaches. For example, in a conventional approach, if a search is narrowed by adding geographic-territory specific search criteria such as a zip code, often such search results are less than ideal in that a generic text-based listing of ‘hits’ is provided wherein each hit is merely displayed in a text format which is nearly identical to the other hits. Thus, in the prior approaches, the means for differentiating one text-based hit from another are through a literal translation of the text and can only be discerned to the extent that a user reads, contrasts and compares the text of the search results. While the percentage of relevant hits may be improved with a geographic-territory specific narrowing of a user's search criteria, there is nonetheless, little or no means for differentiating the search result hits from one another other than a meaning that may be derived only from the literal meaning of the text search results that are actually read. In contrast to the prior art, the present system provides the displaying of one or more groupings of suggestive and/or associative content or content elements pertaining to (i) the geographic-territory and category ‘GT&C’ (or subject matter ‘GT&S’) criteria entered by or associated with a user and/or (ii) pertaining to each search result ‘hit’. In one embodiment, options or choices are optionally displayable in a viewable browser display area adjacent to or in close proximity with a text-based search results listing, to provide a grouping of single words, word phrases, or media file graphical representations as suggestive content and/or associations pertaining to the geographic-territory and category ‘GT&C’ (or subject matter ‘GT&S’) of interest to a user to entice a user to make a selection of one or more among the search result text-based hits related to the proximate displayed content that otherwise could not have occurred to the user by the mere reading of text in a text-based listing. For example, a text listing resulting from a “Pizza” category and “Chicago” location search can cause the displaying of ‘Whole Grain Crust’ as an associative word phrase (among a grouping of such content) which when clicked on by a user input device input can cause the displaying of and/or highlighting of a particular pizzeria among the text listing. Thus there is an opportunity for improving online advertising exposure probability that is being overlooked and which could be of significant benefit to users and advertisers when effectively deployed, and it is an object of the present invention to provide such geographic-territory relevant suggestive and/or associative content or content elements.

Another disadvantage with the status quo search-engine approaches is that the text-based listing of their search results requires a user to navigate to a different Web site in order to find out more information about how to choose among one or more of the, or the type(s) of, or particulars of the, propositions, or offerings, or deliverables provided by a listed merchant or service or activity provider. In contrast, it would be advantageous to users to have any of such choices presented as they interact with geographic-territory and category ‘GT&C’ (or subject ‘GT&S’) specific content or elements thereof while they are on a Web page that presented such content in the results of their GT&C or GT&S specific search, and it is an object of the present invention to provide such same-page interactive content and choices and to provide same-page displaying of electronic commerce means for initiating and/or completing online transactions pertaining thereto.

Another approach to, and a newer technique for, the representation of text in a browser, resulting from a user entering of text criteria, has emerged on the internet, and is being referred to as a “word cloud.” Word clouds comprise a visual depiction of closely-arranged, or a grouping of, words or keywords (also referred to as “tags”) generally or loosely related to one another or to the subject matter provided at an associated Web site and may also be comprised of words frequently used on a Web page. A word cloud is a visual depiction of frequently used words or ‘tags’ in a web page. In some cases the fonts of the word cloud words or tags reflect the frequency of keyword usage by proportionally altering the prominence of a word or tag display, e.g., by displaying words or tags having a more prominent, larger font size or scale size for a more-often used keyword and displaying a smaller font for those that are less-often used. Alternatively, or additionally, the fonts of the words or tags may otherwise be edited to improve their prominence by making a word appear different or more noticeable by common font-editing means such as the applying of a bold, or italic, or bold-italic, or underlined, or colored font, or any combination thereof.

While such cloud-like arrangements of words have a context that can be effective in suggesting generally or loosely related subject matter to a user, the prior word cloud approaches are less than ideal for some of the same reasons relating to the aforementioned internet search-engine approaches. In particular, there is no comprehensive or standardized navigable and searchable databased ‘community’, multiplicity or network of geographic-territory specific word clouds or cloud-like groupings of geographic-territory specific associative discernible content elements (hereinafter referred to as ‘ADC’ elements). Accordingly, it is an object of the present invention to provide data storing and retrieving management means, wherein each word cloud, or cloud-like grouping, and each ADC element, or combination thereof, is storable and readable as a data-file record having one or more associated geographic-territory specific identifiers. The data-file records are storable in one or more databases in storage media accessible to the system and can be searched or referenced (or cross-referenced), retrieved and displayed in a browser as a GT&C or GT&S specific cloud in accordance with one or more geographic-territory specific identifiers and optionally one or more other identifiers (such as category and/or subject related identifiers). In one of the embodiments of the system, storable data or data-files can optionally include metadata or one or more metatags such as an HTML code line or command that identifies data pertaining to the contents, words or keywords of a cloud and/or cloud page (such as location-specific data, a category, a subject, time and date data and so forth) in an index or database format searchable by search engine software routines of the present system and optionally be provided in a format searchable from within third-party or independent Web sites. Preferably the present system automatically provides the association of a geographic-territory specific identifier and optionally one or more other identifiers with each data-file saved by file-managing software routines of the system. For example, the user interface of any selectable software application tool of the system, operable and co-located adjacent to, or in close proximity with, an ADC element cloud is preferably equipped to automatically display, or default to a user pre-configured displaying of, or accept user text entry of, at least a geographic-territory of interest to a user, and optionally a specified category and/or subject. In an optional automatic mode of one embodiment of the system, during the launching of any co-located software application tool in a Web page, the system queries data pertaining to the user interface of that Web page to search for any specified geographic-territory and optional category and/or subject criteria, for example criteria specified in the title bar of the web page, so that, the matching information found during the query is automatically associated with the opened and operative software application tool. In the user pre-configured mode, a user can specify a default or preferred location, for example in a setup or preferences window or pane and can optionally assign a geographic-territory for any software application tool. In the user pre-configured mode, a user simply types in the desired criteria or may select a location from a list, or drop-down menu, or pop-menu, recent or favorite location and the like, and may similarly do so for the entry of a category and/or subject. In each case, the co-located software application Tool is thereby configured such that the saving of any Tool-file (i.e., data-file) in effect ‘stamps’ or associates any of such criterion identifiers to the respective data-file, whereby posting or subsequent searching, opening, accessing or reading of the data-file includes such data. Thus, an advertiser/seller can generate advertising content, write a classified ad, configure one or more ADC elements to his liking, write text to be included in a displayable text-based listing, and the like, using for example, an ‘Advertising’ co-located software application Tool, and in each case, any saved data-file of that Tool will automatically include the predetermined and/or configurable geographic-territory and/or category or subject associated identifier data.

The term ‘Cloud page’ as used in the present invention means a Web site page, or browser displayable user interface, or the like which includes the display of a least one geographic-territory specific and/or category or subject specific cloud or cloud-like grouping of associative discernible content ‘ADC’ elements displayed in response to search criteria entered by a user or advertiser, and/or displayed in response content input by a user or an advertiser (or seller) into one or more co-locatable software application Tools ‘C SAT(s)’. Thus, with the present system a user or potential advertiser concerned with, or living in, a geographic-territory, can type in search criteria pertaining to a category (or subject) and a geographic-territory of interest, and ADC elements of a word cloud or a cloud-like arrangement among a databased ‘community’ or multiplicity of such system accessible and displayable clouds, will be displayed in a browser apparatus display area associated with the user-entered geographic-territory (and optionally have one or more search result listing and/or software application Tool(s) displayed adjacent or proximate to the cloud which also pertains to the geographic-territory criteria). Additionally, the present invention also provides the option of displaying geographic-territory specific ADC elements which may alternatively or additionally be comprised of any one or more in a variety of browser displayable elements other than text, and preferably does so such that a user interactivity with such geographic-territory specific ADC elements, via suitable user input means, results in the display of one or more offerings, or propositions, or opportunities to purchase, rent or lease deliverables selected from a group consisting of products, merchandise, goods, foods, beverages, services and activities. Alternatively, one or more software routines of the system can provide the option for a user to play an audio and/or video data-file in response to a user input with a graphical representation of an ADC element. For example, a stationary or portable browser-equipped apparatus having audio or video playback and/or voice-synthesis capabilities and the aforementioned software routines provide for the playing of an audio or video digital file pertaining to an ADC element, or a voice-synthesized reading of the text of an ADC element.

It is noted that one or more portable variants of the system (including those which may also be equipped with Global Positioning System ‘GPS’ means) can be incorporated into the dashboard or instrument display area of a vehicle, or the back of a vehicle seat such as an automobile, a recreational vehicle, a boat, or an airplane, and the like, such that the audio and/or video playback and/or voice synthesis capabilities (and any other capabilities of the system) can be of assistance to a driver, crew member or one or more passengers of a vehicle. Preferably such vehicle-incorporated systems also include display screens having touch-sensitivity and include software for interpreting inputs made by the touch of a user's hand or one or more fingers.

Experts in the advertising field acknowledge that the human mind scans for relevance or tends to look for content according to one's preferences and current interests or needs. Often one's preferences also tend to be very locality-centric, i.e., often, the closer one can be to a desired outcome, such as the acquiring of one or more products or goods, or the fulfillment of one or more services products or goods, or the participation in one or more desired activities, the better. Thus, there is an added-value advantage in the present system's approach to quickly providing information which is organized in a highly suggestive and/or associative manner, for example directly relating to user's specified geographic-territory or location of interest. Organizing ‘searches’ (i.e., the referencing and display) of geographic-territory specific ADC elements into one or more displayed clouds significantly improves the percentage of relevant ‘hits’ or references resulting from geographic-territory specific searches, and also provides enhanced exposure probability and increased awareness of the elements because the user knows that there will be an improved ratio of locality-centric or relevant words in such clouds. In prior word cloud approaches the clouds are not equipped, or directed at increasing advertising exposure probability to users in, or having an interest in subject matter pertaining to, a particular location, and often provide only a modest ‘draw’ due to an absence of, or a limited, compelling reason to go to the Web page in which a word cloud is displayed.

Additionally, there is currently no comprehensive and standardized word cloud-incorporating approach that a user can employ when searching for information pertaining to, or navigating on the internet to, different localities of interest, or when navigating among a databased ‘community’ or multiplicity of different localities of interest, and upon being presented search results pertaining to any of such localities, interact with the elements of a geographic-territory and category (or subject) specific word cloud or cloud-like arrangement in a consistent and predictable manner.

Accordingly, it is an object of the present invention to provide a standardized approach in the display of geographic-territory specific clouds and in the user experience so that when a user searches among, ‘navigates to’ and interacts with different clouds (or the interactive, transaction-enabling or transaction-facilitating elements thereof) among geographic-territory and category specific or geographic-territory and subject specific clouds (or both), the standardized transaction-enabling cloud approach and any complementary, co-locatable components of the system displayable within the same, single user interface ‘SUI’, facilitates familiarity and optimal ease of use. As previously mentioned, this can include the co-locating of one or more GT&C or GT&S specific text-based listing and/or complementary and interoperable, co-locatable software application Tools (each providing one or more GT&C and/or GT&S specific outcomes) adjacent to or in close proximity with a GT&C specific cloud or GT&S specific cloud. Another object of the present invention in providing such co-locating of one or more complementary software components displayable in the same, single user interface ‘SUI’ of the system, is to provide means for enhancing exposure probability and increasing user awareness of GT&C specific content or GT&S specific content (or both) and associative discernible content ‘ADC’ elements of one or more clouds, due to a same-page (e.g., SUI) displayability of and utility provided by one or more of the following co-locatable components: software application Tool(s) ‘CSAT(s)’; text-based listing(s), CSAT displayed content, search-conducting means, wherein any of which preferably also provides multi-component interoperability and geographic-territory specific outcomes congruent with one or more specified localities of interest to a user.

There are additional disadvantages with the status quo search-engine advertising business model that can be understood from an advertiser's perspective. For example, whether an advertisement is being placed by a professional advertiser or a novice, the previous advertising approach typically has a level of complexity which can be daunting and consequently result in a significant loss of advertising revenue. This can be illustrated in the steps required to place a ‘Pay Per Click’ advertisement wherein, many or all of the following steps can be required in order to most effectively place an advertisement: sign up and give your credit card number for Pay Per Click-based payment; study the process to learn the advertising terminology and methodology; write your advertisement headline and copy; choose between displayed key words and/or input your keywords and phrases (one to thousands); choose between keyword and or keyword phrase broad match, phrase match, exact match, negative match display factors; set budget per keyword and or groups of keywords; test results and adjust your budget; study a Quality Score metric and gain expertise in techniques to increase Click Through Rate ‘CTR’; test advertisements, adjust headline and copy; test keywords; test keyword groupings to increase CTR; cull keyword groups to secure higher Click Through Rate ‘CTR’; lower the CTR to lower the cost per click; adjust your maximum cost per click at the Ad Group Level to raise or lower your ad impressions, monitor clicks to lower Cost Per Click ‘CPC’; study the process and gain expertise in techniques for lowering CPC; and, monitor budget to increase or lower impressions while, concurrently, reviewing and measuring your historical keyword performance.

Thus, in the one or more of the status quo approaches, placement of an advertisement requires many steps that require expertise in order to lower Cost Per Click and increase the Click Through Rate in an informed way and which together, along with many other factors, determine the ranking location in the advertisement display hierarchy. Developing considerable expertise is also required because advertisers often have to compete with one another using the same keywords and phrases in order to increase the probability that their advertisements will have prominence and be seen. In general, in the previously employed advertising approaches, the higher an ad is placed on a Web page the more its exposure probability is increased and the more clicks it will receive. The most experienced advertisers know that few people go past the first page or two of search results, thus paid-for advertisements on the first page have a side effect of reducing the exposure probability of ads appearing on subsequent pages. Thus a number of nuances of the current advertising approaches must be learned and a good deal of expertise gained in order to skillfully control advertising costs and effectively compete for first-page uppermost-position advertisements.

Thus there is a need to simplify the procurement and display of search-engine facilitated online advertising preferably within a single or minimal number of Web pages of a Web site instead of numerous Web pages, and to make such advertising and any co-located user-accessible software application Tool(s) and/or text-based content more directly related to or congruent with GT&C specific criteria entered by users or advertisers. Accordingly, it is an object of the present invention to address and overcome the aforementioned advertising complexities and to provide a simpler and easier to use online advertising alternative for professional and novice online advertisers, whereby, there is no need to study or understand nuanced or complex methodologies in order to compete for advertising with the same keywords or phrases, or to limit exposure probability to the few text-based results or ads appearing on just the first page of potentially a multitude of pages. For example, by employing a stationary or handheld portable browser-equipped apparatus and accessing a Web page having the user interface of the system, the advertiser simply enters criteria pertaining to (i) a category and/or subject and (ii) one or more advertiser-preferred geographic territories, and a GT&C-specific or GT&S specific cloud or cloud-like arrangement equipped to display a range of one up to dozens or one up to hundreds of GT&C specific or GT&S specific associative discernible content ‘ADC’ elements is displayed in a viewable display screen area of a single page or SUI of a browser-equipped apparatus. The advertiser is given a choice among selectable ADC elements displayable in the subject GT&C-specific cloud. Such same-page ADC elements are purchasable (i.e., the ADC element displaying rights) by an advertiser in the form of online advertising that appears within one or more GT&C specific or GT&S specific clouds or cloud-like arrangements (either hereinafter referred to as a ‘cloud’ or ‘clouds’), and each advertiser-selectable element has a specificity or relevance pertaining to the advertiser's entered or selectable GT&C specific or GT&S specific criteria, and each ADC element is preferably equipped to be responsive to user interactivity via suitable user input means. For example, the ADC elements can each include one or more advertiser-configurable hyperlinks or associated software routine(s), which when subsequently clicked on, or otherwise interacted with, by a user of the system, preferably causes the display (in the same page or currently viewable display area) of one or more advertiser-configurable offerings, or propositions, or options to complete the purchase or rental of one or more deliverables selectable from a group consisting of: products, merchandise, goods, foods, beverages, services and activities.

Another issue of great concern to internes commerce businesses which provide pay per click compensation to users is fraud. It is estimated that fraud related to pay per click advertising on the internet is a multi-billion dollar problem. The victims of this fraud are advertisers and particularly advertiser's clients who pay out this money for less than bona-fide user input and interactions and advertisers who are burdened with having to prove which clicks are fraudulent. A good deal of this considerable problem persists because there is no integrated or consolidated approach to the registration and identification of user, and advertiser and/or seller participants authorized to generate and/or configure, and store content via one or more software applications of the same integrated system. For example, it is common practice for user-generated content, advertiser-generated content, configuring of commission-enabled content and the use of software applications employed for any of such purposes, to be used independently of one another often at different or unrelated Web sites with data being stored on different, often unrelated databases. Such non-integrated or poorly integrated systems have perpetuated the complexities of the pay per click Internet commerce status quo approaches and such complexities and poor integration have made it easier for dishonest users to abuse these existing systems. Accordingly, it would be desirable to provide one or more effective fraud preventative approaches which addresses this very costly problem and which readily facilitate the registration and identification of user, and advertiser and/or seller participants authorized to generate and/or configure, store and access content via one or more software applications and databases of the same integrated system, and it is an object of the present system to provide such integrated, fraud preventative approaches.

Another disadvantage of established search-engine approaches is that even with the entry of geographic-territory and category search criteria, for example “Chicago” and “Pizza”, the text-based hits can number in the hundreds and go on for many pages, consequently a user has to scroll through each of the pages to effectively compare and contrast the numerous hits using their literal text-meaning. These hits are typically sorted and displayed in a hierarchical order wherein the entity paying the most for advertising appears higher in the listing and those paying a lesser amount can become so non-prioritized they are virtually lost somewhere among the numerous pages making up a text-based listing. Thus, there is a need to separately provide suggestive and/or associative content elements arranged in a highly condensed manner that are viewable preferably on a single page and thereby do not require the repetitive steps of scrolling back and forth through numerous pages of text-based search hits. Accordingly, it is an object of the present invention to provide such means so that the displaying of GT&C specific or GT&S specific ADC elements in a cloud appear within an area of a Web page or SUI viewable on a stationary or portable/handheld browser equipped apparatus. Another object of the invention is to provide such GT&C specific or GT&S specific suggestive and/or associative, discernible content elements which pertain to or relate to a geographic-territory or locality of interest to a user, wherein such elements suggest locality-centric options to users that are not presented in the mere text-based listing form of search results provided by the prior art. For example, when using an existing search-engine, if one narrows their search criteria e.g., to include “Pizza” and a “Zip Code” the search results will simply list a text-based column of pizza serving establishments for that zip code area. However, such search results do not include one or more geographic-territory or locality specific clouds having advertiser-configurable suggestive or associative text or phrases or elements such as “Thin Crust”, “Deep Dish”, “Pepperoni”, “Cheese Pizza”, “Low-Carb Pizza” and the like, or logos of one or more pizzeria or pizza chains, each providing user interactivity and an offering or proposition related to the user-entered geographic-territory search criteria. Thus, in the prior art, there are no new forms of suggestive and/or associative discernible content ‘ADC’ interactive elements provided to advertisers or users, and users seeing a typical generic text-listing of names, addresses and phone numbers have no separate-but-associated co-locatable stimuli from which to form a new, different or spontaneous choice.

The previous approaches also provide the means whereby ‘affiliate’ participants in affiliate network systems, such as those provided by Commission Junction, LinkShare, and Performics, can earn commissions by generating or compiling text content covering subject matter that is of interest to online readers and which displays one or more interactive text hyperlinks in that content that match subject matter which has previously been selected or entered as advertising-related words, or keywords by advertisers selling related goods, services or activities. However, their commission enabling approaches have been less than ideal in that such systems do not provide a turnkey or self-contained approach wherein users can, within a single user interface screen or single Web site (or viewable display area thereof) such as that provided by the present invention: perform broad-based searches in accordance with geographic-territory and optional category and/or subject criteria; become commissionable-event participants; generate and save content; associate their content to a geographic-territory of interest to content readers and to advertisers/sellers; accept advertising content from advertisers/sellers in accordance with geographic-territory and optional category and/or subject criteria; display user generated content to content readers; provide in such content one or more interactive revenue-generating elements ‘IRGE(s)’ which respond to content reader interactivity to display subject matter having a geographic-territory of interest to content readers and advertiser(s)/seller(s); display offerings or propositions as a result of content reader interactivity with one or more IRGE(s) including preferably doing so in accordance with geographic-territory and optional category and/or subject criteria; review content generated by other users and/or of interest to advertiser/sellers in accordance with geographic-territory and optional category and/or subject criteria; receive payments from advertisers/sellers for advertising content and for commissionable transactions; making arrangements for completing the paying of any commissions due to users from advertisers/sellers for content reader interactivity with any IRGE(s) and any transactions relating thereto; and optionally integrate such functionality within the services provided by a single search-engine Web site to content generators, content readers and advertisers/sellers having IRGE(s) displayed within such content.

Another area within the advertising field having inefficiencies and where the effectiveness of advertising and an accountability or auditing of ad content could be significantly improved, is in the tracking of advertising which is potentially viewable by others on the Internet (or other large-scale network) and providing data to advertisers and their clients which includes (1) ad quantity reporting: for reporting how much a given advertising content was made viewable to one or more users, and (2) ad exposure-duration reporting: for reporting how long that content was displayed in a viewable condition to one or more users. It is an object of the present system to provide apparatus and one or more methods for reporting such information to advertisers including data which indicates ad-duration exposure times for any one or more of the following: advertising content and/or ad-related elements.

It is well understood within the advertising field that a significant portion of advertisements will never be viewable to or seen by others, nonetheless the advertising client still has to pay for those ads in order to improve the likelihood (through increased numbers of ads) that their advertisement will be viewable and seen. Wasted ads that are not seen are merely considered as part of the cost of advertising. However, with the tracking and reporting capabilities of computers, and particularly of computers or computing devices equipped for Internet access, it is not only possible to improve the auditing and reporting of advertisements that are viewable by others, but also the ratio of advertising that has been paid for and advertising which has been displayed in a viewable condition. It is an object of the present system, by employing computer executable instructions to provide a tracking and auditing of which advertising content is actually displayed in a Web page and to provide advertising content exposure-duration monitoring and reporting of that content when made viewable to one or more users, and through such ad quantity and ad exposure-duration reporting features, to provide a new type of advertising arrangement wherein an advertising client can be charged and pay for advertising in relation to timed durations during which their advertising has been made viewable to one or more users, and which thereby also provides an empirical/‘scientific’ feedback advantage for the reporting and/or auditing of such information to advertisers and their clients.

To address the aforementioned deficiencies or shortcomings, the present invention provides, in as little as a single user interface (SUI), Web site or Web page, a consolidating of complementary software-component functions, wherein in a first software-component type a generating, selecting and/or configuring of user content (in a storable data-file format) is provided, and in a second software-component type a generating, selecting and/or configuring of advertiser/seller content (in a storable data-file format) is provided with options for purchasing the right to display the same, such that a subsequent geographic-territory and category (and/or subject) ‘GT&C/S’ specific search conducted by a user within the same system causes a cross-referencing of, and search-criteria matching between ‘GT&C/S’ data-file identifiers associated with each of the two forms of data-file content, and a displaying of one or more user ‘GT&C/S’-specific interactive commerce-facilitating elements, based on one or more search-criteria matches. Accordingly, the present system provides for a configuring and displaying of GT&C/S-specific advertising content in the same SUI, Web site or Web page in which users also generate content, view content generated by others and conduct GT&C/S-specific searches, and such complementary and interoperable functionalities thereby serve to significantly enhance the exposure probability and increase user awareness of the GT&C or GT&S specific advertising content, and promote a completing of one or more customer orders based on the display of interactive, commerce-enabled advertising propositions or offerings that are more congruent with the interests and one or more locations of interest selected or specified by a user (and/or automatically cross-referenced and determined by the system).

### SUMMARY OF THE INVENTION

To overcome the limitations and deficiencies of the aforementioned approaches or systems the present invention discloses an online commerce and advertising system which can be summarized in a system and/or method context. For example, in a system context, a stationary computer or portable handheld browser equipped apparatus having a communications link with a large-scale publicly-accessible network such as the internet (via a cable connection or a wireless communication) provides user access to a Web page equipped with a user interface having searching or ‘navigation’ means for providing access to and searching among a multiplicity of databased geographic-territory and category ‘GT&C’ specific and/or geographic-territory and subject specific “GT&S” specific word clouds (or cloud-like groupings of proximately-arranged GT&C and/or GT&S specific associative discernible content ‘ADC’ elements). The network represents the communication pathways between browser equipped apparatus and the online system. In one embodiment, the network is the Internet. The network can also utilize dedicated or private communications links that are not necessarily part of the Internet.

While the browser-equipped apparatus mentioned above include stationary and portable handheld devices (such as browser-equipped cell phones, PDAs and the like), it is noted that the system and its interactive, transaction-enabling ADC elements can also be incorporated into various other types of display apparatus capable of displaying the cloud content of the present invention, for example televisions (e.g., webTV), or billboards, books, text-readers, magazines and the like which incorporate pixelated screens or flexible pixelated material, projection screen technologies, large-screen monitors, televisions, and the like.

The interactive search processes of the system enable worldwide locality-focused subject and/or category searches that generate consumer advertising word clouds populated with associative discernible content (ADC) elements that are associated by locality, and category and/or subject matter to, and displayable proximate to, locality-specific or locality-related content displayable within assorted co-locatable software-component application tools.

The terms ‘cloud’, ‘word cloud(s)’ and ‘cloud-like grouping(s)’ are used generically within the context of the present invention to refer to a closely arranged grouping of user interactive and preferably transaction-enabling (or transaction-facilitating) geographic-territory specific associative discernible content associative discernible content ‘ADC’ elements.

Preferably each browser-displayable cloud is GT&C specific and/or GT&S specific and comprises a categorized or subject associated grouping of one up to dozens or one up to hundreds, of proximately-arranged ADC elements relating to a user entered or selected geographic-territory. In one of the preferred modes of the system, one or more software routines provide an advertiser (or seller) the option to purchase exclusive rights, or non-exclusive rights, or both, to display one or more hyperlink-equipped (or otherwise interactively enabled) ADC elements within a GT&C specific cloud, whereby an advertiser is said, after completing such a purchasing procedure, ‘to own’ the displaying rights to the ADC element within a specific cloud for a limited period of time, or a renewable period of time, as a form of GT&C specific or GT&S specific suggestive and/or associative advertising. Optionally, the system provides one or more software routines and/or co-locatable components for (i) displaying and/or listing ADC elements that are currently available for purchase by an advertiser, or (ii) for suggesting of alternative associative ADC elements which are not currently displayed in a viewable area of a browser cloud area to assist an advertiser in choosing one or more best-suited and currently available elements or types of elements. Preferably, one or more software routines of the system provide the means for an advertiser to enter or create one or more customized or advertiser-configurable cloud ADC elements which, following an advertising purchasing procedure, is then displayable in a cloud or cloud-like arrangement within a cloud page. The processes related to purchasing ADC advertising are simplified, relative to the status quo approaches, because advertising content is generated, selected, and/or configured by advertisers or sellers and then made displayable in a single integrated or consolidated commerce system.

Optionally, the system provides advertisers the right to purchase offline cloud ADC elements that are displayable in a printed or projected cloud-like arrangement or format, for example with offline ADC element print and/or projection purchasing options presented to the user when they are using one or more of the system's advertiser order placement procedures. Such printed-cloud format options include but are not limited to one or more purchasable ADC elements printed on billboards, in books or magazines, newspapers, newsletters, periodicals and the like on small medium and large publicly-viewable surfaces, on objects typically used for ambient media advertising, and the like. Projected-cloud format options include but are not limited to one or more purchasable ADC elements which can be projected on television screens, on theater screens or screens viewable in large-audience venues such as stadiums, arenas, race tracks and the like, on buildings or other architectural surfaces, on an inflatable medium, or large publicly-viewable surfaces and the like. For example, such printed and projected ADC elements can be purchased by advertisers and/or sellers for limited periods of time to entice users seeing such content in public, to go online to a Web site or Web page (or Cloud page) and interact with one or more respective, related or associated ADC elements, or engage in one or more transactions, offerings or propositions pertaining or relating thereto. When the printed and/or projected cloud ADC elements option are made available to advertisers and/or sellers the system is equipped to present one or more of such print format or projected format options to the advertiser and to provide online or mailed transaction culminating means for the advertiser to make one or more payments for offline cloud ADC elements.

Preferably, purchasable offline ADC elements are the same, or are related to or associated with, online ADC elements, and can optionally be displayed online having a similar look. For example, ADC elements appearing in public on a billboard can optionally also appear within ‘billboard’ within a Web site cloud page. ADC elements appearing on a projected screen can optionally also appear within a similar-looking ‘screen’ within a Web site cloud page.

Printed and/or projected ADC elements appearing within an offline cloud preferably have at least one of the following identifiers adjacent to, or proximate to, or within the offline cloud's printed or projected content: the address of a Web site or cloud page with the same, similar or related ADC elements displayed online; one or more telephone numbers whereby inquiries and/or transactions pertaining to any of the printed or projected content, or any offerings, propositions or for any deliverables thereof, can be made; a geographic-territory specified which pertains to the printed cloud ADC elements; and a subject or category (or both) pertaining to the ADC elements. An offline cloud's printed content, such as printed content appearing on objects which can be held by a user, can additionally or alternatively include optically scannable content or coded content (e.g., a bar code, a location specific code, alpha-numeric code, or key code) and/or magnetically scannable content, in which case the system can also be equipped with user input means which includes scanning apparatus suitable for reading such content.

Preferably, advertiser purchasable ADC elements are comprised of one or more words, or keywords, or tags, or cloud tags, or non-text elements which are hyperlink-equipped (or as described elsewhere herein can alternatively be comprised of one or more other hyperlinked types of digital media files), and one or more software routines of the system provide the means for displaying, in response to a user interaction with an interactive ADC element via a user input means, one or more propositions or offerings associated with an ADC element, and an online transaction means for completing a purchase, or a rental, or a leasing of one or more deliverables may be presented in response to a user interaction with any of such ADC elements.

The system's ADC elements, and data pertaining to interactivity and/or configurations of any one or more ADC elements, are storable in and retrievable from one or more databases as data or data-files accessible to and searchable by data-managing computer executable instructions of the system (e.g., storable to and accessible from one or more networked databases and/or Web site servers). Preferably each of such data-files include one or more associated and searchable (i.) geographic-territory identifiers, or (ii.) category identifiers, or (iii.) subject identifiers, or any combination thereof. Thus, a cloud and/or cloud ADC element data or data-file is searchable and can be displayed according to its geographic-territory specific identifier among a searchable databased ‘community’ or multiplicity of clouds and consequently, search results are provided that in a majority of cases, or in all cases, are congruent with or relevant to the geographic-territory specific criteria entered by or previously configured by a user. Similarly, when a cloud and/or cloud element data or data-file is searchable and displayable according to its category or subject specific identifier among a navigable and/or searchable databased ‘community’ or multiplicity of clouds, search results are provided that in a majority of cases, or in all cases, are congruent with or relevant to the category or subject specific criteria entered by a user.

In the preferred embodiments of the system, a user employs a stationary, or portable, or wireless handheld, browser-equipped apparatus having a communications link with a large-scale publicly-accessible network such as the internet, to access a browser displayable interface such as a Web site or web page having a geographic-territory specific search or navigation means for searching among and displaying representations of one or more GT&C specific or GT&S specific clouds. In response to one or more navigation means inputs by a user, the system is equipped to access and communicate with one or more databases (e.g., Web site servers) and database data pertaining to the databased ‘community’ of geographic-territory and/or category specific clouds, and equipped with computer executable instructions for searching such data and displaying a representation of one or more user-selected geographic-territory and/or category specific clouds each having one up to hundreds (or more) of category and/or geographic-territory specific associative discernible content ‘ADC’ elements. Preferably each ADC element is equipped to be responsive to user input means interactivity for example, including one or more user or advertiser configurable hyperlinks or other software routine(s) providing user interactivity, and is transaction-enabled to facilitate commerce, or transactions, or commissionable events, or any combination thereof.

When the system employs one or more portable browser-equipped apparatus having a communications link with the internet (or other large-scale publicly-accessible network providing access to the system's databases and data), such apparatus can include wireless devices including, but not limited to, browser-equipped: personal digital assistants ‘PDA’s, cell phones, portable computing devices, GPS devices, and the like. When a portable browser-equipped apparatus of the system also includes global positioning system ‘GPS’ means, the system preferably provides one or more executable software routines wherein the current location of a user having such a GPS-equipped browser apparatus can automatically (or in accordance with one or more user selectable options or preferences) be determined by the GPS means, to operate as an automated navigation means, whereby a display of a Web page, or browser viewable display area, displays a cloud pertaining to the user's then-current GPS-determined location. For example, a user located in Cedar Park, Tex. can, upon employing a portable browser and GPS-equipped apparatus of the system can automatically have displayed, in a Web page or browser viewable display area, one or more GT&C specific or GT&S specific clouds or cloud pages having content and/or subject matter particular to Cedar Park, and moments later after driving to another city e.g., Austin, Tex., automatically have displayed one or more GT&C specific or GT&S specific clouds or cloud pages having content and/or subject matter particular to Austin, Tex.

The system's non-GPS search (‘navigation’) means is employed in navigating to, and/or searching for, a user-preferred geographic-territory and/or category specific cloud(s) on a Web page (e.g., found among a community of such clouds), by the user inputting one or more criteria pertaining to a geographic-territory, or category, or subject (e.g., anything having to do with people, or places, or things, or any combination thereof). To facilitate a one-click type of search ‘navigation’ through content browsed through, referenced and/or collected from prior searches, the system preferably includes one or more software routines which give the user the option to configure, in the user interface, one or more user-preferred or default Web pages and/or GT&C or GT&S specific clouds, or to customize one or more ‘Favorite’ page, or ‘My Favorite Location(s)’, or Categories, or Subjects, or any combination thereof. Such a configuration can include one or more in a range of ‘Favorites’ pages, or bookmarked pages, or ‘History’ pages (historically recorded and recallable pages) and the like.

Thus, any preferred geographic-territory and category specific GT&C or GT&S specific cloud-displaying Web page (or browser displayed/viewable GT&C or GT&S cloud area) once displayed or visited, can subsequently and easily be revisited within a single user interface ‘SUI’ or cloud displaying Web page without the need of the user inputting one or more text-based criteria. For example, any one or more among a community of databased GT&C clouds can be accessed and displayed as a default Web site page or Home page by minimal input from a user input device, wherein a user can employ input means communicating with a browser equipped apparatus to click or double-click a user interface element such as an element linked or hyperlinked to a user-preferred GT&C cloud and/or GT&C Web page.

Stationary, or portable browser equipped apparatus of the system optionally can include a microphone and one or more voice-recognition software routines, whereby user input in the form of one or more vocalized words or commands is received microphonically and is interpreted by the software to enact one or more software outcomes including but not limited to any one or more of the following outcomes: the inputting of geographic-territory search criteria, the inputting of geographic-territory category or subject criteria, a navigation to a user-specified or advertiser-specified GT&C or GT&S specific cloud or cloud-displaying Web page, inputting of general text dictation, an advertiser configuring and/or purchasing one or more ADC element advertisements, a user completing a transaction, and the like. When such apparatus are also equipped with one or more speakers or earphones the system can accommodate users that are seeing impaired.

Accordingly, the present invention provides one or more in a variety of means for storing and searching geographic-territory specific or locality-centric cloud data or data cross-referenced or made relational to geographic-territory specific clouds. Similarly, any of such data can alternatively pertain to word cloud-like groupings or arrangements of any one or more among a group of various associative and/or suggestive discernible content text and/or non-text elements). Thus, any of such data is storable and searchable in, retrievable and displayable from, one or more databases accessible to the system.

Additionally, the present system optionally provides one or more co-locatable software application Tools CSAT(s) which are user-accessible and deployable adjacent to, or in close proximity with, at least one geographic-territory specific cloud (and the associative and/or suggestive discernible content ‘ADC’ thereof) displayable in a single user interface ‘SUI’ such as the display screen of stationary, or portable (e.g., handheld wireless) browser-equipped apparatus. Each CSAT is equipped to provide and/or display user storable, retrievable and/or browser-displayable data and/or outcomes preferably pertaining to the locality and/or subject or category specificity of the cloud page in which the CSAT is displayed, or of one or more co-located clouds. The CSAT(s), when accessed and employed by a user, preferably provide a utility which repeatably appeals to the user and thereby increases the exposure probability and awareness-increasing aspects of the adjacent or proximate cloud (displayed within the same single user interface ‘SUI’) and fosters increased perusal and sustained engagement of ADC elements, particularly ADC elements relating to a geographic-territory of interest to the user. Thus, the more often users employ the CSAT(s) and are engaged with CSAT data and/or outcomes seen adjacent or near to the co-located grouping of ADC elements, the more often the ADC elements are also seen. CSAT(s) providing one or more geographic-territory relevant outcomes, content or subject matter pertaining to the geographic-territory of a cloud page and/or the geographic-territory specified by a user, are preferably selectable from any one or more among a group of software Tools displayable in the cloud page. For example, such tools can include but are not limited to ‘Community Building Tools’, ‘Social Tools’, ‘Group Tools’, ‘Personal Tools’, ‘Advertising Tools’, and commonly used software programs (e.g., word processors, spreadsheets, presentation, database, email programs, graphic display/editing, video displaying/editing programs and the like), instructional aids, tutorials, educational materials, templates e.g., for creating blogs, or forums, or wikis, or classified ads, or auctions, and the like. A selectable co-located software application Tool ‘CSAT’ or co-locatable ‘web application’ can be equipped for manual or automated entry of criteria to provide geographic-territory specific or related outcomes and optional category and/or subject outcomes with the single user interface of the system.

Preferably a standardized or partially standardized look-and-feel of the CSATs is employed to provide an easy familiarity in using more than one CSAT. The standardized interface approach and the co-location of Social, Group, and Personal (private) Software Application Tools of the system reduces or can eliminate the cost of such tools for consumers everywhere. For example, the utility and cost-savings of a free word processing CSAT can be used to promote and foster numerous forms of activities. Including those of a civic nature, such as facilitating dialogs, blogs, forums or user groups associated with community organizations or governmental entities or agencies (e.g., with one or more community-oriented CSATs). The access of a potentially broad assortment of software tools in proximity to the ADC advertising lowers the cost of advertising through increased exposure probability for advertisers within the trading areas shared by the registered advertisers and/or sellers, and local consumers (registered users).

Preferably certain CSATs include user interface transaction/payment means, whereby, a user or an advertiser/seller employing a co-locatable CSAT (or ‘web-app’) for a billable or other transaction-related outcome, is provided with an arrangement for completing one or more payments. For example, a software user interface transaction means can be provided within or adjacent to a CSAT (displayable within a single user interface ‘SUI’ or single Web site embodiment of the system) displaying an arrangement or user interface element or component equipped for accepting user input pertaining to one or more online payments made with a credit or debit card, or line of credit, or other common financial transaction instrument (or one or more other, commercially available software employed in Internet commerce).

Accordingly, a plurality of software, user interface components, responsive to user or advertiser/seller input, are displayable within the single user interface ‘SUI’ or a Cloud page of the system and provide interoperability and means for completing transactions pertaining to a geographic territory, or geographic territory and category and/or subject (GT&C/S).

Preferably a plurality of CSATs is accessible to users of the system and each CSAT is equipped with software routines providing geographic-territory specific outcomes useful to users or advertisers/sellers and of interest to content readers in a specified area. For example, a user can place a classified type of advertisement in a format readable by content readers using or performing geographic-territory specific searches within the system. Or a user or advertiser/seller can advertise the sale, rental, lease or auctioning of one or more products, services or activities readable online by, and available to, content readers in the same or general geographic-territory. An advertiser and/or seller can employ the system's Advertising CSAT to select, enter or configure one or more words or keywords to be displayed in geographic-territory specific advertisements e.g., appearing as one or more ADC elements within an ADC element grouping or ‘cloud’. For example, such advertising can appear as interactive, user interface elements providing commissionable events within CSAT-user generated content, or appear in one or more text-based listings. Similarly, an advertiser and/or seller can employ the Advertising CSAT to select, place and/or configure one or more propositions or an offering for one or more deliverables associated with an ADC element advertisement, or employ the tool to add or amend advertising related content such as one or more coupons, bonus points, or commissionable content, or to pay a commission, and the like.

User-entered data and/or content or outcome(s) of any of the aforementioned software Tools are storable in and retrievable from a data storing memory or digital memory buffer accessible to the system as databased data-files preferably including geographic-territory identifiers or geographic-territory and category (hereafter referred to as ‘GT&C’) specific identifiers. The system software provides the option to access such data and to create a browser display area representation of one or more clouds related to and conditioned by user-entered and/or software Tool-outcome data. For example, words entered most frequently in a software application Tool (adjacent or proximate to a GT&C specific or GT&S specific cloud) and stored in a memory or memory buffer as data-file data can be accessed by one or more software routines of the system from where the data are stored, such that cloud generating software of the system then accesses and displays the frequently used words as GT&C specific (or GT&S specific) ADC elements in a GT&C specific cloud. The system includes the option to generate cloud content from single-user input and/or multi-user input. For example, in the latter case, a GT&C cloud-adjacent ‘Social Tool’ or ‘Community Tool’ (CSAT) can be deployed providing a type of Instant Messaging ‘IM’ or other real-time forum software outcome preferably having to do with a then-current geographic-territory and/or subject cloud, wherein the input(s) of each participant CSAT user (each employing separate browser-equipped apparatus) is made viewable in the same interface of that cloud-adjacent CSAT and most-frequently used words and/or phrases entered by the multiple users are then displayed in a cloud by the cloud generating software.

Preferably co-locatable software application Tool of cloud page (e.g., an Instant Messaging ‘IM’ CSAT) is equipped with computer executable instructions for generating interactive, and transaction-enabling ADC elements of clouds that are locality-specific, when a user has entered one or more location criteria such as his own hometown, his zip code (or area code and the like), or a city he is visiting (or zip code or area code of that city and the like). Thus, a user in an IM CSAT text dialog about dogs would see a cloud displayed by the software of the system (in the location-specific cloud page) next to or near the IM Tool that relates to dog subject matter in the user-specified locality. For example, the ADC elements can relate to businesses where dog food can be purchased locally, local kennels, local veterinarians, local pet stores, and the like, and/or one or more transaction-enabling elements or links (such as offerings or propositions of any the same businesses) whereby the user may order and complete purchases online, optionally including the ordering of one or more deliverables that can be delivered to a location specified by the user.

Preferably the generated cloud content is editable by one or more authorized users, host, administrator or content monitor providing content oversight, by one or more automated content-monitoring software routines

In multi-user sessions wherein a plurality of users are engaged in a discussion which include numerous users at different locations, the location data of each user can be accessed by the system in a manner whereby the same software application Tool type employed in the multi-user session generates ADC elements of one or more clouds in a cloud page of each of each user's browser in accordance with the geographic-territory of each individual user in the same session. For example, in a multi-user session concerning the subject of “pizza”, wherein one user's geographic-territory is Chicago and another's is Los Angeles, one or more software routines of the system in response to data pertaining to the location of each user displays ADC elements particular each user's location in their respective cloud page, so that a ADC element pertaining to one national chain of pizzerias (or other local pizzeria) interacted with by the Chicago user provides offerings or propositions pertaining to the Chicago area, and the same national chain of pizzerias (or other local pizzeria) interacted with by the Los Angeles user provides offerings or propositions pertaining to the Los Angeles area, and so forth. Preferably the ADC element generating software routine(s) of the system are equipped to display the ADC elements during live sessions and save the CSAT content generated during a session in a digital format which can be subsequently accessed and reviewed by users or content readers at a later time, and the software routines generate ADC elements of one or more clouds in a cloud page that preferably are locality-specific to each user reading and/or adding to the content in their respective browsers. The ADC elements generated during live multi-user sessions and reviewable subsequently as CSAT-user accessible data provide the same ordering, purchasing and delivering capabilities as previously described for a single user of a Tool. Preferably the location of each user is entered in a User-Profile mode which is subsequently accessible to the system in the form of User-Profile data, user-entered location criteria, or when a Web site (or page thereof) includes data, or internet protocol ‘IP’ data, having location specificity, such data can be automatically detected and read, sorted and subsequently accessed by one or more software routines of the system.

Optionally the system's software includes ADC element editing, sizing, scaling and/or shaping means, for example, wherein a font-editing means adjusts the prominence of the displayed words/elements within a GT&C specific cloud in response to associated words being used most frequently in a CSAT by one or more users (e.g., highlighting an ADC element, or an increasing of element font size, scale and/or a text's emphasis using one or more of the following font controlling parameters: bold, italic, underline, shadow-effects, filter-effects, upper case, title case, color, opacity, and the like).

Preferably the software is equipped with a word filtering means, whereby GT&C specific cloud displayable word or word phrase matches are sought among words such as: nouns, pronouns, verbs, adverbs, adjectives, and the like, and do not include common incidental words such as “the”, “and”, “a”, “when”, “then”, and the like.

Users having opened a plurality of geographic-territory specific clouds (or one or more clouds generated from user entered text or other user input) are provided system software means for switching easily between the plurality of clouds, such as a ‘Search-Cloud’, ‘User-Cloud’ and ‘User-Profile Cloud’ (of a user), and the like. Wherein a ‘Search-Cloud’ is a cloud displayed within the cloud page in response to a previous search having been conducted in accordance with user-entered search criteria. A ‘User-Cloud’ is a cloud displayed within the cloud page in response to user inputs in a cloud page for example a user employing one or more cloud-adjacent or co-located software application Tools within the same cloud page and entering text or other content a user input area of the Tool. A ‘Profile-Cloud’ is a cloud having ADC elements that are generated by one or more types of inputs made by a user in a User Profile Setup mode and/or into a co-locatable software application Tool ‘CSAT’ of a cloud page, or by one or more other user interactivities provided by the system. For example, a cloud-switching means can comprise one or more user interface interactive elements, such as: (i) a click-on ‘Search-Cloud’ tab (button, or menu selection, or the like) which, when clicked by a user causes the display of the GT&C specific cloud most-recently viewed by the user or alternatively the display of a cloud pertaining to the most recent search criteria (or a default criterion) entered by that user; and, (ii) a click-on ‘User(s)-Cloud’ tab (button, or menu selection, and the like) which in the latter case, when clicked by a user, causes the display of the GT&C specific cloud or GT&S specific cloud pertaining to the most recent (or a default) software application Tool employed by the user. If a plurality of Search-Clouds and/or User-Clouds (or other cloud category) have been opened within a cloud page of the system, the system provides the option of successively displaying each ‘layer’ of the opened clouds according to a cloud category, by clicking on the tab of the cloud category, wherein each successive click of the same tab displays a different cloud of the cloud category as the top layer of opened clouds. Preferably such tabs can be located adjacent or proximate to the display area of a cloud displayed within the cloud page or along one or more borders of a Web page.

Optionally computer executable instructions of the system provide one or more ‘User-Profile Clouds’ with user-related ADC elements within a cloud page, which can be stored to, and recalled from, one or more memories or databases of the system, wherein software routines of the system generate ADC elements within a User-Profile cloud within the cloud page based on any one or more (or all) of the following: user-entered or selected search criteria; history or data pertaining to user purchases or transactions; text input or other types of user inputs made within one or more co-located software application Tools (CSAT) employed by the user within a cloud page. Additional User-Profile Cloud ADC elements related to such subject matter input by a user can also be generated and displayed in the same cloud including ADC advertisement elements that are interactive as previously described and referred to in the descriptions pertaining to the drawing FIGS. 4 through 6 (below). Preferably the system also provides a User Profile Setup mode or software application tool whereby a user or content-reader enters one or more of the following data: information pertaining to the user's or reader's identity, home or business address, hometown, zip code, phone numbers, area code, hobbies, interests, profession, favorite pastimes, activities, volunteer work, system preferences statistical information pertaining to the user's or reader's usage of the system, registration related data, and the like.

Preferably a User-Profile Cloud is automatically updated or refined by the system tracking and recording data pertaining to a user's or reader's usage of the system so as to accurately reflect one's interests. Such data can include but is not limited to any one or more of the following: user preferences, shopping or shopping-cart related information, historical shopping transaction related information, passwords, log-in information, Web page visitation related information, browsing patterns and preferences, and the like.

In an optional automated user-profile data gathering mode, the system provides software routines which generate ADC elements within a User Profile Cloud based on the user's interests and interactions. For example, a storable representation of one or more interactive ADC elements of a User Profile Cloud can optionally be accessed and displayed in a cloud ADC grouping in response to computer executable instructions monitoring and maintaining records of frequent or repeated user interaction in a cloud or cloud page of the system, such as the monitoring and recording of a user's (1) most frequent visitation(s) to certain Web sites, (2) performing repeated or certain searches, (3) most frequent use of one or more CSATs, (4) most frequently clicked on interactive element, hyperlink content or ADC elements (e.g., within non-user profile clouds) including ADC elements or interactive revenue-generating elements (IRGE's) pertaining to one or more deliverables, offerings, propositions, transactions, commissionable events, purchases made, and the like. In the first example (1), the software references a storable memory record of Web sites visited by a user, generates a displayable ADC element representation of each visited Web site (preferably in conformance with user and/or system configurable parameters and/or Web site usage thresholds) and creates an association between the displayable ADC element (such as a user or system configurable text, graphic, or multimedia interactive element) and hyperlinked to a respective Web. Accordingly, when input from user input means interacts with the displayed ADC element and associated link (within the User Profile Cloud of the cloud page) a previously visited Web site, or one or more propositions, offerings or transactions (or user or advertiser configurable information) associated with the Web site are recalled and displayed. In the second example (2), the software references a storable memory record of searches conducted by and/or search criteria employed by a user, generates an ADC element representation of each subject search (preferably in conformance with user and/or system configurable parameters and/or search usage thresholds) and creates a linked association between a displayable ADC element (such as a user or system configurable text, graphic, or multimedia interactive element) and each search. Accordingly, when input from user input means interacts with the displayed search-related ADC element (within the User Profile Cloud of the cloud page) a previously conducted search is quickly recalled and displayed. Similarly, in the third example (3), the software references a storable memory record of CSATs employed by a user (optionally including a previous CSAT work-in-progress state), generates an ADC element representative of a subject CSAT (preferably in conformance with user and/or system configurable parameters and/or CSAT usage thresholds) and creates an association between a displayable ADC element (such as a user or system configurable text, graphic, or multimedia interactive element) and each subject CSAT. When input from user input means interacts with the displayed CSAT-related ADC element (within the User Profile Cloud of the cloud page) a previously conducted CSAT (or work-in-progress state thereof) is quickly recalled and displayed. In the fourth example (4), the software references a storable memory record of a user's most frequently clicked on hyperlinked content, or ADC elements (e.g., of other non-user profile clouds) including ADC elements or IRGE's, generates an ADC element representative of each subject interactive element (preferably in conformance with user and/or system configurable parameters and/or interactive element usage thresholds) and creates a linked association between a displayable ADC element (such as a user or system configurable text, graphic, or multimedia interactive element) and each subject interactive element. When input from user input means interacts with the displayed search-related ADC element (within the User Profile Cloud of the cloud page) a previously conducted search is quickly recalled and displayed. Similarly, a user's most frequent or most recent usage of one or more co-located components within in a cloud page can also be referenced in a storable memory accessible to the system such that the co-located components (e.g., one or more GT&C clouds, text-based listing, CSATs, or any combination thereof) can be quickly recalled and displayed. To facilitate eCommerce options or alternatives based on User Profile Cloud related data, the system is preferably equipped with software routines for accessing such data in order to display interactive ADC elements having customized transactable propositions or offerings that are of interest to individual users.

Each of a plurality of interactive ADC elements can independently be or collectively be positioned or aligned in accordance with ADC element aligning computer executable instructions, for example to align elements in one or more rows, or columns, or both, or can be positioned within a grid, matrix or table, or each ADC element positioned within a placeholder, a layer, or by a positionable anchor.

Thus, any ADC element of a GT&C specific cloud or GT&S specific cloud can be displayed in a User Profile Cloud and can automatically be updated and reflect the changing interests of the user, thereby making the displayed content more relevant to the user, and improving the exposure probability of the ADC content.

Preferably, the User Profile Cloud can be turned on or off by the setting of preferences or options, and can include other options such as the user selectively choosing to not report visiting certain types of Web sites which the User may want to keep private, or setting access to, or the viewing of, the User Profile Cloud as private, requiring the user to enter a password.

In a similar cloud ADC element generating approach, the system optionally provides for the creation and management of User Personality Clouds, wherein interactive ADC elements of a User Personality Cloud are automatically produced by software routines or computer executable instructions of the system in response to user input into, and an interoperability between, co-located components e.g., within the single Web page or single user interface of the system. Such user input and multi-component interoperability can occur between a software application tool CSAT, and one or more cloud(s) or text-based listings or any combination thereof. For example, a user generates blog content employing a Blog CSAT and posts a good deal of blog content having a subject matter concerning ‘peace’ (and stores the content in a memory accessible to the system). The system software or computer executable instructions accesses the CSAT content and is equipped with routines for seeking repetitive words and/or repetitive use of root words within the content, and thereby determines that the word ‘peace’ is an oft repeated or most repeated non-incidental word in the blog content and/or is an oft or most-frequently recurring word in one or more CSAT content files or in the saved titles of such files, and displays the word ‘peace’ in his User Personality Cloud. Preferably the displayed word (or other ADC element type) is given a prominence, emphasis and/or position within a User Personality Cloud which is generally proportionate to and reflects the degree of use of the word by the user.

User Personality Cloud ADC elements can also be generated in the manner described above pertaining to the automatic generation of ADC elements of User Profile Clouds. Thus, any oft repeated or most repeated theme, subject matter, search, search criterion or interactivity, and the like, generated by or occurring within a non-User Personality Cloud can be referenced to provide representations of the ADC elements of a User Personality Cloud (preferably in conformance with user and/or system configurable parameters and/or usage thresholds). Preferably, software routines of the system provide user personality cloud managing software for editing and selectively displaying ADC elements which make up his or her User Personality Cloud. For example, a user can choose to hide or display any of his personality data in order to more accurately reflect what he wants to show to others. Thus, the User Personality Cloud reflects a user's interests, or more specifically, the interests that the user wants to make public.

Optionally, a user's personality cloud (or ADC elements thereof) can selectively be chosen by a user to represent some or all of his or her public persona. In one mode, software routines provide for the user creation of one or more identities, such as one or more pseudonyms, or pen names, or ‘handles’, or avatars, and/or the use of a real name, and the like, such that, when the user creates or edits CSAT generated content, or employs a CSAT to make comments, add to reviews, answer questions, contribute to wikis and forums, and the like, the content is automatically identified with the current, or a user selectable, identity chosen by the user. Preferably, the software routines provide for the creation and storing of a selectable User Personality Cloud for any persona/identity and display ADC elements within the cloud based on that persona's input and their particular usage of the system, for example including but not limited to one or more of the following, the user's: CSAT content, user input means interactivities, inputs, uploads, imports hyperlinking, Web site visitations, and searches (each preferably being a setup or options parameter which can be selectively activated or deactivated by the user). When content readers review CSAT content saved by the persona/identity, for example content which has previously been saved and then subsequently read within the single user interface of the system, a CSAT content creator link is displayed within, or in proximity to, the content, which when clicked displays the User Personality Cloud of the content creator to other (preferably registered) users of the system. Accordingly, others can see at a glance what the identity/personality of the user is, and the types or categories of content the user generates. As the number of User Personality Clouds stored in one or more databases accessible to the system increases, the system software is preferably equipped to classify or categorize the personalities/identities according to common areas of interest, and preferably does so in accordance with the geographic territory of each persona, so that a searching of personalities, or identities, or persons having specific areas of interests, can be conducted by users, for example, by employing the ‘search’ software user interface component of the system, or by the displaying of a General Persona/Identity Cloud comprising interactive ADC elements each representing a separately linked class or category of persona/identity. In the latter case, when the user clicks on the linked class or category of their choice, the system software is equipped to display a cloud having ADC elements representing that class or category of personality, or identity, or persona (optionally constrained to a geographic territory of choice as well).

The User Personality Cloud software of the system can also include software routines whereby others (e.g., content readers) can post a rating or make comments regarding the content of a persona/identity. Preferably the software includes routines whereby the user can edit the content of, or delete one or more of their User Personality Clouds and start again, or stop the system from automatically creating a User Personality Cloud based on a persona's/identity's (or personality's) repeated or most-often entered inputs (or based on other user-configurable setup options), or can amend a personality cloud by adding or deleting ADC elements, or other custom material or annotations such as the displaying information the user may wish to divulge like the age, occupation, and interests of the user and the like. The system can be configured (e.g., in an options, preferences or Setup mode) to influence and update a User Personality Cloud through any of the previously described types of user interactions within a component co-located within a Web page or single user interface of the system. For example, through interactions within, or input into CSAT blogs, forums, and other content created within one or more CSATs of the system, and also monitoring and/or referencing posts, comments, and the like, and storable data pertaining thereto. Optionally a user can selectively choose to display or not display one or more User Personality Clouds, and is preferably provided a setup option to choose who (which individuals), or what group(s) of people, will be able to display and view a given Personality cloud.

Preferably the system is equipped with one or more software routines whereby users can selectively choose to have one or more of their User Personality Clouds automatically displayed adjacent to a CSAT (e.g., used to view the CSAT-generated content) or have the cloud(s) displayed in response to input from a user input device. For example, content readers reviewing CSAT content can click on, or rollover (hover on) a displayed hyperlink or other interactive element associated with a CSAT and a user (personality) or persona having created the CSAT content, or click within the content to cause the display of, or select a menu option to display, one or more User Personality Clouds of the person or persona/identity associated with that CSAT content (i.e., the content then being read, or viewed, or heard). The displayed hyperlink can be located within or adjacent to the CSAT content. The CSAT input from a user input device can be a right mouse button click within the area of the displayed content, or on a CSAT graphic representation or video element, or text-based excerpt(s) pertaining thereto (or another form of user input from any user input means). The User Personality Cloud (or cloud element) and/or persona hyperlink allows content generators within the system to attract users to their content, and allows content readers to find more content generated by personalities that they find most appealing. Accordingly, a CSAT user having generated a storable CSAT blog posting and having one or more content readers of the system viewing the blog content provides the means whereby the content readers can easily and quickly find out associative information regarding the CSAT content generator by using one or more of the aforementioned forms of user inputs. Similarly, one or more registered content readers of the system who provide a comment regarding a CSAT user's content can also be identified by a hyperlinked interaction such that one or more User Personality Clouds of the commenter can easily and quickly be displayed for example next to the CSAT content or next to the displayed comment.

In recent years many Web sites, such as those facilitating social networking through ongoing discussion groups, forums, blogs, or special interest groups and the like, have been faced with a problem pertaining to a growing number of users who, emboldened by an anonymity as an internet user, and/or identified to others only by a pseudonym, have become quite rude, brash or inconsiderate in the language they use to communicate with and among others. Such attitudes towards others are not conducive to the building of a community of users wishing to fully participate in emerging ‘Social Networking’ services offered at an increasing number of Web sites. Rude attitudes towards others often persist because those typically showing little or no respect have grown accustomed to there being no oversight or accountability for their actions. Accordingly, if such users perceive that there is no one, or no means for holding them accountable, or no consequence for repeatedly being discourteous or using crass language, they are not sufficiently motivated to change, or to improve their online manners or etiquette.

While some Web sites have attempted to improve this situation by having users rank the comments of others on some scale of propriety or civility, such approaches have required manually-entered feedback among a community of users, which has not proven to be ideal for reducing less than desirable language or for improving such attitudes. If, on the other hand, a user knew in advance of making comments, or through specific feedback to him in response to his comments, that his participation and/or content was being increasingly filtered from view by the choice of his co-participants by one or more automated modes of the present system—due to his choice of words or attitude(s) or both—he could be given ample motivation and an opportunity to improve his ‘social’ interactions with others to regain lost viewers, or reduced participation privileges.

Accordingly, it would preferable and advantageous to provide an automated approach to the ranking of comments, content, input or reviews of users, such that viewers of such content could be provided an option to manually and/or automatically filter out content at a level, or threshold, or according to one or more criteria, that they prefer or feel is appropriate, and it is an object of the present invention to provide computer executable instructions and datafile managing apparatus and processes for such purposes. For example, in one exemplary approach of the present system computer executable instructions can provide the means whereby content created or displayable in one or more CSATs and storable as a datafile in one or more of the system's data storing apparatus can be either manually or automatically tagged or rated causing one or more storable content-filters or comment-filter identifiers (associated with the one or more inappropriate words, and/or the content creator's identity) to be associated with the datafile. Thereafter, the one or more content-filters or comment-filter identifiers, preferably also identified with the viewer's CSAT content/datafile(s), are accessible to the system to limit the degree to which inappropriate text (or users) will be displayed to one, or more, or a community of viewers.

A manual rating or tagging can be controlled, determined or conditioned in part or in its entirety by a user input means input such as a mouse clicking on an interface element like a check box or button, or selecting a selectable element among a ranking range of elements, or by making a menu selection, or in response to text-based criteria enter by a viewer in a text field, and the like. In the manual filtering approach, objectionable text and one or more associated content-ranking datafile identifiers is chosen by the viewer and are storable by and subsequently accessible to the system. Text-filtering datafile identifiers can include a viewer-selectable number rating on a numerical scale, a brief text description given as feedback, or one or more selectable or clickable text-based identifiers (each optionally having a weighted value which is preferably cumulatively accrued) such as “Inappropriate”, “Rant”, “Mean-Spirited”, “Not Family-Friendly”, “Rude”, “Crude”, or simply “Filter This Out”, and the like, e.g., by a user employing a user input means interaction with a selectable user interface element. In an automated approach with user-generated content comprising alphanumeric text, and the system also including a database for storing words which are considered inappropriate and/or deemed objectionable (to a viewer, or to the system) computer executable instructions automatically cross-reference user-generated content relative to the database of inappropriate words and any associated text-filtering datafile identifiers and adjust and/or curtail (or ‘filter’) the display of such content to other viewers, or do so in accordance with one or more conditions specified by one or more viewers.

Optionally or additionally words are made selectable within displayed CSAT content and once selected by one or more viewers can be stored as database-storable filtering words (optionally including being selectable or managed by one or more authorized Web site administrator). Preferably in the manual and/or automated comment-filtering modes one or more selectable comment-filter thresholds are provided to viewers, giving a viewer the option to choose (or not choose) a filtering level which suits their interests. For example, a content viewer might be provided with a selectable user interface element which selects a ‘threshold’ or range for a comment-filter or content-filter, such as one or more of the following choices: ‘Viewer-Age Appropriate’, ‘Family-Friendly’, or ‘Adult’, or ‘No Ranting Please’, or having a certain adjustable courtesy or grading level (e.g., ‘A’, ‘B’, ‘C’, ‘D’, ‘F’), or percentage threshold or range, or providing a choice among a selectable rating system similar to those employed with video games or feature films such as “Rated-G”, “Rated-PG”, or “Rated-R” and the like. Preferably, the database of selectably-filterable or inappropriate text content is comprised of text datafiles and each datafile includes at least one text datafile identifier that is associated with at least one rating, threshold, range or other selectable quality-assurance criteria. Thereafter, computer executable instructions of the system automatically cross-reference user-generated text content relative to one or more text datafile identifiers in the content-filtering databased data and only display content to viewers which is in keeping with their preferences. Such preferences can be performed, stored and/or accessed by content viewers in any of the ‘Setup’, ‘Options’ or ‘Preferences’ modes, or menu selection modes, described elsewhere in this specification, including doing so as a logged-in registered user and/or password-authorized user (e.g., as a parent of a dependent user). Computer executable instructions of the system can additionally or optionally provide CSAT-content viewers a quick method of entering or tagging text as filter-criteria that a viewer wishes to block or filter for a viewer-controllable period of time (or unspecified period of time), and/or subject to one or more other criteria. In one exemplary mode, computer executable instructions provide the option for a viewer to highlight one or more text instances intended to be filtered (e.g., by an input means clicking on different text instances while holding down one or more keyboard keys such as a Control-Key to highlight different instances) and then, in response to a user input means interaction, store such word(s) in a database accessible to the system preferably in a manner wherein each stored word is stored having both a datafile identifier associated at least one filtering criterion and with the identity of the viewer. In response to the user interaction (following a highlighting of one or more words) such as a right-click of the viewer's mouse or other input device), the computer executable instructions preferably provide one or more filtering options to the viewer such as a displaying of one or more viewer selectable options, in a menu or pop-up window, or option(s) determined by a clicking on, or within, one or more displayed check boxes or buttons, or in accordance with a spoken command input into a microphonic input means, one or more text entry fields, and the like. Preferably, filtered-text conditioning data storable in one or more databases are also made accessible to registered and/or password-authorized users so that any filtered text can be selectively displayed and/or edited or amended within or proximate to a CSAT display area and a record of changes made thereto made storable and retrievable as well.

Preferably computer executable instructions of the system also include providing feedback to content generators which can be (a) private—made viewable solely to the individual user) or (b) public—made viewable among a community of users. Thus, a user who generates text content can be informed that his content is rated ‘High’ or ‘Excellent’ and is continuing to accrue more viewers, on one end of a spectrum, or on the other end of the spectrum can be informed that his content rating has fallen, or within a specified ‘Poor’ range or below a certain threshold, and the user is consequently losing viewers or readers. Optionally, the same user can be notified (optionally posted privately or publicly) within, or proximate to a displayed CSAT that comment-filtering, whether chosen by viewers or determined by the system, or both, has caused a loss in viewers by a reported range or certain percentage. If a user is seeking to gain income from commissionable events or accrue bonus points offered by the system, it is in the interest of the user to interact with as many viewers as he or she can in a favorable manner, and the system's software can so notify the user. Additionally, the system can optionally choose to provide such commissionable events, Bonus Points, rights and/or privileges to users who are in good standing or who operate above a predetermined threshold, and who show they can interact with others, even heartily disagree with them, while also interacting with them honorably.

Preferably, a user having fallen to a lower than desired rating can be granted time, such as a probationary period (optionally posted privately or publicly) during which time he or she can choose to improve their content in order to regain or acquire more viewers, or can merely choose to make no changes (which may likely cause a loss in more viewers over time). Additionally the system can be adapted so that users, having fallen below an acceptable level of communication, may through a communication such as an email, Instant Message, letter, phone call, and the like, with an administrator or other authorized customer service personnel or agent, be given the right to appeal a rating he or she has received in accordance with reasonable requirements and expectations.

Optionally registered viewers of a certain age, such as 18 (or 21) and over, and/or one or more authorized Web site administrators, can selectively choose to turn on or off, or determine the degree of, one or more text filtering options. Optionally, the reporting and displaying of private or public filtering information or notices, viewable to one or more users, for example, having only nominal or infrequent instances of harsh words or mild expletives may not be filtered (e.g., by falling short of a predetermined threshold), but the system can otherwise be configured to post any of such reporting and displaying when comments exceed moderate limits, in which case, the system can employ any one or more of the abovementioned text-filtering methods or processes.

Accordingly, the system provides an enhanced accountability (regardless of the name or pseudonym one chooses to operate under), in that users will know, or learn, or through their agreeing to a registration-user agreement before using the system, that their content and/or input will be identified with them as users (via one or more user identity datafile identifiers) and there can be undesirable consequences for negatively treating, abusing or demeaning others in a repeated or persistent manner, including users and/or their content being rated or ranked for viewers by one or more ranking criteria or scales such as a ‘Positive’ to ‘Negative’ scale or range. For example, a sustained or ongoing ‘Negative’ ranking or lower-range rating can produce one or more of the following: a significant reduction in viewers (e.g., by those viewers' own choosing), reduced system-redeemable Bonus Points, fewer IRGEs and commissionable-events, less benefits and privileges, or a curtailment of all privileges or access to the system. Optionally, notification of a ‘Negative’ rating (or pending rating) can first be communicated privately to a user, giving the user to an option to rectify persistently negative content within a reasonable period of time so as to prevent the displaying of one or more negative types of notices, reviews, rankings or ratings, and the like, to one or more, or a community of content viewers. On the other hand, a ‘High’ or ‘Excellent’ ranking (or upper ranking on a numeric scale) whether determined by an automated mode of the system which compares and contrasts user's datafile input in accordance with one or more acceptable thresholds or limits (such as any of those previously described), and/or caused by feedback or selectable input from viewers which rates a user's words and/or their content generally can produce significant rewards—for users essentially treating others in a manner in which they would appreciate being treated—can produce a significant increase in viewers, thereby producing increased system-redeemable Bonus Points, increased IRGEs and commissionable-events, increased benefits and privileges, positive notices, ratings and the like. In other words, the more a user creates generally positive, helpful and constructive content, the more likely that user is to accrue significant benefits and/or revenues offered by the present system.

As previously described, the system is equipped with computer executable instructions or software routines for accessing and cross-referencing data storable in one or more databases accessible to the system, including data pertaining to User Profile Clouds and/or User Personality Clouds, such that criteria previously entered by advertisers/sellers (e.g., via an ‘Advertising’ CSAT accessible in the same user interface or cloud displaying page) can be cross-referenced in view of such profile and/or personality data. Accordingly, offerings or propositions pertaining to any deliverable of an advertiser/seller can thereby be tailored to and made displayable according to the interests of each user personality (or user profile) and preferably are made displayable according to one or more geographic territories or locations of interest to the user. Preferably the system also includes computer executable instructions which are responsive to input by a user employing user input means such that an IRGE displayable in a CSAT or text-based listing, in response to user input, displays one or more hyperlinked, or otherwise-interactive, offerings or propositions from two or more different advertisers/sellers. Thus, one or more software routines of the system automatically provide for the matching or relating of any criteria previously entered by one or more advertiser/sellers with data of one or more User-Profile Clouds, or User Personality Clouds, or both cloud types, such that offerings or propositions or any deliverables pertaining thereto can be displayed as a result of user or reader interaction with ADC elements of one or both cloud types. For example, if the user or reader has entered “snow skiing” as a favorite activity, or has searched for, or entered text relating to the subject of skiing, and an advertiser/seller has previously entered the word “skiing” as a matching, related or similar-word criterion, then by cross-referencing the stored data, the system software can access a representation of the ADC for display within the User-Profile Cloud pertaining to snow skiing to provide the user or content reader interactivity leading to more information and/or one or more transactions pertaining to skiing.

Thus, the interoperability of one or more CSATs and clouds simultaneously displayable within a single user interface or Web page of the system, and the data deriving from both types of such co-locatable components, provide enhanced exposure probability and increased awareness of displayable advertising content within that user interface, due to the displayed content being more relevant to, or in closer congruence with, a user's or a persona's interests.

Such data can be accessed by file managing software of the system for general display, or to provide the display of locality-centric or topical information, for example, local news and events which is of general or particular interest to the user or reader, such as local or regional weather, reports, traffic reports, upcoming activities, and an editable calendar, and the like. Preferably such information is displayed within one or more CSATs, or within a cloud page or single user interface of the system. Optionally the display of such data can also be in the form of a co-located User Profile Cloud wherein such data, or salient excerpts thereof, are displayed in a close cloud-like arrangement or grouping of ADC elements generated by computer executable instructions in response to a user's or reader's input.

The online commerce and advertising system of the present invention may alternatively be summarized in the context of one or more method embodiments. For example, one method of implementing the system and its inter-operable components (displayable in a single user interface ‘SUI’) can be achieved through a user taking the steps of: (a) establishing communication between a stationary or portable browser-equipped apparatus and the internet; (b) employing the browser-equipped apparatus to display a ‘Home’ or starting Web site page having a user interface means and computer executable instructions providing user-navigable access to and among a databased multiplicity of user-selectable geographic-territory and category (‘GT&C’) specific clouds or geographic-territory and subject (‘GT&S’) specific clouds (or both); (c) employing GT&C or GT&S specific search criteria by (i.) entering text-based search criteria, or (ii.) selecting a user pre-configured search criteria, for example among one or more ‘Favorite(s)’, or defaults, or bookmarks, or historically recallable (e.g., ‘History’) clouds or cloud pages, and the like; (d) accessing GT&C or GT&S specific data-files of one or more databases accessible to the system in response to one or more user entered search criteria and displaying at least one GT&C specific or GT&S specific cloud or cloud page and ADC elements pertaining thereto in accordance with the user-entered criteria. Once a GT&C specific or GT&S specific cloud or cloud page is accessed, the user optionally may select among any one or more of the following method steps: (e) interacting with one or more ADC elements of a GT&C specific or GT&S specific cloud via suitable user input means: configuring one or more advertiser ADC element parameters and completing a financial transaction for a time-limited purchasing of an advertisement associated with the ADC element as configured; viewing information and/or content associated with and pertaining to an ADC element; completing a financial transaction pertaining to one or more offerings, or propositions, or deliverables associated with an ADC element, and the like. Additionally or alternatively, once a GT&C specific or GT&S specific cloud or cloud page is accessed, the user optionally may select among any one or more of the following method steps: deploying one or more GT&C specific or GT&S specific cloud-adjacent or proximate software application Tools (co-located in the same Web page or user interface); entering and/or saving text as a single user or as one of multiple users in one or more GT&C specific or GT&S specific cloud-adjacent or proximate software Tools in a manner which preferably causes the system's software to display one or more, or any combination of the following: the same or similar words or word phrases, or related associative discernible content (ADC), or ADC elements, or the like, in one or more GT&C or GT&S clouds within the same cloud page.

If the user does not select one or more predetermined and or pre-configured ‘Favorite(s)’ or ‘Default’ cloud or cloud page(s) (as described in a previous step) or one or more elements linked thereto, then the user preferably takes the following steps (I.) entering one or more geographic-territory specific criteria using cloud geographic-territory user-input means; (II.) entering one or more category or subject specific criteria using cloud category or subject user-input means, such that the system's software performs the step of (n) accessing one or more databases and data-files pertaining to the databased multiplicity of GT&C specific and/or GT&S specific clouds or cloud pages in response to the criteria entered into the user-input means. Following one or more search criteria-entering steps (or the default page(s) selection step), and database data-file(s) accessing steps, the system's software performs the step of (IV.) displaying within a Web page or viewable area of a portable browser apparatus screen, a representation of one or more user-selected geographic-territory and/or category specific clouds each displaying associative discernible content ‘ADC’ elements pertaining to the geographic-territory specific and category or subject specific criteria entered by the user; and an optional last step comprises (V.) providing the option for a user to select and complete a payment for one or more financial transactions displayed in response to a user interaction made via a suitable user input device with an interactive ADC element of the displayed GT&C specific and/or GT&S specific cloud, and/or optional co-located text-based listing hyperlinked element.

In addition to the ADC elements displayable in a cloud page, the system optionally provides computer executable instructions for displaying other co-locatable cloud page content such as text listings and/or descriptions, graphics, maps, comments, reviews, and the like, to increase exposure probability by providing offerings or propositions that are most relevant to locations of interest to users and to display additional information in order to help the user make a choice and to take action, for example to place an order. Any of such cloud page content can be displayed as a result of a search based on a location, or category, or subject (or any combination thereof) and can optionally include suggested customer interactions by hyperlinked words such as “Call, Order, Web, Map, Reviews” wherein such interactive words (or others) are associated with each reference or ‘hit’ of the search result, and provide a corresponding display of information relating to the word(s).

The system also provides a brand advertising multi-component inter-operability approach wherein the criteria and/or subject matter of one co-located component within the Web page user interface can be referenced by the system to display a related brand or related content in another co-located component. For example, a text-based listing resulting from a specified category or subject search of “Dentists” (preferably having a number of ‘hits’ pertaining thereto) can automatically be referenced by the system to display one or more graphical ADC elements representing a deliverables brand such as “Crest®” toothpaste and/or “Oral-B®”, or graphical representation of a brand logo and the like, within a co-located cloud. Similarly, in a locality-specific search, for example also including the category or subject “Groceries”, the subject criteria can automatically be referenced by the system to display one or more ADC elements representing a deliverables brand such as “Campbell's®” or logo of “Campbell's®” soup. Such ‘branded’ ADC elements may be linked or otherwise associated with digital media content such as video or audio files, or the like, optionally including educational content such as a Crest® ADC element being associated with a video promoting the benefits of flossing and brushing, or the Campbell's® ADC element being associated with a link providing a free e-book with 100 Soup Recipes, and the like.

It is estimated that more than 30% of all products sold on the internet are sold through affiliate referrals that are commissionable and paid by third-party affiliate networks. Such sales and their respective commissionable transactions and/or events are tracked and accounted for by third-party businesses such as Commission Junction, LinkShare, and Performics, wherein, each acts as a separate, third party intermediary in the transaction process between a reader of content viewable in a Web page or viewable area of a browser and a seller or advertiser who pays for hyperlinked text (or for user interactions related thereto) which appear within Web page content searched for and read by content-readers.

In previous internet approaches an ‘affiliate’ is someone who generates or otherwise facilitates the posting of content which is readable by internet users and in which one or more hyperlinked elements are displayed pertaining to, or transferring a reader to, one or more advertiser/seller offerings or propositions related to or associated with the hyperlinked element(s). The affiliate, who generates such content, serves as a type of referral agent between readers of that content and any offering(s) of an advertiser/seller displayed in response to a content-reader's interaction with the content's interactive hyperlinked element(s). The content generator is identifiable as an affiliate by an affiliate-code to a third party affiliate network business whereby he or she can receive commissions based on reader interaction with such hyperlink elements, such as a reader clicking on the element (i.e., a click event), or following a reader completing an online transaction.

While the prospects of providing such means for generating commissions for hyperlinked interactions such as referrals or transactions is responsible for a substantial percentage of internet related commerce, the process of becoming an affiliate participant in any of such affiliate networks is nonetheless an unnecessarily cumbersome one and is presently one that can be quite time-consuming. For example, someone wishing to participate as an ‘affiliate’ in an affiliate network must exit whatever Web site or Web page they are currently viewing, navigate through and choose among several third-party affiliate network businesses offering one or another versions of an affiliate-like program. A would-be affiliate then needs to know how to effectively generate and manage content and affiliate-coded hyperlinks within one or more other Web sites, or blogs, or forums, or wilds and the like (usually displayed within different Web pages). This has resulted in making the affiliate experience one which is exclusive to those who have the time necessary to learn how to effectively operate within one or more third-party affiliate network systems, and how to manage up to several (or numerous) Web sites or Web pages having the affiliate's generated content.

In contrast, the present system provides an arrangement wherein commissionable events are setup or configured and are made transactable within a single user interface ‘SUI’ or single Web site (or Web page) of the system, and are generated by the combination of (i) one or more co-located software application tool(s) ‘CSAT’ (proximate to at least one cloud-like ADC element grouping within the same Web page) providing storable, searchable and displayable C SAT-user generated content, and (ii) the system providing means, such as an advertiser/seller text-entry CSAT or utility program (or user interface text-entry window or pane) for accepting and storing one or more searchable words or word phrases as commissionable-related content or criteria. Such criteria is preferably identifiable in accordance with a location (e.g., storable as a data-file having a location-specific identifier or descriptor), and optionally identifiable with a category and/or subject so as to be cross-referenced or otherwise referenced or searched by computer executable instructions of the system. For example, wherein one or more software routines are responsive to a reader having entered search criteria which matches one or more location, or category, or subject data-file identifiers (or any combination thereof) associated with stored CSAT-user generated content (e.g., matching a CSAT text word, words or word string, or identifier associated with another type of digital media file). Criteria of any advertiser/seller previously entered and found by the system's software to matching CSAT-user generated content is displayed as an interactive revenue-generating element ‘IRGE’ (i.e. as a transaction-enabling or transaction-facilitating element).

In contrast to commissions having to be setup and managed at one or another third-party affiliate network Web sites and the need for content generators to navigate among and manage a plurality of Web sites or Web pages, the present system provides a more convenient and simpler approach for users to participate in commissionable events, wherein users do not need to gain special expertise in one or more separate Web sites or programs. For example, within a single user interface or single Web site or display area of a Web page thereof, the present system provides means: for the inputting and storing of advertiser/seller criteria; for the inputting and storing of CSAT-user generated content; for the searching and displaying of CSAT-user generated content in accordance with one or more search criteria entered by a content-reader and the displaying of any matches of advertiser seller criteria within such content which also matches or is related to the content-reader search criteria as an interactive revenue-generating element(s) ‘IRGE’; for data-file formats having associated identifiers which provide means for completing an arrangement whereby CSAT-users can receive any commission payments due from one or more advertisers/sellers. Thus, a self-contained commission enabling, commission-element configuring, and interactive commission-element displaying and commission event culminating arrangement, practicable within a single standardized user interface or single Web site is provided.

The single user interface ‘SUI’ or single Web site approach of the system increases exposure probability for content (or criteria) entered by an advertiser/seller because such input appears within and/or is displayed adjacent to, or in close proximity with, one or more of the aforementioned co-located components within the same single user interface ‘SUI’, Web site or Web page. Preferably, a plurality of the co-locatable, complementary and interoperable components are also equipped to display content which is related to the advertiser/seller input, e.g., wherein the content is related by a location of interest specified by a user or content reader, and optionally may further include the display of content also related to a category and/or subject.

Thus, users of the standardized user interface or single Web site approach of the present system are more likely to be engaged with, or take an interest in, content having inter-operable and/or inter-related locality-centric (and optional category and/or subject) content. When such components include the option of displaying one or more selectable co-located software applications Tool(s) ‘CSAT(s)’ also having inter-operable and/or inter-related locality-centric outcomes, which users (e.g., registered users) can individually use to create geographic-territory relevant blogs, forums, discussion groups, wilds, reviews, comments, calendars, or the like, the system further increases geographic-territory specific exposure probability of such content and for any advertiser/seller offerings or propositions, or IRGE(s) contained therein.

Preferably advertisers/sellers, users, content generators and content readers register to use the system and are provided access to use one or more selectable CSAT(S), for example, to generate CSAT-user content such as, in the creating and administrating of one's own blog(s), forum(s), wiki(s) and the like, and or by simply writing comments, reviews, or the like in the blogs, forums, wilds, and the like, of others.

Preferably any CSAT-user content generator may selectively choose, via one or more CSAT software options, whether or not, or to what extent he or she wants to be a participant in commissionable events. The system preferably employs the user's setup and/or preference information to determine whether to toggle on or off, or selectively determine the degree of the participation option. For example, when the option to not participate is selectively chosen by a user, any CSAT content generated by the user can be withheld from being linked to advertiser-related offers and commissionable events will not be provided. If the user chooses the option to participate in commissionable events, the system preferably automatically accesses the user's registration and/or preferences information which optionally includes personal data indicating where earned commissions should be sent. A user data configuring procedure includes the step of a user providing the system with accurate information as to their geographic location (e.g., in a user registration or Setup mode), which in turn, increases user involvement with one or more co-located components displayable in the single user interface ‘SUI’ or single Web site of the system, in that such components can, through the system's accessing of such data, provide locality-centric outcomes and/or relevance to the user's city or specified area of interest. For example, in the displaying of one or more ADC element cloud-like groupings or, CSAT(s) generated content, or co-located text-based listings, or any combination thereof, one or more computer executable instructions can thereby filter or otherwise limit the display of a component's content to a locality-centric relevance (and optional category and/or subject relevance), and thereby an enhanced exposure probability and accompanying increased awareness of any offerings or propositions pertaining thereto are achieved. Similarly, an automated accessing of a user's geographic-territory specific data by one or more software routines provides CSAT-user generated content and/or co-located text-based listings content which is relevant to the user's specified location of interest, and relevant to criteria or content entered by nearby advertisers/sellers. Similarly, when a content reader conducts a search using search criteria which matches, or is found to be similar to, such geographic-territory specific content, and then employs user input means providing interaction with one or more interactive revenue generating elements ‘IRGE(s)’ displayed within such content, any advertiser/seller offerings or propositions pertaining thereto can be displayed that are relevant to the user's specified location of interest, and relevant to criteria or content entered by advertisers/sellers within or close to the same geographic-territory. Interactivities with IRGE(s) or transactions pertaining thereto can result in one or more in a variety of arrangements for making the payment of any commissions due to a CSAT-user from an advertiser/seller, and such arrangements are described in the section pertaining to the detailed description of the preferred embodiments of the invention.

As previously mentioned a significant concern to internet commerce businesses which provide pay per click compensation or commissions to users, is fraud. Accordingly, to facilitate the prevention of (or a significant reduction in) click fraud, and fraud pertaining to the generation of commissionable content and/or other interactive-events, the present system provides one or more effective fraud preventative approaches which address this very costly problem and which readily facilitate the registration and identification of user, and advertiser and/or seller participants authorized to generate and/or configure, store and access content via one or more software applications and databases of the same integrated system.

Preferably all users and advertisers/sellers are provided access to the integrated system subsequent to their registering and/or logging-in through a secure user-authenticating procedure. Accordingly, for a user to be a content generator (and have content displayed), or be a Benefits Program commissionable-event participant, or for an advertiser and/or seller to be able to configure and/or enter (or select) advertising content or one or more advertising criteria pertaining to any offering(s) or proposition(s) or deliverable(s) (or ADC element representation thereof), each must be a logged-in, registered user in good standing. System-displayable content generated by each registered user is databased in one or more integrated, secure storing medium accessible to the system. User-generated content is storable and accessible in a CSAT data-file format, and advertiser/seller-generated content and/or criteria (the latter for cross-referencing to search criteria entered or configured by a user) are storable and accessible in a CSAT data-file format, wherein each data-file format preferably includes an associated identifier which identifies a registered user and/or advertiser/seller respectively. Thus, the system's user-specific data-files can be monitored, referenced or searched, for typical and reasonable levels or thresholds, such as the level of repeated text or text-strings in content generated by registered users (versus fraudulent, highly repetitive usage of keywords and/or text in user-generated content). Similarly, computer executable instructions of the system can store and reference data pertaining to each click event of a given registered user's clickstream history and such data can be monitored, referenced or searched, for typical and reasonable levels or thresholds of repeated click events, wherein each data-file record includes an associated user-identifier, or can otherwise be stored or categorized in a file organizing manner which associates that data with the identity of its respective user. Users exceeding reasonable thresholds can be notified e.g., by email, phone message or fax (or the like) and be prompted to rectify their behavior or lose privileges or benefits offered to them by one or more of the complementary components of the integrated system.

The combination of registered user interactivity with, commerce-enabling associative discernible content (ADC) elements and registered user clickstream data of the system lower advertising cost and increase exposure probability for the majority of registered advertisers and/or sellers because relevant advertising is shown to consumers whose interactivity and clickstream data defines and describes their geographic locality, demographics, interests and buying preferences.

Accordingly, the system provides an enhanced accountability (regardless of the name or pseudonym one chooses to operate under), in that registered users will know, or learn, or through their agreeing to a registration-user agreement before using the system, that their content, clickstreams and/or input will be identified with them as users (via one or more of the previously described user identity datafile identifiers) and there can be undesirable consequences for any abuse or fraudulent activity. For example, user-generated content having unreasonably repetitive text, keywords or phrases can result in that user having their content rated or ranked for other viewers according to one or more ranking criteria or scales or ranges. For example, the system can post an ‘Unnaturally Repetitive Content’ rating to produce one or more of the following outcomes: a significant reduction in viewers (e.g., by those viewers' own choosing), reduced system-redeemable Bonus Points, fewer IRGEs and commissionable-events, less benefits and privileges, or a curtailment of all privileges or access to the system. Optionally, notification of such a low rating (or pending rating) can first be communicated privately to a user, giving the user to an option to rectify their behavior before such a notice is made viewable to other users of the integrated system. On the other hand, a ‘High’ or ‘Excellent’ ranking (or other equivalent ranking e.g., an upper ranking on a numeric scale) whether determined by an automated mode of the system which compares and contrasts user's datafile input in accordance with one or more acceptable thresholds or limits (such as any of those previously described), and/or caused by feedback or selectable input from viewers which rates a user's content generally can produce a significant increase in viewers, thereby producing increased system-redeemable Bonus Points, increased IRGEs and commissionable-events, increased benefits and privileges, positive notices, ratings and the like. In other words, the more a user creates generally positive, helpful and constructive content, the more likely that user is to accrue significant benefits and/or revenues offered by one or more of the integrated, complementary components of the present system.

Thus, an acceptable range or threshold of repetitive user-identifiable content created and/or displayed in the system's integrated content generating and displaying co-locatable components, and/or user-identifiable clicks on any interactive elements or IRGE(s) of the system, can be monitored, recorded, referenced and searched for typical and reasonable repetition or redundancy levels. For example, executable computer instructions can provide such monitoring or referencing of the data-files and/or click records and can do so in accordance with one or more predetermined allowable thresholds. If an allowable threshold is exceeded or fraud is deemed likely, executable computer instructions can provide corrective measures including, but not limited to one or more of the following: prevent further display of the user's content; cease recording and reporting of the user's click commissionable-event or transaction related activity; provide an indication, rating or warning viewable to others who view the user's content and/or paying for interactions (e.g. paying for pay per clicks) that reasonable allowable limits have been or are exceeded; notify the user that any one or more of such punitive actions is about to, or has occurred; inform the user that such actions are considered fraudulent and/or illegal and appropriate legal action may or will take place; ban the user indefinitely, put the user on probation or temporarily prevent the user from being a participant in the seamlessly integrated content generating and commerce-enabled components of the system, and the like.

Accordingly, the system protects advertisers and their clients from the aforementioned costly types of fraud through its integrated approach. This approach includes requiring that only registered users can use the full scope of the system. For example, content generators who wish to participate in the pay per click ‘PPC’ processes of the system must register their name, address, phone number, and the like, and have their identity verified by the system in order for them to receive payment, Bonus Points or other compensation related to clicks on keywords within text they have generated within the system. Preferably another protection provided by the system includes computer executable instructions for monitoring the volume of CSAT content or keywords and/or phrases related thereto, in accordance with reasonable thresholds of content output for a given period of time. For example, a single content generator can be limited to not more than X number of web or CSAT pages, or Y number of keywords, IRGEs or phrases per web or CSAT page in a day, month, or year. Such limits can additionally include not more than X number of web or CSAT pages, or Y number of keywords, IRGEs or phrases per web or CSAT page for a given category, topic or subject matter within in a day, month, or year. Thus the system (or one or more administrators thereof) can set one or more reasonable threshold of pages on which the system will pay per click on keywords appearing within pages or randomly selectable pages. Such limits, and having users and advertisers/sellers registered and verified by the same system, provide a means for preventing or greatly reducing cheating such as the use of computer-generated web pages filled with, or out-sourced (non-registered) labor generating high-paying keywords and content. Preferably another protection provided by the system includes computer executable instructions for monitoring clicks of registered users wherein clicks are only deemed payable or commissionable when registered users click on a PPC-related item, and are not paid when a registered user clicks repeatedly and/or intermittently on the same PPC-related item. The for monitoring of clicks of registered users provides the means to employ other types of limits such as, the system only paying content generators when a registered user clicks on less than X number of PPC-related links or IRGE(s) of one or more predetermined types in a day, month, or year. Setting such reasonable thresholds or limits on paid-for-clicks, prevents content generators from employing one or more non-registered users who fraudulently seek to make a living by clicking on the PPC-links within the content of a content generator. In addition, since the clickstream (or click/user input history) of all registered users of the system is known, the system can choose not to pay for any clicks when fraud is suspected on the part of content generators and/or on the part of registered users whose browsing of content and clicking activity is suspected of click fraud. Preferably this protection includes identifying content generators and their computers (e.g., via an IP address, registration data or the like) so that those who share access to their computer, are not paid for clicking on PPC-links within content they've generated. Taken separately or collectively, these primary protections and their application via the integrated complementary components of the system, protect advertisers and their clients from the substantial degree of fraud occurring in the non-integrated status quo approaches.

In another embodiment of the present invention, ADC elements, such as cloud-based or text-based listing ADC elements can be displayed on external websites which operate outside of the user interface of the system (owned or operated by others who are registered with the present system). In such cases, computer executable instructions, such as a javascript, applet or other self-running application (available to Web site operators registered with the present system) storable on and operable from one or more servers of a Web site, provides a displaying of ADC content which are contextually matched to the content displayed on one or more pages of the Web site. For example, if the content on the Web page were about horse breeding, the ADC content on the ADC-cloud generated by the system would match the subject of horse breeding (including the option to find and display matches of that subject matter found within one or more databases of the present system). Remote or internal ADC content can include individual pay per click ‘PPC’ interactive elements each related to one or more advertisers and/or sellers. Optionally, the system can be setup to pay for such clicks or transfer PPC-credits to the website owner. Similarly, the system can be setup to pay for clicks or give credits for clicks, such as a credit equal to what would have been paid per a given click, and/or include a “credit bonus amount” equal to a multiple of the amount. When credits are also provided by the system to the website owner, he or she can convert such earnings to pay for additional advertising displayable within the present system. Preferably when a payment or credit per click is computed, different compensation levels are provided for interactivities of non-registered and registered users. For example, an advertiser or seller whose one or more ADC elements appear in an external Web site can pay a reduced PPC fee or credit for clicks made by a user not registered with the present system. Alternatively, the advertiser or seller can pay a full or higher PPC fee or credit for clicks made by a registered user of the system. The variable fee compensation modes of the system may be conducive to deterring non-registered external Web sites from participating fraudulently, and, and the system providing interactions which preferably occur with registered users protects advertisers and/or sellers from making PPC payments related to fraud.

Further protections from fraud are provided by the present system through the preferred modes of dealing with users who are registered with, and whose identity is verified by the system. For example, transactionable events (e.g., purchases of one or more products, activities and/or services) displayed by the system occur only with registered users, and commissionable events preferably occur with, and commissions are paid to, registered users. The verification processes include associating one or more other identifiers with each user, for example, a verifiable password, log-in entry, email address, and/or physical address of a registered user who clicks a commissionable link resulting in a sale within the system. To further protect, and provide increased incentives to, registered advertisers/sellers of the system, optionally a percentage of each, or of certain types of, PPC revenue or credits (or commissions pertaining thereto) can be credited by the system to the advertisers and/or sellers who have commissionable interactive elements, IRGE(s), hyperlinks or the like, and of any sale resulting from user interaction with any of such elements. Such credits and/or commissions can be provided during a specified time period, or for one or more repeated time ranges occurring within an hour, day, week, month, and the like. Thus, the system provides PPCs having reduced-costs and improved advertising effectiveness and fraud preventative protection, including doing so during through the completion of transactions made by registered users.

Accordingly, there is a need for performing rapid searches wherein there is a substantial improvement in the percentage of hits that are relevant to or contextually congruent with both a user's search criteria and a specific geographic-territory of interest to that user, and wherein associative discernible content ADC elements related to and or congruent with such improved search results are also displayed in one or more co-locatable software (user interface) components of the system, providing one or more options whereby a user may interact with such content to further facilitate a transaction. There is also a need for a new system wherein, within a single user interface ‘SUI’ commissionable-element interactivity and events can be setup or configured and transacted and thereby be made significantly easier to learn and use.

Thus, there are numerous deficiencies in the previous approaches taken and a new improved approach is needed. It is an object of the present invention to provide improvements which overcome the aforementioned deficiencies and to improve internet-searching and the relating of transaction-enabling ADC elements to the results of such searches, and to optionally provide proximate to GT&C specific and/or GT&S specific search results, user and/or customer productivity Tools (CSATs) (for users or advertisers) operable within a search-engine single user interface ‘SUI’. Another object of the present invention is to provide a plurality of complementary, and interoperable co-locatable software components which are displayable proximate to one or more ADC element groupings or ‘clouds’ to facilitate inter-operability or inter-relatedness between SUI-displayable components equipped to provide transaction-enabling (or transaction-facilitating) and locality-centric outcomes. It is another object of the present invention to enhance the exposure probability and geographical territory relevancy of cloud-like groupings and text-based listings of commerce-enabled advertising content contextually related to and simultaneously displayable with content generated by one or more co-located software application tool(s) shared among a community of network users. Another object of the present invention is to provide geographical territory specific and subject specific auto-tagging of user content generated or advertiser/seller content within co-locatable software application tool(s). It is another object of the present invention to provide auto-linking of user content generated within co-locatable software application tool(s) (CSATs) by employing computer executable instructions to search for exact matches (or optionally for similar matches) of advertising or transaction related criteria entered by advertisers/sellers found within storable CSAT content, and automatically display a found match within a display area of one or more co-locatable software application tool(s) (or text-based listing) as commerce-facilitating hyperlinked content or as an interactive revenue-generating element (‘IRGE’). It is an object of the present invention to provide computer executable instructions which are responsive to input by a user employing user input means such that an IRGE displayable in a CSAT or text-based listing in response to user input displays one or more hyperlinked, or otherwise-interactive, offerings or propositions from two or more different advertisers/sellers.

### BRIEF DESCRIPTION OF THE DRAWINGS

FIG. 1 is a generalized diagrammatical depiction of the invention illustrating how the elements or components of the invention may be incorporated in the context of a system.

FIG. 2 is a generalized diagrammatical depiction of the invention illustrating how one or two procedures may be taken to implement the system of the present invention in the context of a method.

FIG. 3 depicts a portion of a software user interface component viewable in a display screen area of a portable or stationary browser-equipped apparatus, wherein the interface component provides a searching or navigation to one or more clouds having geographic-territory specificity based on geographic-territory and/or category or subject criteria entered by a user. The same user interface component is depicted in the lower left portion of FIG. 4.

FIG. 4 depicts a portion of a software user interface which is viewable in a display screen area of a stationary or portable browser-equipped apparatus, wherein the user interface includes a display area in which a grouping or cloud-like arrangement of a plurality of closely arranged alpha-numeric text elements each relating to a geographic-territory and/or category or subject criteria entered or selected by a user. To the left of the text cloud-like arrangement are optional navigation and text-listing co-located components simultaneously displayable in the same interface, with the text-related content pertaining to the geographic-territory specific and/or category or subject criteria entered by a user.

FIGS. 5 and 6 are views similar to FIG. 4, wherein the user interface of FIG. 5 depicts a geographic-territory and category specific cloud being optionally scrollable and optionally having a plurality of proximate user selectable tabs whereby a user can select between different types of clouds by selecting one of the tabs. To the left of the cloud area in FIGS. 5 and 6, a co-locatable software application ‘Tool’ (CSAT) is depicted being opened and located so as to be operable adjacent or proximate to the cloud. In FIG. 6, the software application (CSAT) has an opened drop down menu providing user choices optionally including choices affecting the content which appears in a ‘User(s)-Cloud’.

FIGS. 7 and 8 are views similar to the user interfaces depicted in FIGS. 5 and 6, wherein in FIG. 7 a co-located software application Tool ‘CSAT’ is identified as a ‘Blog’ content generating and managing tool which accepts the input of Blog CSAT-user content, and the system is equipped with software to make displayed CSAT content interactive when matching content or criteria previously entered by one or more advertisers/sellers, and can optionally display a listing of one or more sellers within a co-located display area of the same user interface.

FIG. 9 is a generalized diagrammatical depiction of Auto-Linking and Auto-Tagging aspects of the invention which occur within a single user interface, Web page or cloud page of the system.

FIG. 10 is a generalized diagrammatical depiction of steps taken in a method of employing the system, wherein the steps of generating content or input by users and advertisers/sellers is followed by an indexing and storing of data-files each having one or more associated geographic-territory and category (and/or subject) ‘GT&C/S identifiers, which enables a cross-referencing of the stored content so as to display criteria-matched transaction-enabled associative discernible content ‘ADC’ elements within different co-locatable software components and a simultaneously displayed in the same software user interface ‘SUI’.

### DETAILED DESCRIPTION OF THE PREFERRED EMBODIMENTS

As previously mentioned, the term ‘cloud’ is used generically within the context of the present invention to refer to a closely arranged grouping of user interactive and preferably transaction-enabling (or transaction-facilitating) geographic-territory specific associative discernible content associative discernible content ‘ADC’ elements. Each ADC element is displayable for a pre-determined period of time for an advertising fee, and is storable as a data-file having one or more associated data-file identifiers including at least one geographic-territory identifier and optionally including a category identifier and/or subject identifier. Following the payment by an advertiser/seller for the right to display an ADC element within a cloud-like grouping for a pre-determined period of time, the data-file pertaining to the ADC element includes at least one identifier which identifies the advertiser/seller. ADC element data-files and their respective data-file identifiers are storable in one or more storage media (e.g., one or more servers) accessible to data-file managing software of the system. One or more groupings or cloud-like arrangements of ADC elements (hereinafter referred to as ‘clouds’) are displayable in a display area of a browser interface (or display area thereof) in accordance with a search conducted by a user which has included at least a geographic-territory criterion and may optionally also include one or more category criteria or subject criteria, or both.

In a preferred embodiment of the system, a plurality of different, interoperable co-locatable software components are displayable in a single user interface ‘SUI’ or single GUI of the system each including computer executable instructions for accepting user input and for generating one or more commerce-related or transaction-facilitating outcomes pertaining relating to a specified geographic-territory and optionally also relating to a specified category, or subject, or both. A single standardized user interface ‘SUI’ screen such as a single Web site (or Web page or ‘Cloud page’ thereof) provides means for: the selecting or entering of, and the completing of payments for, ADC elements by advertisers/sellers; the manual entering of, or a pre-configuring of automated, cloud search geographic-territory specific criteria; the conducting of geographic-territory specific cloud searches by users, the display of one or more geographic-territory specific commerce-enabling clouds; the display of one or more other co-located and inter-related user interface geographic-territory specific components and the employment and management of each by a user; and an optional interoperability between at least two of the co-located geographic-territory specific components. Such interoperability can include computer executable instructions for cross-referencing data derived from content input into one co-locatable component with content input into one or more other co-locatable components. For example, within the same, single user interface ‘SUI’: content entered by a registered user in a first co-locatable software application tool ‘CSAT’ can be cross-referenced with content entered or selected by one or more registered advertisers (or sellers) in a second co-locatable ‘Advertising’ CSAT (or similar co-locatable SUI advertisement-configuring component) to cause a displaying of one or more interactive revenue generating elements ‘IRGE(s)’ to be displayed in the first CSAT component. Alternatively or additionally, within the same SUI: content entered by a registered user in a first co-locatable software application tool ‘CSAT’ can be cross-referenced with content entered or selected by one or more registered advertisers (or sellers) in a second co-locatable ‘Cloud ADC Element-Configuring’ CSAT to cause a displaying of one or more interactive, transaction-enabling (or transaction-facilitating) ADC elements in a third co-locatable cloud component, and so forth

In a similar embodiment further comprising one or more selectable co-located software application Tools ‘CSAT(s)’ displayable and operable within the single standardized user interface screen or single Web site (or Web page thereof) provides the means for a user to generate CSAT content storable in a data-file format including at least one geographic-territory identifier and optionally including a category identifier and/or subject identifier. For example, a content-reader subsequently employing the system's search component and software to conduct a search using search criteria matching one or more identifiers, provides system access to and means for displaying any CSAT-content data-file associated with the identifiers, in a manner wherein interaction by user input means of a content-reader with an interactive revenue-generating element ‘IRGE’ displayed within the criteria-matching CSAT content causes a commissionable event whereby the CSAT user who generated the content is provided an arrangement wherein the payment of any commission due can be completed.

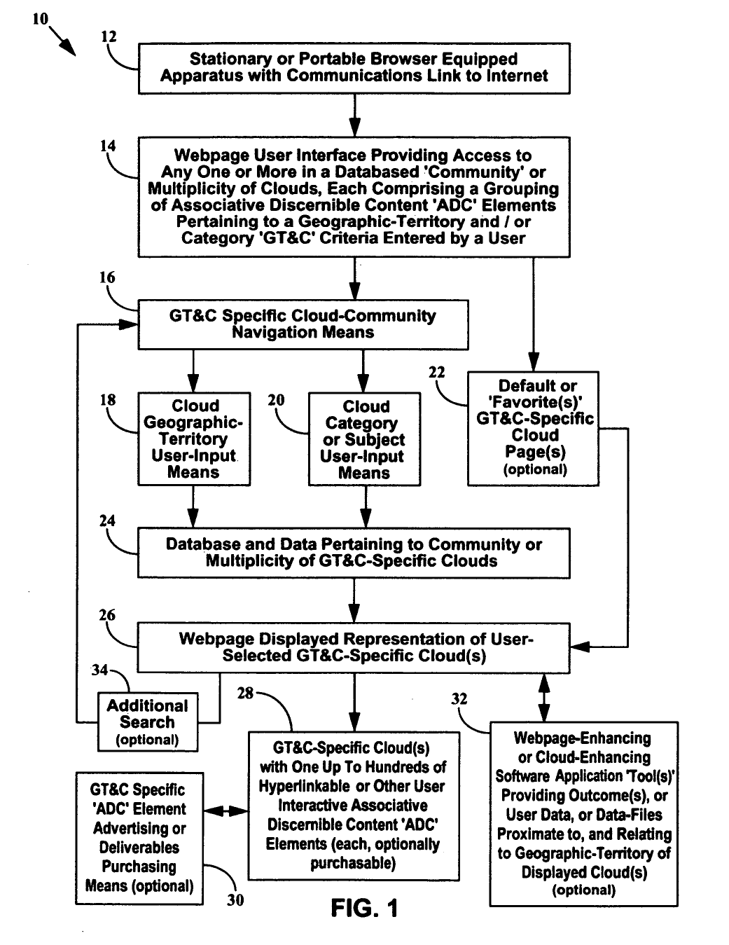

In reference to FIG. 1, a generalized diagrammatical depiction of a preferred embodiment of the system 10 illustrating how the elements or components of the invention may be incorporated in the context of a system is provided, wherein a relationship of elements or components of the invention are illustrated in the context of a system.

The system is employable in two primary modes: (i) as a stand-alone Web site or self-contained type of online search-engine and geographic-territory and/or category (or subject) specific cloud-element advertising model, or (ii) as a non-stand-alone system variant, for example, when integrally incorporated into, or associated with the use of, an existing internet Web site having one or more search-engine and/or database referencing capabilities. In either mode, user input means interaction within one of the system's components (co-locatable in a single user interface of the system) results in the display of commerce-enabling or commerce-facilitating interactive elements in one or more of the system's components.

Incorporation of the present system within a search-engine user interface of an existing internet search-based or search-capable Web site can be provided by simply including one or more user interactive ‘Cloud’ links or cloud icons (e.g., wherein a text link wording such as “Cloud” or “Location-Specific Cloud” or “GT&C Cloud”, or “Local Cloud” or the like, is displayed and hyperlinked and appears underlined) as a user interface element of the Web site's search page(s), which a user can click on as a search category option to narrow their search(es) to a ‘navigating’ among, or the displaying of, Web pages equipped to display one or more clouds and transaction-enabling ADC elements thereof in accordance with cloud search criteria the user has entered.

Each of the FIG. 1 reference numerals 12 through 34 refer to a block or text-enclosing rectangle in the generalized diagrammatical depiction, as follows: a “Stationary or portable browser equipped apparatus with communications link to internet” 12 is employed to navigate online to a “Web page user interface providing access to any one or more in a databased ‘community’ or multiplicity of clouds, each comprising a grouping of associative discernible content ‘ADC’ elements pertaining to geographic-territory and/or category ‘GT&C’ specific criteria entered by a user”14.

For ease of reference, the acronym “GT&C” as used in the following descriptions refers to ‘geographic-territory and category’ or alternatively ‘geographic-territory or category’, and the acronym “GT&S” refers to ‘geographic-territory and subject’ or alternatively ‘geographic-territory or subject’. The acronyms are used in the descriptions relating to the system's co-locatable, complementary components, to its interactive, transaction-enabling (or transaction-facilitating) ADC elements, and auto-tagging processes. For ease of reference the acronym “GT&C/S” is used in the following material to mean ‘geographic-territory and category’, or ‘geographic-territory and subject’, or both. The acronyms also refer to data searching and/or referencing criteria which narrow the displaying of transaction-enabling elements and/or content within one or more of the aforementioned complementary components to the specificity of the criteria used in a search.

Computer executable instructions of the system provide means for referencing or searching databased cloud-related data and/or associated data-file identifiers or descriptors based on any one or more of the following search criteria: one or more geographic-territory criteria, one or more category criteria, one or more subject criteria, or any combination thereof. In response to the conducting of a search, computer executable instructions display one or more clouds preferably within a single user interface ‘SUI’ of the system such as a cloud-displaying Web page (or ‘cloud page’) or user-selectable or configurable ‘Home’ page, based on the search criteria.

It is noted that terms ‘computer executable instructions’ and ‘software routines’ or ‘one or more software routines’ as used in any descriptions pertaining to the present system are used interchangeably and can alternatively mean ‘algorithm’ or ‘one or more software algorithms’ and the like.

The term ‘cloud’ refers to a word cloud or a cloud-like grouping of GT&C specific and/or GT&S specific suggestive and/or associative discernible content ‘ADC’ elements, with each ADC element preferably providing transaction-enabling outcomes and user and/or advertiser interactivity. The ADC elements can be comprised of one or more words, and/or non-word ADC elements such as graphical representations of one or more types of digital media files.

The term ‘components’ as used in the specification refer to a plurality of co-locatable software user interface components, displayable within a single graphical user interface ‘GUI’ or single user interface ‘SUI’ of the system. The complementary and interoperable components co-locatable within the same GUI or SUI are selectable from a group comprising one or more: co-locatable software application tool(s) or ‘CSAT(s)’; component(s) for accepting input from advertisers/sellers; word cloud(s) or cloud-like grouping(s) of interactive, transaction-enabling (or transaction-facilitating) associative discernible content ‘ADC’ elements; text-based listing(s); component or component-content ‘navigating’ or search-conducting element(s); and arrangement(s) for completing one or more payments and/or transactions via a transaction instrument. The co-locatable components have a complementary interoperability wherein user input into one component causes and/or affects the displaying of transaction-enabling or transaction-facilitating elements in one or more other components (displayable within the same GUI or SUI). Preferably transaction-enabling elements, displayable within one or more co-locatable components are displayed in the same GUI or SUI in response to a matching or relating of user-entered content and advertiser/seller configurable criteria, or entered criteria, or selected criteria. Such criteria can include one or more of the following specificities: a geographic-territory, a category, a subject, or an auto-tagging criteria or outcome (the system's auto-tagging functionality is described in detail in a subsequent section of the specification). Thus, the system provides means for the input of user-generated content, for advertiser/seller input and advertising criteria configuring, for enabling, facilitating and completing transaction-related activities within the same GUI or SUI.

The terms ‘navigate to’ and ‘navigation’ as used in the specification are used figuratively and refer to search results displaying outcomes of software routines of the system, which, in accordance with one or more cloud-search criteria entered by a user, reference the system's databased cloud-related data and/or data-files and then display one or more clouds in a cloud Web page or viewable cloud display area of stationary or portable browser-equipped apparatus based on search criteria-matching data and/or data-files (thereby giving the user the sense that he or she has ‘navigated’ from one page or cloud to another in response to their entered search criteria).

The system is equipped with file accessing and managing computer executable instructions to store, index, update, reference and display data or data-files pertaining to a databased ‘community’ or multiplicity of clouds and respective cloud ADC elements having (i) geographic-territory specificity, or (ii) category or subject and geographic-territory specificity, or (iii) or category or subject specificity, and thus provides a databased data indexing and searching means whereby users can conduct searches using criteria having any of such specificities, and thereby the representation of one or more groupings of ADC elements (or ADC element clouds) can be accessed and displayed within a cloud page in response to such user-entered search criteria. Thus, the system provides the means to conduct searches, generate and display one or more clouds displayed within a single cloud page/user interface, and preferably does so with clouds comprising transaction-enabled ADC elements. Preferably displayed cloud content is related to or based on user-entered search criteria having geographic-territory specificity, or category (or subject) and geographic-territory specificity, or category (or subject) specificity (and the system software optionally can display one or more co-located, complementary and interoperable components, such as cloud-proximate software application Tools and/or text-based listings related to such search-criteria within the same page/user interface). Studies have indicated that the human mind scans for relevance according to one's current or immediate need(s), or desire(s), or preferences, and often such concerns are ‘close-to-home’ (e.g., for someone needing a new tire or oil change, wanting to order pizza for their family, or wanting to go to a movie). Accordingly, the system's method of conducting searches by employing any one or more of such search criteria (preferably with the convenience of the search being conducted in the same cloud page/user interface) and displaying cloud content, and optional related co-located content, within the same cloud page in response to that criteria, improves exposure probability of cloud content and increases awareness of the cloud's interactive ADC elements and the suggestive nature of such content, and thereby enhances the advertisement value of the transaction-enabled ADC elements of such clouds. Thus, the higher the ratio of, and the utility associated with, search references or ‘hits’ relevant to a user's needs (following a user-configured search), the longer the user is likely to stay engaged with the search results and related suggestive and/or associative cloud ADC elements. Accordingly, the user is likely to spend more time perusing the system's cloud ADC elements and any optional co-located content (on the same cloud page) which he or she finds to be congruent with or relevant to their current or immediate need(s), or desire(s), or preferences.

The enhanced exposure probability in turn produces increased awareness of ADC elements and optional co-located component content which also improves advertising effectiveness. Advertisers paying for the display of any of such elements and/or content within a cloud page and it being linked to, or otherwise interactively associated with, one or more displayable transaction-enabled offerings, or propositions provided by the same advertiser, also benefit from knowing that their advertisement(s) will be contextually congruent with a user specified location, or subject, or category, or any combination thereof, and thereby are likely to improve their ratio of qualified potential or repeat customers. The system optionally provides software routines whereby users may do searches solely or initially using as little as one category and/or subject criteria, which, while producing search results that are likely to be broader than when employing the aforementioned narrower search criteria, nonetheless also provides content which the user knows will be congruent with their specified category and subject and knows can readily be browsed or scanned for relevance to an immediate or current need or preference (albeit not as specific). The broader scope of such cloud searching(s) and cloud displaying(s) in a cloud page can also be attractive to advertisers who have products, or services, or activities (or any combination thereof) that are not location specific or geographic-territory specific (for example advertisers who advertise nationally or internationally).

As previously mentioned, the term ‘browser equipped apparatus’ can include any one or more among a variety of stationary or portable browser equipped apparatus having a communications link with the internet (whether attaining an internet connection via a cable connection means or via a wireless connection means) including but not limited to: home or business desktop or laptop computers, cell phones, PDA's, audio playback devices, handheld computing devices, handheld computing devices equipped with GPS means, and the like (and as previously described, the term ‘internet’ can alternatively mean one or more other large-scale publicly-accessible networks or publicly-accessible computer networks and the like).

The network represents the communication pathways between browser equipped apparatus and the online system. In one embodiment, the network is the Internet. The network can also utilize dedicated or private communications links that are not necessarily part of the Internet. In one embodiment, the network uses standard communications technologies and/or protocols. Thus, the network can include wireless links using technologies such as WiFi, 802.11, wide area network (WAN) services, integrated services digital network (ISDN), digital subscriber line (DSL), asynchronous transfer mode (ATM), and the like. Similarly, the networking protocols used on the network can include wide area network (WAN) services, multiprotocol label switching (MPLS), the transmission control protocol/Internet protocol (TCP/IP), the hypertext transport protocol (HTTP), the simple mail transfer protocol (SMTP), the file transfer protocol (FTP), etc. The data exchanged over the network can be represented using technologies and/or formats including the hypertext markup language (HTML), the extensible markup language (XML), javascript, AJAX, and the like, or variants thereof, etc. In addition, all or some of the links or information transmittable as a result of any user, or reader, or advertiser/seller interactivity with the links can be encrypted using conventional encryption technologies such as the secure sockets layer (SSL), Secure HTTP, HTTPS, and/or virtual private networks (VPNs). In another embodiment, the communications technologies and/or protocols can use custom and/or dedicated data communications technologies instead of, or in addition to, the ones described above. Preferably the system is also equipped to display RSS feeds in any browser application equipped apparatus or device or any within a software application of any operating system thereof.

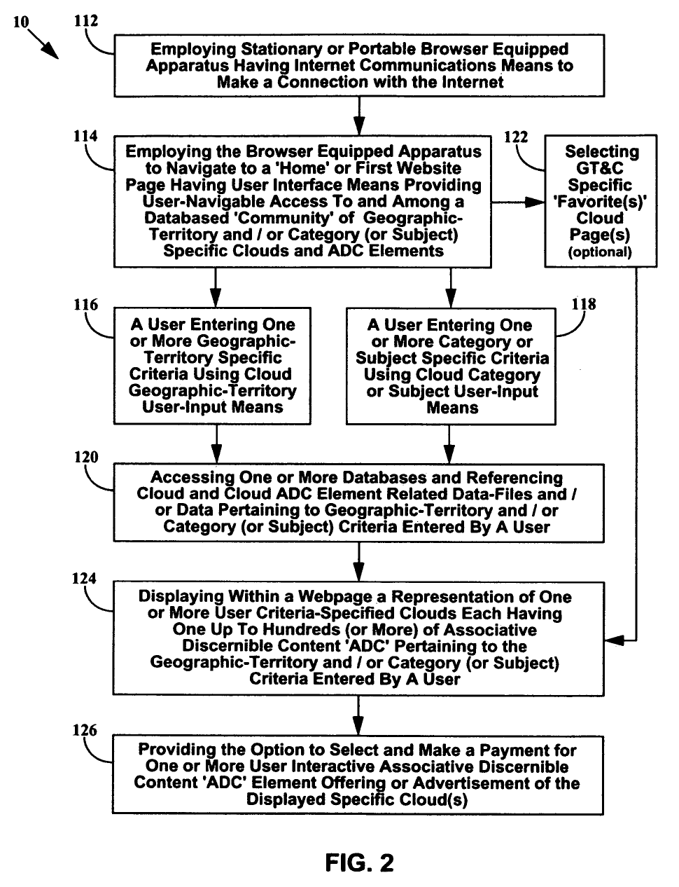

In reference to FIG. 1, Web page user interface 14 provides users ‘GT&C/S specific cloud navigation means’ 16 in the form of ‘Cloud geographic-territory user-input means’ 18, ‘Cloud category or subject user-input means’ 20 and optional ‘Default or ‘Favorite(s)’ GT&C/S-specific cloud page(s)’ user selection means 22. In response to GT&C/S-specific cloud search related input entered by a user in 18 and 20, or optionally a single input made by a user in 22, one or more software routines of the system access or provide a referencing of at least one ‘database and data pertaining to a community or multiplicity of GT&C/S-specific clouds’ 24 and displays a representation of one or more GT&C/S specific clouds or GT&C/S specific cloud-pages in accordance with the user-entered search data or criteria. It is noted that the term ‘community’ of diagram block 24 of FIG. 1 (and as used in diagram blocks 114 and 120 of FIG. 2) is used figuratively and refers to a broad range of various GT&C/S-specific cloud-related data-files (such as location and/or other search-criteria specific groupings of ADC elements) or GT&C/S-specific cloud-pages, storable and retrievable from via one or more databases accessible to the system. The data-files are stored in a format wherein a user may search until—in accordance with and in response to user-entered search data or criteria—a representation of one or more GT&C/S-specific clouds (comprising interactive, transaction-enabled ADC elements) derived from the accessed database data is/are displayed in a display area viewable in the user's stationary or portable browser-equipped apparatus. For example, in response to the entering of one or more suitable search criteria, the system is equipped to display ‘Web page displayed representation of user-selected GT&C/S-specific cloud(s)’ 26 with a/the ‘Cloud(s) having one up to hundreds (or more) of GT&C/S-specific, hyperlinkable associative discernible content elements (each, optionally purchasable)’ 28. It is noted that the system can be equipped to otherwise represent a ‘community’ of geographic-territory specific clouds. For example, the system can provide one or more software routines wherein a text-based listing of geographic-territory specific clouds are listed, for example, according to one or more territory-size, or according to a hierarchy of territory sizes. For instance, a column or row text listing (or a menu, such as a pop-up or drop-down menu, or word cloud) can include countries, or states, or cities, or the like, and a user making a selection among a displayed geographic-territory preferably be shown a subordinate reference (text list, menu, word cloud etc.) whereby one or more search criteria can be inputted or further refined as needed, with the system preferably also providing the option for any selected territory to become one or more defaults as an easily recallable future selection. Similarly, one or more text-based columns or rows can alternatively be arranged adjacent to or in close proximity with one another, for example wherein a first column or row displays a text listing comprising a selection of locations such as countries, the next adjacent listing comprising a selection of locations such as states or provinces, the next cities, and so forth. Any of the selection choices is preferably hyperlinked to facilitate a narrowing of a geographic-territory specific cloud search or the finding of one or more desired geographic-territory specific clouds.

Preferably each user or advertiser who employs the system, does so following one or more secure and/or encrypted User Log-In and/or Password procedures, such as any among a variety of secure user identifying and authorizing software routines currently in use for secure online commerce and other internet purposes. When a user or advertiser of the system has searched for and accessed the display of a GT&C/S specific cloud, he or she can optionally initiate and culminate online commerce pertaining to that cloud's content by employing ‘associative discernible content or deliverables purchasing means’ 30. For example, in the case of advertising and the purchasing of one or more associative discernible content ‘ADC’ elements or advertisements, a novice or professional advertiser can employ browser apparatus user input means to click on, or rollover (or another common type of user interface element interactivity) a cloud's interactive, transaction-enabled ‘ADC’ element, for example, a displayed word, or plurality of words, or any in a variety of other non-text element(s), and be presented with one or more options. For example, the advertiser can be presented one or more options such as: configuring the manner in which the ADC element(s) will be displayed, and for configuring one or more parameters pertaining to any offering(s), or proposition(s), or deliverables purchasing, or rental, or leasing, or credit arrangement, and the like. Based on an ADC element configuring, the advertiser is presented a displayable arrangement for making one or more payments for any of such configurings via one or more conventional online authorized financial transaction instrument or means (e.g., following a user entering of a log-in and/or password) including, but not limited to, an entering of transaction data pertaining to one or more of the advertiser's identification, credit cards, debit cards, checking accounts, bank accounts, credit lines, credit union accounts, fund transferring means, wire transfer means, payments to be sent by mail, and the like.

Similarly, in the case of one or more deliverables transactions, a user (non-advertiser) can employ browser apparatus user input means to click on, or rollover (or another common type of user interface element interactivity) a cloud's interactive, transaction-enabling associative discernible content ‘ADC’ element, for example, comprising a word, or plurality of words, or other non-text element(s), and be presented with the display of information pertaining to the element(s), or one or more offering(s), or proposition(s) procedures pertaining thereto. Such procedures preferably include a displayable arrangement for the purchasing, or rental, or leasing, of one or more deliverables, and a procedure for culminating transactions by making one or more payments using any of the aforementioned payment methods.

The system includes computer executable instructions for optionally displaying ‘One or more Web page-enhancing or cloud-enhancing software application Tools proximate to GT&C/S specific cloud(s)’ 32, hereinafter referred to as a co-locatable (or co-located) software application tool ‘CSAT’. Each CSAT is a software application equipped with computer executable instructions to (i) accept the input of and display user-entered storable and retrievable data, pertaining to a geographic-territory, or category, or subject, or any combination thereof, and (ii) are preferably also equipped for providing one or more transaction-facilitating or transaction-related outcomes. For example, CSAT content generated by a user is storable in a data-file format wherein each data-file preferably has one or more associated search and/or referencing identifiers or descriptors, and such data can be automatically cross-referenced by computer executable instructions of the system so that criteria separately entered by one or more advertisers/sellers (within the same single user interface ‘SUI’ which displays co-locatable CSATs) can immediately be matched with a user's CSAT content to display offerings or propositions within a CSAT content display area (e.g., as one or more hyperlinked words) or within a cloud (e.g., as one or more user interactive, transaction-enabling ADC elements). Thus within a SUI of the system, advertisers/sellers can configure and enter (or select) advertising criteria, and users can employ co-located CSATs to generate, display and store content, and be presented with contextually-relevant interactive transaction-facilitating or transaction-enabling elements (pertaining to or relating to their content) within one or more complementary, co-locatable components of the system operable within the SUI.

The co-locatable software application Tool(s) CSAT(s) when deployed by a user is operative adjacent to or in close proximity with a GT&C/S specific cloud so as to provide a cloud-adjacent or cloud-proximate utility or usefulness that appeals to users in addition to their interest in that cloud's geographic-territory specificity and interactive, transaction-enabled ADC elements. The co-locatable aspect of the complementary components operable within a single user interface ‘SUI’ of the system, such as a ADC element cloud and one or more CSAT(s), create a proximity effect wherein the degree that a co-located Tool(s) is used by users, the awareness of the nearby GT&C/S specific cloud and its ADC elements are also increased and thereby, the individual and collective exposure probability of the components are improved.

When a search of CSAT-generated content (or data) is completed by a user or advertiser, one or more software routines of the system provides the option to do an ‘Additional search’ 34.

In reference to FIG. 2, a generalized diagrammatical depiction of a preferred embodiment of the invention 10 is provided illustrating two procedures, each implementing the system of the present invention in the context of a method. Each of the reference numerals 112 through 126 separately represent a step contained in a block or enclosing rectangle in the diagrammatical depiction, and can be viewed as a method having a series of method steps as follows: ‘Employing stationary or portable browser equipped apparatus having internet communications means to make a connection with the internet’ 112; ‘Employing the browser equipped apparatus to navigate to a ‘home’ or first Web site page having a user interface providing user-navigable access to and among database of data-files pertaining to geographic-territory and/or category (or subject) specific clouds and interactive, transaction-enabled ADC elements’ 114; ‘A user entering one or more geographic-territory specific criteria using cloud geographic-territory user-input means’ 116; and/or ‘A user entering one or more category or subject specific criteria using cloud category or subject user-input means’ 118; ‘Accessing one or more databases and referencing cloud and cloud ADC element related data-files and/or data pertaining to geographic-territory and/or category (or subject) criteria entered by a user’ 120; optionally ‘Selecting GT&C/S specific ‘Favorite(s)’ cloud page(s)’ 122; ‘Displaying within a Web page a representation of one or more user criteria-specified clouds each having one up to hundreds (or more) of associative discernible content ‘ADC’ pertaining to the geographic-territory and/or category (or subject) criteria entered by a user’ 124; and, ‘Providing a user interface arrangement for a user to make a payment for one or more user interactive associative discernible content ‘ADC’ element offering of the displayed GT&C/S specific cloud(s) 126. Alternatively, in a second shorter procedure) when a user or advertiser employs steps 112, 114 and 122 (including by means of a single user input, such as a click of a user input device on a hyperlinked ‘Favorite’), steps 116, 118 and 120 may be bypassed, and thereby the deploying of step 124 may be achieved with three fewer steps.

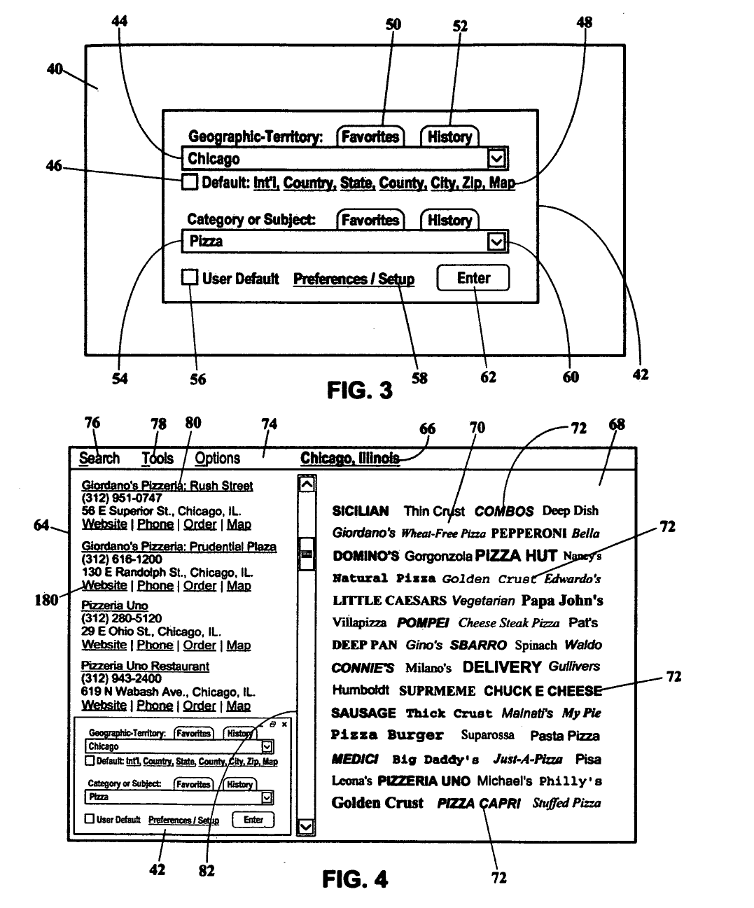

In reference to FIG. 3, a portion of a displayed browser page or Web page 40 having a software user interface search component is depicted being viewable in a display screen area of a portable or stationary browser-equipped apparatus or computer, or displayable in a single software user interface page of the system (such as component page 64 of FIGS. 4-8). The user interface component provides a navigation means for a user or advertiser to navigate to, or search among or for, one or more data-files pertaining to Geographic-Territory specific clouds based on his or her Geographic-Territory and/or Category or Subject search criteria. Preferably user interface navigation means 42 (co-locatable user interface component) includes a procedure whereby a registered user or advertiser is ‘recognized’ as an authorized ‘participant’ of the system by having ‘signed on’ via a log-in and/or password procedure (e.g., by employing any one or more available software routines, or cookies, or the like, for securely identifying and authorizing an online user). When one or more preferences or user-configurable options of the system are made available to an identified/‘recognized’ user following a secure logging in procedure, the user may configure and/or enter or select one or more preferences pertaining to any user-configurable option of the system, for example, including the home locality and/or one or more other locations specified by the user.

In one embodiment of the present invention, the user interface navigation means 42 (e.g., the user interface search component depicted in FIG. 3 and FIG. 4) preferably includes a Geographic-Territory specifying means such as a Geographic-Territory specific text criteria entry field 44 for accepting one or more user text entries (wherein, for the sake of an example, the word/Geographic-Territory “Chicago” is displayed), and a Category or Subject specifying means such as a Category or Subject specific text criteria entry field 54 for accepting one or more user text entries (wherein, for the sake of an example, the word/Category or Subject “Pizza” is displayed). Preferably the user interface search component includes computer executable instructions for conducting cloud data-file related searches based on the two types of criteria. Following the entry or selection of the criteria a user can employ a user input means of a browser equipped apparatus to initiate a search such as a clicking on a ‘Enter’ (or ‘Search’, or ‘Done’, or ‘Accept’) button 62 or when the system is equipped with voice-recognition software and a microphone a user can speak a voice command such as “enter” or “search”, and the like. Thus, in one mode of operation, upon the entry of two cloud-related data-file criteria, a Geographic-Territory and Category (‘GT&C/S’) specific cloud, or Geographic-Territory and Subject (‘GT&S’) specific cloud, can be navigated to (referenced and displayed) following a single clicking of an ‘Enter’ button, or a single spoken word voice command. It is noted that while FIG. 3 depicts two separate text search criteria entry cells, that the system can alternatively display a single text-entry cell or field wherein a user can enter more than one criteria, such as both a location and a category or a location and subject (e.g., “Pizza 78613” can be used for conducting a search of “pizza” subject matter in a Cedar Park, Tex. location) and implement the search by one of the previously described user inputs, or by pushing the ‘Enter’ key on a computer, or entry button or key on a portable browser-equipped device, and the like. Similarly, a user can enter “News 78613” or “Local News” in a single alpha-numeric text-entry field or cell and implement a search constrained to the combined criteria, e.g., displaying news-related content and/or ADC elements pertaining to the user's specified location or default or ‘Setup Mode’ text-entered criteria.

In a simpler, one-click, or one-step, mode of operation, following a user ‘Setup’ of user-configurable preferences parameters, one or more Default, or ‘Favorites’ or memory-recallable GT&C/S specific or GT&S specific cloud(s) can be ‘navigated to’ (i.e., displayed in the browser interface following a search) by clicking on a single interface element of the user interface navigation means 42. For example, one or more of the system's software routines can provide the means whereby a user, having clicked on one or more ‘Link(s) to Preference/Setup control means’ 58 (or by selecting a similar software routine(s) through any one in a variety of other common software user interface means) might select “Cedar Park, Tex.” as his default ‘Geographic-Territory’ parameter, and select “Restaurants” as his default or ‘Favorite’ ‘Category’ or ‘Subject’ parameter. Thereafter, the software accesses the parameters in response to (i) the user clicking on a single user interface element, such as: the ‘Enter’ button 62, or (ii) the combination of the user having first checked a ‘User Default’ checkbox 56 (or similar user interface element) and then clicking on the ‘Enter’ button 62, or (iii) the clicking on a hyperlinked or interactive word or wording such as ‘My Favorite’, or (iv) the making of a ‘Favorite’ menu selection. In each case, the simplified user interaction causes an accessing of search-criteria related data-files from memory storing means and displays one or more GT&C specific cloud(s) or GT&S specific cloud(s), giving the user the sense that he or she has ‘navigated to’ those clouds. Additionally or alternatively, any user-configurable ‘Default’ or ‘Favorite’ page is configurable and displayable as the ‘Home’ page of the system.

It is noted that while certain types of user interface search components or navigation elements have been described for conducting searches resulting in the display of one or more GT&C specific or GT&S specific clouds or GT&C specific or GT&S specific ADC elements thereof, that any one or more in a variety of other types of common user interface navigation means elements can alternatively be employed. For example, one or more alphabetical or alphanumeric indices can be employed and made interactive. For example, in one approach, a plurality of alphabetized letter and/or alphanumeric ranges are each hyperlinked (or are otherwise made interactive through one or more other software routines) such that when a hyperlinked letter range is clicked on by a user via suitable user input means, a narrowing of the user's search occurs, e.g., wherein a choice of selections resulting in a hyperlinked “A-D” range element being clicked on reduces the user's search to geographic-territory specific clouds beginning with the letters “A” through “D”. Additionally or alternatively, a similar interactive letter-range approach can be employed for referencing or conducting searches of categories and/or subjects beginning with the letters “A” through “D” by clicking on an interactive user interface “A-D” element.

Similarly, a single alphabetical or alphanumeric index such as an “A” through “Z” listing of each letter of the alphabet can alternatively be used to narrow search choices, or be used in combination with any user interface navigation means 42 elements, wherein, in either case, a user may simply click on a single hyperlinked letter or number of the index in order to constrain their search results to Geographic-Territory specific clouds and/or to Categories and/or Subjects beginning with that clicked-on letter. In another approach, the user may click on one or more links of the Geographic-territory scope defining means 48 (or other type of text-based listing) to narrow the geographic-territory specificity of their search. For example, territory-scope can otherwise be defined by a user input clicking-on a hyperlinked or other software-enabled user interactive element, such as any among the following types of words (or literally defined areas): “Universe”, “Galaxy”, “Solar System”, “World”, “International”, “Continent”, “Country”, “Territory”, “Province”, “Prefecture”, “Region”, “State”, “County”, “Jurisdiction”, “District”, “Precinct”, “Zone”, “City”, “Town”, “Village”, “Neighborhood”, “Street”, “Home”, “Room”, “Yard”, “Zip Code”, “Map”, “Within Zoomed Area of Map” (e.g., a currently viewable area), “Within 5 miles”, “Within 25 Miles,” “Within Miles” (responsive to a user entered number), “Within Sphere of Influence,” (or other predetermined or configurable distance range), and the like. Distance-range defining options can include a user selectively zooming in or out to a viewable map area (i.e., to choose a map magnification level or determine a particular scale), or a user specifying a distance range from a selected location to narrow search result hits to those located within or constrained to the user specified input (and to any additional user entered criteria when input, such as a subject or category related criteria, or both). Following a determining of any of such criteria, computer executable instructions of the system then access data-files having, or associated with, that criteria. Additionally, geographic-territory specific data can be constrained to information within a definable area such as the relative distance between a plurality of locations or the absolute distance from a user specified location and one or more locations, for example by including longitude and latitude data for each databased geographic-territory related reference. In the unlikely case when a search specified by a user within a prescribed distance range does not produce an adequate or desired number of results, the system can optionally provide software routines whereby the area of the search is automatically or user-controllably expanded to one or more greater areas until a satisfactory number of search results are achieved. For example, a user in a rural area may not be able to find adequate search results by specifying search criteria limited to his own town or immediate area, in which case the system can automatically, or in response to user control, expand the search area (optionally displaying the then-current distance range or map zoom level, or a superimposed boundary encompassing the then-current operative display area) until the user is satisfied with the area and/or search results.

The present system can also include one or more software routines wherein a user entering or selecting only a geographic-territory criterion in order to search and display a sought-after cloud causes a referencing of the system's databased geographic-territory identifier or descriptor data pertaining to the user-entered criterion (or criteria) and the display of a respective locationonly specific cloud within a component page 64, having suggestive interactive ADC elements pertaining to a broader scope of subject matter: relating to the specified territory criterion (i.e., only the location, with no category or subject criterion). For example, if a user simply enters “Chicago” as the locationonly search criterion, the system will reference databased data-files having one or more Chicago geographic-territory identifiers e.g., associated with the data-files (which may include metadata or one or more metatags and the like), and display a Chicago-specific cloud having one up to dozens or hundreds (or more) ‘Chicago’-related hyperlinked ADC elements such as one or more among the following: “Restaurants”, “Hotels”, “Visitor Guide”, “Lodging”, “Nightclubs”, “Tours”, “Landmarks”, “Museums”, “Theatres”, “Transportation”, “Bakeries”, and the like. Preferably each of the suggestive hyperlinked ADC Chicago-related elements of the location-only specific cloud are interactive such that a clicking on an element by a user provides the display of a new cloud within the cloud page, wherein the ADC elements of the new cloud are related to the subject of the previously clicked-on element. For example, clicking on an ADC element “Visitor Guide” within the location-only specific cloud pertaining to Chicago will cause an accessing of a data-file having a ‘Visitor Guide’ identifier or descriptor and display a new cloud and respective new ADC elements (preferably hyperlinkable and user interactive) such one or more (or all) of the following: “Michigan Avenue”, “Navy Pier”, “Millennium Park”, “McCormick Place”, “Museum Campus”, “Woodfield Mall”, “Chicago History Museum”, “State Street Chicago”, “Boat Tours”, “Walking Tours”, and the like. Thereafter, any one or more (or all) of the new interactive ADC elements provide interactivity in any one or more of the ways previously described, or as described in reference to any of the ADC elements of FIG. 4, 5 or 6 below. Optionally, the software also provides for the saving of any location-only specific search criteria in a manner which can be subsequently employed via a single click or selection made by user input means, for example displayed as a menu selection, or a selection made from, or a click on, or one or more interactive (e.g., hyperlinked) alpha-numeric word or word phrases such as: ‘Default’, ‘Bookmarks’, ‘Favorites’, ‘History’, and the like.

Similarly, the present system can optionally include one or more software routines wherein a user entering only a category or subject criterion for searching and displaying a sought-after cloud, causes a referencing of the system's databased data pertaining to the user-entered criterion (or criteria) and the display of a subject-only specific cloud within a Web page or GT&C specific component page 64 having suggestive ADC elements pertaining to a broad scope of subject matter relating to the user-entered single criterion (i.e., a single subject, with no location criterion). For example, if a user simply enters “News” as the subject-only (or category-only) search criterion, the system will display a News-specific cloud having a number of hyperlinked ADC news-related elements.

Similarly, in a Commerce-enabled Cloud Mode of the system, which accesses system data to display clouds having interactive, transaction-enabled ADC elements, computer executable instructions in response to the user entry or selection of geographic-territory or ‘Location’ criterion, or category criterion, or subject criterion, or any criteria combination thereof, cause a display of a Commerce-Enabled Cloud having interactive, transaction-enabled ADC elements relating to the criteria. Each transaction-enabling ADC element has one or more associated computer executable instructions that are responsive to a user interaction such as input from suitable user input means, and provides the displaying of one or more offering(s), or proposition(s) procedures, such as (i) one or more procedures for a user purchasing, or rental, or leasing, of one or more deliverables, or (ii) one or more procedures for an advertiser purchasing one or more time-limited or non-time-limited advertisements, or (iii) one or more procedures for culminating such transactions by making a payment using any of the aforementioned or conventional online payment methods, and the like. In one mode, the system search-related software is optionally equipped to automatically interpret a search string entered by a user in a search text-entry field beginning with a commerce-related word such as “Buy” or “Purchase” (“Rent” or “Lease” or “Auction” or “Advertise”, and the like) as a software event triggering the displaying of a commerce-enabled cloud. Additionally or alternatively, a user manually selecting a displayed user interactive interface element, or check boxes or buttons, or menu selection, or the like, or clicking on or rolling over one or more of the same or similar commerce-related words, can be used as a software event triggering the displaying of a Commerce-enabling Cloud Mode (or ‘Commerce-Cloud’) of the system. For example, one or more referenceable commerce-related data-file identifiers can be saved with, or in association with, each ‘Computer’-related data or data-file (in a manner similar to that previously described for location specific identifiers) and subsequently, search-related computer executable instructions in response to one or more criteria matching such data will cause a displaying of a ‘Computer’-specific cloud having a number of hyperlinked ‘Computer’-related transaction-enabled ADC elements. Accordingly, if a user enters “Computers” or clicks on a word phrase “Buy Desktop Computer” as a subject-only (or category-only) search criteria, either entry will cause a referencing of the system's databased data pertaining to the ‘Computer’-related criteria and to any associated commerce-related databased data or data-file(s) pertaining thereto. While the example of ‘Computer’ as a subject matter has been provided, it is noted that any category and/or subject in a wide variety of other subject matter (e.g., not narrowed or limited to a specific geographic territory) can alternatively be entered and one or more file identifiers or descriptors associated with the data or data-files pertaining to the new criteria similarly referenced and their respective interactive transaction-enabled ADC elements displayed in an alternative Commerce-Cloud. Alternatively, any ADC element of such categories or subjects may be displayed and made similarly interactive and/or transaction-enabled in the form of one or more types of user interface elements such as a text-based listing on a cloud page or menu and the like, and whether a user enters the category and/or subject as text, or clicks, or selects, or otherwise causes interaction with a category and/or subject, a broad range of subject matter such as any among the products, goods, merchandise, activities, foods/beverages, and services (deliverables) found in a printed telephone book business section can be represented by category and/or subject in a Commerce-Cloud of the present system. For example, some of such user-entered or user-accessible categories and/or subjects may include, but are not limited to the following: Category: Auto Sales, Subject: Cars, Trucks and Vans, Recreational Vehicles; Category: Travel, Subject: Vacations, Tours, Cruises, Flights, Train, Hotels, Bed and Breakfast, Tourist Attractions, Amusement Parks; Category: Books, Music and Movies, Subject: Books, DVD, Video, Magazines and Newspapers, Music, Textbooks, Downloads; Category: Clothing and Accessories, Subject: Apparel, Accessories, Jewelry, Watches, Shoes; Category: Computer and Office, Subject: Computers, Office Products, Software; Category: Consumer Electronics, Audio and Video, Subject: Camera and Photo, Cell Phones and Service, Computer and Video Games, Musical Instruments, All Consumer Electronics; Category: Food, Subject: Grocery, Gourmet Food; Category: Health and Beauty, Subject: Prescriptions, Over-the-Counter, Vitamins, Eye Care, Beauty, Health and Personal Care; Category: Home and Garden, Subject: Bed and Bath, Furniture and Décor, Home Improvement, Kitchen and Housewares, and the like.

Thus, any number of Commerce-Cloud transaction-enabled ADC elements referenced and displayed as a result of a subject-only criteria entry, provide user interactions in any one or more of the ways previously described, and provide commerce-related functionality as described in reference to any of the ADC elements of FIG. 4, 5 or 6 below. Optionally, the software also provides for the saving of any subject-only specific search criteria in a manner which can be subsequently employed via a single click or selection made by user input means, for example as a menu selection, or a selection made from, or click on, one or more ‘Defaults’, ‘Bookmarks’, ‘Favorites’, ‘History’, and the like.

Following any narrowing of search criteria pertaining to one or more Geographic-Territory specific clouds and/or to Categories and/or Subjects, the user may optionally employ any one or more of the aforementioned search (or ‘navigating’) means to assist in further narrowing a search, or search-in-progress, or any additional search desired by the user. Additionally the software of the system can include the option of a user being able to set one or more ‘Defaults’ pertaining to a user-defined geographic-territory scope, for example the system can provide a selectable, interactive user interface element such as a check box or radio button Geographic-territory link on/off control means 46 whereby the selecting of a ‘Default’ checkbox, or radio button (or other similar element) next to one or more of such geographic-territory scope word-links 48 (i.e., each preferably having a user pre-configured hyperlink) provides the user the option to simply click once on any one of the word-links to instantly navigate to or among a database of displayable representations of clouds having ADC elements relating to the geographic territory of the clicked-on word-link. For example, word-links can be pre-configured by a user according to the user's interests (e.g., via a ‘Setup’ or ‘Options’ mode or menu selection) such that when the Geographic-territory link on/off control means 46 (check box) is checked by the user, and the user clicks once on the “City” word-link a cloud page (cloud-displaying Web site page) having one or more clouds pertaining to the user-specified (pre-configured) city will be displayed.

Alternatively, ADC elements of a cloud can each be employable as a search initiating element e.g., wherein one or more elements each display the name of a geographic location (not shown) and the cloud can thereby be employed as a single-click software means for providing ‘navigation’ to a single clicked-on location (or to an ADC element suggestive location). For example, the user clicks once on the “Country” word-link, and ADC elements of a country oriented cloud are displayed having the names of various states, cities, and the like, each of which is preferably hyperlinked to one or more other location-narrowed clouds, or Web sites, and/or offerings or propositions and the like pertaining to the clicked-on ADC element named-location. Similarly, ADC elements of a cloud can each include a subject or category (not shown) and the cloud can thereby be employed as a similar single-click software means providing ‘navigation’ to an ADC element's displayed subject or category. For example, a city-specific cloud is displayed by the system and the ADC elements of the City cloud are comprised of the various subjects and/or categories each of which is hyperlinked to one or more narrower-range clouds, Web sites, and/or offerings or propositions and the like pertaining to the clicked-on ADC element named-subject and/category. For example, a cloud of a small town could have ADC element subjects or categories such as bakeries, realtors, stores, religious organizations, parks, and the like, and a single clicking on any of the hyperlinked locality-specific ADC elements provides ‘navigation’ to one or more Web sites, and/or offerings or propositions, and the like, constrained to the clicked-on ADC element subject or category.

Alternatively, user interface navigation means 42 may optionally be equipped with one or more user or advertiser ‘Favorites’ user selection means 50 and/or ‘History’ user selection means 52 or the like, such as a labeled clickable ‘tab’ or by a user input device interaction with one or more other software user interface elements, text-based or menu selection(s), or the like, and the system can include one or more software routines whereby any of such selection means can be employed to narrow the specificity of search criteria pertaining to the geographic-territory and/or Category or Subject of sought-for GT&C specific or GT&S specific clouds.

While several user input methods have been described such as ‘click-on’ or ‘roll-over’ of one or more interface elements, it is noted that a number of other user input means may alternatively or additionally be employed. For example, wireless handheld browser equipped apparatus further equipped with GPS capabilities can also include one or more software routines whereby a user of the apparatus is given a software option to have geographic-territory input data be provided by the incorporated GPS such that one or more locations are determined by the GPS and its software. For instance, when a user commutes from one location to another, such as the taking of a trip or excursion from Cedar Park, Tex. to Austin, Tex., one or more software routines of the system can query the incorporated GPS and its software such that the data pertaining to each GPS determined location is readable by the system in a manner wherein one or more GT&C specific or GT&S specific clouds and their respective user interactive, transaction-enabling ADC elements can automatically be displayed in accordance with the then-current, or any series of recent, locations determined by the GPS.

Alternatively, user interface navigation means 42 may optionally be equipped with one or more menus, or pop-up or drop-down menus, such as menu user control means 60 wherein, one or more software routines of the system provide a menu listing with a number of previously employed (or ‘History’ of) search criteria and each of the criteria is selectable from the menu by a user in a typical user menu-selection manner to rapidly select among any of the criteria in the listing. Thus, the specificity of search criteria pertaining to the geographic-territory and/or Category or Subject of sought-for GT&C specific or GT&S specific clouds can be augmented by the inclusion of the optional menu user control means 60. Alternatively, any one or more of the software routines or commands previously mentioned in connection with a user navigating readily to one or more desired GT&C specific or GT&S specific clouds, can be implemented by voice commands when any stationary or portable browser equipped apparatus of the system includes one or more microphonic means (such as one or more attachable or built-in microphones) and also includes voice-recognition and/or voice-command recognition software.

User input apparatus can also include an optical scanner having a connection with browser-equipped apparatus of the system whereby optically scannable content is scanned and computer executable instructions convert scanned images of machine-printed or handwritten text (numerals, letters, codes, images and symbols) into a computer-processable format e.g., by employing optical character recognition (OCR) software routines, preferably including contextual processing either to correct misclassifications made by an recognition algorithm or to limit recognition choices for example to any one or more of the search criteria previously mentioned. Accordingly, optically scannable content can be scanned as a form of user input to provide or affect one or more search criteria and/or cloud displaying outcomes.

User input apparatus can also include the display screens of browser-equipped apparatus of the system being equipped with touch-screen functionality and software for interpreting and/or converting user touch input into computer executable instructions.

Thus, in reference to FIG. 3, numerous alternatives are provided wherein, in response to one or more types of user or advertiser inputs, the specificity of search criteria and the speed in which locality-centric searches are performed pertaining to the Geographic-Territory and/or Category or Subject of sought-for GT&C specific or GT&S specific clouds can readily be enhanced. While FIG. 3 solely depicts navigation means within a display area of a browser equipped apparatus or a Web page, it is noted that one or more software routines of the system can alternatively display one or more of the previously described ‘navigation’ means or one or more elements thereof (e.g., one or more text entry fields, menu types, text-based listings, ‘Favorites’, ‘History’ Defaults, links or hyperlinks, and the like) within a GT&C/S specific component page 64 such as the cloud pages 64 depicted in FIGS. 4, 5 and 6 below.

FIG. 4 depicts a software user interface (or portion thereof) which is viewable in a display screen area of a portable or stationary browser-equipped apparatus, wherein a GT&C specific component page 64 or GT&S specific cloud page or web page (hereafter referred to as ‘GT&C specific cloud page’) preferably having a cloud page specified geographic-territory 66, provides a cloud display area 68 (co-locatable component) in which one or more cloud(s) 70, such as a word cloud or word cloud-like arrangement, is depicted being comprised of GT&C/S specific cloud associative discernible content ‘ADC’ text elements 72 e.g., a plurality of closely arranged, preferably non-overlapping, words or word phrases pertaining to one or more geographic-territory specific criteria and/or category or subject criteria entered by a user. The term “co-locatable user interface component” refers to a software user interface displayable component which is simultaneously displayable with one or more other interrelated co-locatable components of the system described elsewhere in this specification. Like non-text elements, each ADC element word or word phrase is storable as a data-file having one or more identifiers or descriptors associated with a geographic-territory, or category, or subject or any combination thereof. FIG. 4 also depicts the displaying of an optional navigation or search component 42 (e.g., a reduced-size version of the component depicted in FIG. 3), which can be displayed in response to a user clicking on or selecting from among search selection means 78 menu options. Preferably any two or more of the co-locatable components or elements of the system can selectively be opened or closed, minimized or maximized, positioned or re-positioned so as to enhance the exposure probability and/or an increased awareness of simultaneously displayable content and/or commerce-enable ADC elements of those components or elements within the same SUI.

User entered or pre-configured search criteria such as Cloud page specified geographic-territory 66 (and/or a search criteria category or subject) can alternatively be located elsewhere within GT&C specific component page 64, for example within cloud display area 68 and/or at the top of optional GT&C/S specific text-based search result listing 80.

To provide an enhanced suggestive value (or enhanced random suggestive value) of ADC elements 72 and increase the exposure probability of one or more elements thereof, cloud-configuring computer executable instructions of the system preferably includes means for displaying a matrix, grid or close arrangement (or cloud-like configuration) of ADC elements in a fixed manner as previously described or in a random-positioning manner (preferably non-overlapping) within one or more geographic-territory specific and/or category or subject specific clouds or cloud display areas. For example in the random-positioning of ADC elements within a cloud or ADC element grouping, each time a cloud's ADC elements are displayed, or when the Web page in which the ADC elements are displayed is refreshed, computer executable instructions cause the ADC elements to be located in different positions than when previously displayed. Thus, the element “SICILIAN” seen in the upper left corner of the cloud display area of FIG. 4 can be located in a different location within the cloud each time the cloud is subsequently displayed or refreshed. Alternatively, system software can provide the displaying of individual ADC elements in a grid, matrix or close arrangement either in a fixed, semi-fixed or positionable manner.

For example, interactive ADC elements can be displayed positioned in a grid or matrix so as to have a cloud-like appearance, further comprising the display of the ADC elements in rows wherein one or more rows are positioned or panned horizontally at the same speed or at a different speed. Thus, more ADC elements than can be viewed at one time within a given cloud display area can be moved and made displayable than those viewable in a static arrangement or grouping of ADC elements. In the case where one or more positionable rows are positioned or panned horizontally by computer executable instructions, the display of slower moving ADC elements (viewable longer) can be made available for procurement at a higher fee than faster moving ADC elements. Accordingly, ADC elements displayed in a row located in an upper portion of a cloud-like arrangement or grouping can be made to move slower with each element of the higher row costing more (for its display) than one or more faster moving rows having ADC elements aligned thereunder. Preferably, the horizontal positioning or panning of ADC elements is done in a manner which causes the elements to appear as if they are being displayed in a continuous loop, wherein, if a first, leftmost element in a row is the “Apple” and the last rightmost element in the contiguous row is “Zebra” (not necessarily sorted alphabetically) and the row is panning to the left, then the “Apple” element is displayed adjacent to the right of “Zebra” as the end of that row appears within the ADC element (cloud) viewable display area.

In each case, computer executable instructions can automatically update the display of the separate ADC elements in a manner accommodating the addition or deletion of any ADC element.

ADC elements in a GT&C/S word cloud are comprised of text-based elements that are storable and retrievable in a memory accessible to the system such as one or more database storing apparatus. The present system also provides the options to display text and/or non-text ADC elements in clouds.

Software of the system can alternatively or additionally provide the displaying of a bitmapped representation of a plurality of ADC elements displayable within a cloud display area, or displayable as a separate co-located component within a single user interface display area of the system wherein each ADC element representation appearing as part of a bitmapped or other graphic image representation can optionally further comprise a respective interactive placeholder element (e.g., a transparent placeholder) which defines an interactive area of the element responsive to user input from a user input device and provide one or more of the aforementioned functionalities or interactivities of non-bitmapped ADC elements.

As previously mentioned, preferably each of the ADC elements of a GT&C/S specific cloud are storable as a data-file having one or more identifiers or descriptors associated with a geographic-territory criteria, or category criteria, or subject criteria, or any combination thereof and can be referenced and/or searched via one or more search interface components and search-enabled software of the system. Each ADC element has associated computer executable instructions which make the element interactive and responsive to one or more user or advertiser input means interactions. For example, such interaction can include but is not limited to one or more input device interactivities, such as the clicking on a hyperlinked element, or by voice commands, and the like. In response to a user-interaction such as any among those previously described, computer executable instructions provide the display of information pertaining to the element(s), or pertaining to one or more configurable parameters thereof, or pertaining to one or more offering(s), or proposition(s) procedures, such as (i) one or more procedures for a user purchasing, or rental, or leasing, of one or more deliverables, or (ii) one or more procedures for an advertiser purchasing one or more time-limited or non-time-limited advertisements, or (iii) one or more procedures for culminating such transactions by making a payment using one or more of the aforementioned payment methods, and the like. It is noted that any trademarked subject matter appearing in FIG. 4 is the sole property of its respective owner(s) and no endorsement of the invention is inferred, implied or intended by such usage, but is included as content which is merely illustrative of the cloud content relating to pizzerias.

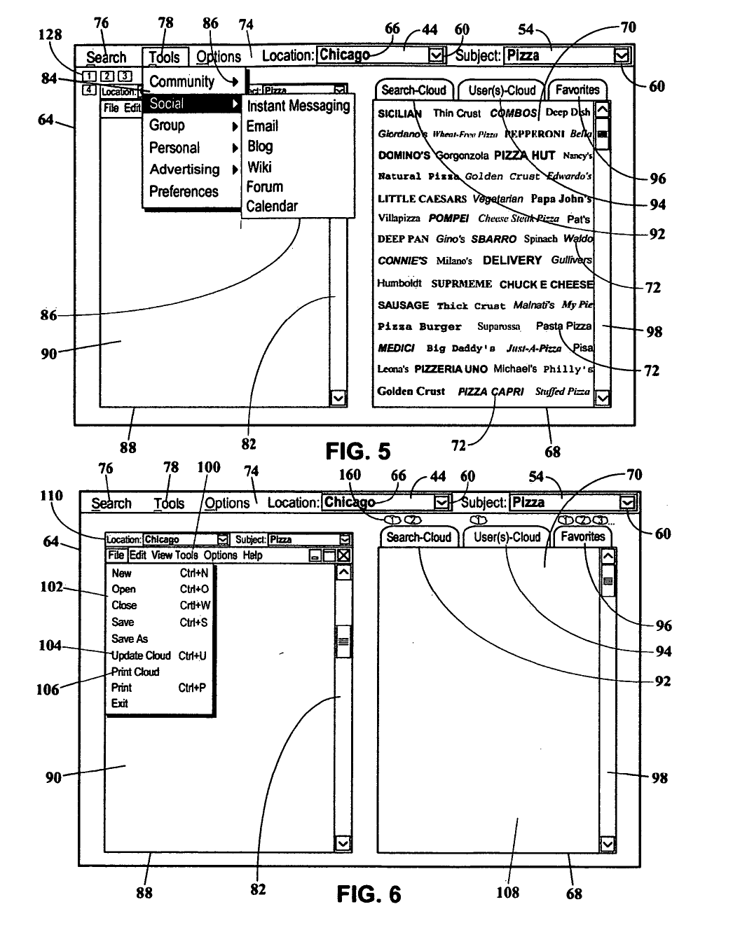

It is noted that while the cloud depicted in FIG. 4 is shown in a portrait format on the right side of GT&C/S specific component page 64, providing room for other related content or one or more software application ‘Tool(s)’ to the left of the GT&C/S specific cloud, that one or more GT&C/S specific cloud(s) can alternatively be located elsewhere within GT&C/S specific component page 64, providing room for content otherwise located adjacent to or in close proximity with the GT&C/S specific cloud(s). For example a GT&C/S specific cloud can be arranged so that its ADC elements are arranged in more of a landscape configuration providing room for such related content above or below the cloud. It is also noted that one or more GT&C/S specific cloud(s) may be located in a fixed position within GT&C/S specific component page 64 or be made positionable, for example by (i) the inclusion of one or more optional cloud-scroll bars 98 (see FIGS. 5 and 6), or (ii) by the making of a GT&C/S specific cloud (and one or more elements of GT&C/S specific component page 64) draggable, or displayed within a positionable pane or layer, and so forth.

Preferably GT&C/S specific component page 64 provides for the display of a GT&C/S specific cloud page header 74 which optionally includes one or more menus, for example a cloud-page menu ‘Search’ selection means 76 which optionally includes means for launching a user interface ‘navigation’ means such as any one or more of the types described in reference to FIG. 3 (above), and/or other menus, such as a cloud-page menu ‘Tools’ selection means 78, or the navigating means depicted in FIGS. 5 and 6 (e.g., ‘Location” and ‘Subject’ text entry fields 44 and 54 respectively), and so forth. The system can optionally be equipped with one or more software routines for scaling the size of one or more clouds on a cloud page. For example, a user employing cloud-sizing means such as one or more cloud located clickable box or other interface element, which affects the cloud size, or a user can select one or more menu ‘zoom’ scale selections (e.g., “Icon” or “Thumbnail”), or scale percentage number such as any one or more of the following “10%”, 25%, 50%, 75%, 100%, 150%, 200%, or user-configurable or customizable percentage and the like, or preset sizes ‘Fit in Window’, ‘Fit in Page’, ‘Actual Size’, ‘Fit Visible’, and the like, or by means of a magnifying glass type of zoom-scaling Tool, and the like.

FIG. 4 further illustrates the exposure probability-enhancing and improved increased-awareness advertising advantages of the present invention in its displaying of one or more in a variety of geographic-territory specific or related content adjacent to, or in close proximity with, one or more fixed or positionable GT&C/S specific clouds or ADC elements thereof. For example, while the system provides software routines for displaying only a fixed or positionable GT&C/S specific cloud within GT&C/S specific component page 64 and preferably does so in a manner providing one or more, or all, of the aforementioned ADC element types of interactivities, the system alternatively provides software routines for displaying one or more GT&C/S specific Web page-enhancing or cloud-enhancing co-locatable Tools, and/or text-based listings, adjacent to, or in close proximity with, one or more GT&C/S specific clouds. As previously mentioned, any one or more of such complementary, interoperable and co-locatable components displayable in the single user interface ‘SUI’ of the system (e.g., Tools and/or listings) provide added-value by providing one or more geographic-territory specific outcomes or functionalities pertaining to, and/or related to, one or more adjacent or proximate GT&C/S specific and/or GT&S specific clouds displayed on the same page, and thereby provide a tool-outcome sustainable attraction to users which in turn enhances the exposure probability and increases awareness of any content viewable on a GT&C/S specific component page 64. Such content can include but are not limited to one or more GT&C/S specific clouds, ADC elements of the cloud(s) and information, offerings, or propositions, advertisements presented to users and/or advertisers when interacting with any of the ADC elements, one or more co-locatable software application Tool(s) CSAT(s) outcomes pertaining to the displayed clouds identified geographic-territory, and so forth. In a simpler mode, GT&C or GT&S specific ADC elements displayed following a search are preferably interactive such that upon user interaction one or more offerings, or propositions, or deliverables pertaining thereto (e.g., for purchase, rental or lease) associated with an element are presented to the user and are related and/or pertain to a geographic-territory search criteria entered by the user.

In further reference to FIG. 4, an inter-operability between one or more geographic-territory related clouds and text-based listing elements within the same cloud page is optionally provided by one or more computer executable instructions of the system wherein user interaction with one or more GT&C/S specific elements of one component of GT&C/S specific component page 64 (e.g., an ADC element of a cloud) optionally causes a result, such as a viewable reaction, in a corresponding or related GT&C/S specific element such as an interactive element within a cloud page displayed text-based listing. Such cloud page element inter-operability, in combination with a juxtapositioning of such related and complementary elements, improves the exposure probability and an increased awareness of content displayed within the cloud page, particularly when users are motivated to continued or repeated engagement with any of such elements due to an added utility or usefulness, and/or geographic-territory relevance such interactions provide. An example of inter-operability can be illustrated, in the GT&C/S specific “Chicago” and “Pizza” cloud of FIG. 4, when a user input device interaction, such as any of the types previously described, pertaining to the word “Giordano's” (i.e., the first word of the second row of the GT&C/S specific cloud) causes an emphasizing of content within the “Giordano's” reference in the optional GT&C/S specific text-based search result listing 80. For instance, the content emphasis can comprise any one or more (or all) of the letters or words in the corresponding “Giordano's” reference of listing 80 being automatically affected including, but not limited to, one or more of the following ways, becoming: sized differently (e.g., enlarged), highlighted, underlined, placed in a border, displayed having a colored background, displayed with one or more font-setting or font-opacity alterations, animated, and the like. Alternatively or additionally, such interaction can cause the automatic displaying and/or playing of a “Giordano's” related text-based content, audio, or video content (e.g., such as an audio or video commercial, infomercial, downloadable podcast or MP3 or compressed multimedia file, and the like) viewable within a display area of a GT&C/S specific component page 64 and preferably user-controllable via an audio and/or video transport-controller software component (not shown). Conversely, the system can also provide one or more software routines wherein any one or more of the aforementioned types of user interactions with the text of a GT&C/S specific text-based search result listing 80 can optionally cause a similar affecting of a corresponding ADC element within an adjacent or proximate GT&C/S specific cloud.

Accordingly, in one mode of use, a user clicking on the ‘Chicago’ specific cloud ADC element “Giordano's” (or (“Giordano's” in a text-based listing) can be presented with one or more displayable options for purchasing food and/or beverage menu items available at Giardano's ‘Chicago’ pizzeria and a displayable arrangement for completing one or more payments within the cloud page for such goods/deliverables (e.g., in a manner similar to one or more of the previously described payment methods). Preferably, transaction-enabling software of the system further provides means for automatically contacting the advertising person, business, organization or entity by suitable communication means such as an email, facsimile or telephonic communication, or the like. Such communication can include one or more payment arrangements to a seller, a billing of an advertiser, or taking or receiving payment for a predetermined commission and/or transaction fee for a user's order. For example, the person/contact authorized to configure and pay for the Giordano's GT&C/S specific cloud ADC element advertising (and/or “Giordano's” text-based listing) as configured and/or displayed within a cloud page can automatically be contacted or billed for one or more commission and/or transaction fee payments and such fee(s) can be securely transferred or transmitted to one or more secure financial accounts.

Alternatively, user input means interaction with one or more elements of a cloud page, such as an ADC element or one or more hyperlinked-words of a text-based listing can result in the user being ‘sent’ or transferred to Giordano's Web site wherein the user can complete a payment for an order in a manner similar to one or more of the previously described payment methods, and preferably software of the system further provides means for automatically contacting the Web site advertising person, business, organization or entity by suitable communication means such as an email, facsimile or telephonic communication, or the like, to bill the advertiser for, or otherwise take or receive payment for, a predetermined commission percentage and/or transaction fee based on the user's order.

For example, a user clicking on an interactive transaction-enabling ADC element within a (GT&C and/or GT&S specific) cloud having a hyperlink to a remotely located Web site (or Web page thereof) can cause a cookie, plug-in, javascript or other machine readable code to be associated with that site or page, such that a transaction initiated by a user input within the cloud and completed at the remote Web site is identifiable with the system's Web site and communication of transaction-related data is communicated back to data reception means of the system. To participate in such remote Web site transactions and bi-lateral communications initiated by cloud ADC element transaction enabling events, the remote Web site operator (an advertiser and/or seller) first becomes an authorized participant in the cloud-element transaction enabling process by a prerequisite online registration arrangement. In response to an authorized/secure registration, the system associates one or more identifiers or descriptors between the (i.) operator's ADC element(s) (displayable in one or more clouds and/or other of the previously mentioned co-locatable components) and (ii.) the network location of the remote Web site (or Web page, Web page portion, pop-up, window pane, and the like) in which one or more of the operator's transactionable offerings or propositions are displayed. Thus, cloud-element transactions initiated within the system can optionally be completed by users being ‘sent’ or linked to participant remote Web site locations and transaction-related data pertaining to any of such transactions will be sent back to the system.

Alternatively or additionally, a cloud co-located and/or cloud proximate text-based listing may include a combination of online commerce transaction facilitating interactive links 180 in a standardized plural format for each reference ‘hit’, for example, wherein each pizzeria in the sample “Chicago” (location) and “Pizza” (subject) search listing (80), provides a combination of two or more (such as any or all) of the following interactive word-links: Web site |Phone|Order|Map|Coupon|Bonus|Points|Comments|Reviews| and the like.

Accordingly, a user input device input, such as a clicking on the cloud-page's ‘Web site’ word-link of a particular pizzeria causes one of that pizzeria's Web site pages providing additional user interactivity to be displayed in the browser, for example a Web page providing order-taking and order-culminating/payment procedures for one or more pizzeria related deliverables.

A user input device input such as a clicking on the cloud-page's “Phone” word-link causes a display of one or more of that pizzeria's phone numbers, or an automated dialing of the number by the browser equipped apparatus and suitable dialing and/or telephonic software (for example when the system is operating on a browser equipped apparatus/computing device also equipped with one or more VoIP software programs, or the like).

A user input device clicking on the cloud-page's ‘Order’ word-link of a particular pizzeria causes order-taking and order-payment procedures for that pizzeria to be displayed in the browser, for example a displaying of a partial or entire menu of that pizzeria and menu item user selection means and a software user interface component/arrangement for making one or more payments for example with credit card or other suitable financial transaction instrument.

A user input device clicking on the cloud-page's ‘Map’ word-link of a particular listed pizzeria causes the display of a map and/or directions to that pizzeria, preferably also providing software means for (a) printing out the directions and/or one or more zoomable levels/scales of the map, and/or (b) when any handheld portable browser equipped apparatus of the system is also equipped with GPS means, assisting the user the with one or more map-displayable direction indicators and/or audible directions to the pizzeria.

A user input device clicking on the cloud-page's ‘Coupon’ word-link of a particular pizzeria presents the user with one or more coupons redeemable by the user in accordance with that pizzeria's coupon terms.

A user input device clicking on the cloud-page's ‘Bonus’ word-link of a particular pizzeria presents the user with one or more bonus propositions such as ‘Buy two large pizzas, Get one Free”.

A user input device clicking on the cloud-page's ‘Points’ word-link of a particular pizzeria presents the user with one or more points or ‘Bonus Points’ propositions, for example where one or more purchases made by the user (or rentals or leasings for propositions offered by other advertisers) accrues points which are subsequently redeemable by the user and have a set value. Thus, the ‘Bonus’ and/or ‘Points’ procedures can be particularly effective in facilitating repeated or regular customer transactions and for rewarding cloud-page customers with rewards for their patronage. Similarly, Bonus points optionally can be accrued by a user for particular interactivities of the user within a cloud page or when otherwise employing the present system (e.g., starting a blog or forum, by leaving comments, feedback or reviews or advice in a blog or forum, by making purchases, rentals or leases, and the like). When the ‘Points’ user interface element option is enabled and displayed the system includes one or more software routines for tracking user activity (preferably registered users) and providing points to users such as ‘Smart Purchase Points’ for their activity and actions within the system (e.g., within a cloud page) which include purchases intermediated by the system, surveys answered, specific clicks and activity, and so on. The Smart Purchase Points can be sold, traded, and or redeemed to purchase goods or services or activities from participant providers, or merchants, or vendors and the like, both on and off the internet, as a means for fostering the exchange of goods or services or activities for customer traffic using Smart Purchase Points. The use and/or exchange of Smart Purchase Points are tracked on and off the internet, for example, by transaction monitoring and reporting means similar to those employed in the monitoring and networked-computer system reporting of sales completed online or at brick-and-mortar facilitates. For example, the tracking of Points redeemed by a user can occur when the user is entering and/or completing an online purchase from a Smart Purchase Points participant vendor, whereby the redeeming of points provides one or more free or discounted items. Alternatively or additionally, the tracking of Points redeemed by a user can occur when the user is employing a digital Shopping Cart and or similar user interface method or procedure providing robust transaction tracking and reporting means. Smart Purchase Points can also be used by advertisers and/or other system-participants to purchase advertising (among cloud page ADC elements, text-based listings, and the like).

A user input device clicking on (or other input) the cloud-page's ‘Comments’ or ‘Reviews’ word-link of a particular pizzeria presents the user with one or more options for posting comments and/or feedback or review or user rating, which subsequently can be read by users of the present system.

Optionally, if any one or more word-links in the online commerce transaction facilitating interactive links 180 is non-functional (e.g., the pizzeria does not have a ‘Web site’ or online ‘order’ capabilities), the inoperable word-link(s) can be displayed differently from the operable word-links, for example, by text that is not underlined and/or gray instead of black, or having a different opacity, color, text format, and the like, or can be omitted from the word-links, displayed for a given ‘hit’, and so forth.

Optionally, to facilitate a debuting or introduction of the system of the present invention to new users and advertisers, and maximize the usefulness, enhanced exposure probability and awareness increasing features of the system to new users and/or early adopters, the system preferably provides ADC element editing and/or control means, whereby, the maximum or an optimum number of ADC elements of a GT&C/S specific cloud can initially be displayed providing some or all interactivity, as if the display rights to one or more (or all) ADC elements in the cloud had already been purchased and were configured by actual advertisers, and do so for a limited period of time and/or for a prescribed limited or ‘trial’ number of uses. As the limited period of time and/or prescribed limited number of uses elapses, the system preferably contacts and informs advertisers that those ADC elements not receiving an advertiser payment can automatically and/or gradually be given less prominence, for example be scaled down in size, and/or reduced in their opacity, or moved to a less prominent position (e.g., out of view and requiring a scrolling to be seen), and the like, or any combination thereof. Similarly, when a cloud page ADC element or text link is provided on a trial basis for a prospective advertiser, and the link is activated by a user in any of the ways previously described, the system provides advertiser/seller notifications software routines whereby a communication regarding the user activity is sent (via any of the previously described communication means) to a prospective advertiser having previously provided contact information. Preferably the prospective advertiser notification software also automatically informs a prospective advertiser that one or more user activities with the trial link(s) identified with the advertiser has occurred, and that free or discounted referrals may be discontinued in the future without notice. Such notices optionally include software routines to allow prospective advertisers to purchase the advertising display rights to trial ADC element(s) or other cloud page displayable ADC-elements. The software routines can also keep an accounting of any trial basis user activity or system notifications or referrals and notify administrators when any of such reach a preset or predetermined threshold, indicating a need to contact the individual prospective advertisers' to introduce them to the benefits of advertising within the system.

Each transaction-enabling ADC element of a GT&C/S specific cloud has an associated data-file and one or more identifiers or descriptors accessible to the system to display the element and one or more offerings or propositions pertaining thereto in accordance with search criteria entered by a user and/or deliverables criteria entered by advertisers/sellers. ADC elements are interactive having computer executable instructions responsive to user input device interaction to provide immediate feedback to the user in the form of more information, or offering(s), or proposition(s), and the like, pertaining to the ADC element interaction event. For example, a ‘rollover’ of a user input device cursor within the perimeter of an ADC element of a GT&C/S specific cloud can cause related text, or a menu, or a pop-up menu, window or pane, to appear displaying one or more of the previously mentioned transaction-related outcomes, or a multimedia form of the same, such as the playing of one or more deliverables germane (contextually relevant) audio files and/or video files, and the like, or any combination thereof. In the latter case, system software preferably provides a user selectable audio and/or video transport controller user interface component for the playback and user control of audio or video files in a manner which is optionally selectable or selectively controllable and/or mutable by users). In accordance with the manner in which an ADC element has been configured by the advertiser and/or system, the system's software provides a displayable and/or printable accounting of the ADC configuration parameters and provides a displayable transaction user interface component for the completion of one or more secured and/or encrypted payments from an authorized, signed-on or otherwise identified, authenticated/registered advertiser using any one or more of the payment means previously described.

In accordance with the configurings made by advertisers/sellers ADC elements of a cloud are each positionable in a cloud display area 68 or multi-ADC element display area 108 by software routines of the system, which provide users a pleasing, aesthetic and easy to use interactive, transaction-enabling ADC element arrangement. The system preferably includes software routines or software plug-ins for positioning ADC elements within a display area of a cloud-displaying Web page as previously described and optionally includes an expandable or scrollable cloud display area. For example, such software, plug-ins or source codes can include routines for positioning user-interactive, transaction-enabling ADC elements for display within a cloud display area in accordance with a grid, or matrix arrangement, or a table, or locating or positioning element each in registration with a respective placeholder, wherein the placeholder is preferably sized similarly to, or so as to generally encompass, its respective ADC element. In another approach, the ADC elements can be given absolute or relative X,Y numerical values or coordinate positions. Optionally, in the latter case, each ADC element can optionally be positioned in one or more cloud page display areas by means of a source code anchor positioning being associated with the ADC element data-file. In each case, an ADC element data-file preferably includes one or more associated advertiser (and/or system) element-configurings and system ADC element-positioning identifiers, optionally including software routines providing a randomizing of ADC element-positionings and/or providing a controlling of one or more ADC element appearance parameters which controls the appearance and the displaying of ADC elements for example, in accordance with the degree of usage, or the aging (approaching expiration) of an ADC element. Thus, user-interactive, transaction-enabling ADC elements within a cloud can be continually positioned (e.g., in the horizontal panning manner previously described) or be positioned randomly (to enhance exposure probability and increased awareness). Text or graphic or video ADC elements can also change in appearance, or the appearance of ADC elements can be made to change over a period of time, e.g., to fade in opacity when approaching the expiration of a predetermined time-period, to glow and/or become animated for example when promoting a special offer, and the like.

Optionally, any one or more clouds viewable within a cloud page can alternately be represented in a reduced size manner, for example, wherein each reduced-sized cloud is represented as a cloud icon 160 or other small, or extremely small user interface element visible within the cloud page, and can automatically be expanded to a former, an optimum or larger size (or moved to a viewable display area from a non-viewable position) in response to one or more inputs from a user input device communicating with the system, such as a clicking, or double-clicking or a rollover interaction with a mouse and cursor. Alternatively, reduced-size graphic elements, or user interface placeholders encompassing an X,Y coordinate area can be located within a designated predetermined area of a single web page, cloud page, or user interface, of the system and made responsive to a user input device interactivity such as a cursor being positioned within the predetermined area causing an enlarged or full-sized displaying, or a positioning of, a respective cloud, preferably in a location of a user's choosing, e.g., a previous location, default location, user-configurable location, and the like. Preferably while a cloud is so expanded or positioned, the user-interactive, transaction-enabling ADC elements displayed therein provide user interaction in any one or more of the ways previously described. When one or more clouds are reduced to an icon size or positioned out of a viewable area by such user interaction, any co-locatable software application Tool ‘CSAT’ can be instantly expanded in size to provide an enlarged of full application user interface of the Tool to the user, for example, be expanded, to fill entirely, or a part of, the maximum available display area within a single web page, cloud page, or user interface of the system. Similarly, the system optionally can be equipped computer executable instructions for reducing or expanding (or positioning) of co-located software application tools (CSATs). Thus, when one or more components within the single user interface ‘SUI’ of the system such as CSATs and/or clouds are reduced to a reduced-sized element, or icon, or positioned out of a viewable area, or minimized, any component can be expanded in size, for example, to fill entirely, or a part of, the maximum available display area within a single web page, cloud page, or user interface of the system by a user input device interaction, such as a click-on or roll-over event, or any of the user input methods previously described. Accordingly, one or more reduced-sized or minimized components can be selectively chosen by users and users can quickly switch from full or partial display area viewings or side by side viewings (e.g., adjacently aligned horizontally or vertically) of one or more CSATs and/or clouds, or text-based listings, or any combination thereof. The rapid and fluid switching between the various co-locatable and inter-operable components of the system, each equipped to display and/or output geographic-territory specific content congruent with one or more locations of interest to a user, further increases the awareness, and enhances the exposure probability, of the component's inter-related content.

As depicted in FIG. 4, when a GT&C/S specific text-based search result listing 80 includes more references than can be viewed within the viewable area of GT&C/S specific component page 64, one or more software routines of the system preferably cause the display of a GT&C/S specific text-listing scroll bar 82 (with the option of displaying as needed a horizontal scroll bar for scrolling of text horizontally).

While the arrangement of ADC text elements 72 depicted in GT&C/S specific component page 64 is shown without any border surrounding the elements, it is noted that any one or more GT&C/S specific clouds can alternatively be displayed within a border, or within one or more fixed or positionable and/or layerable panes or windows viewable within the GT&C/S specific component page 64. It is also noted that ADC text elements 72 (or one or more groupings of various types of ADC elements) can alternatively be arranged to entirely fill cloud display area 68, or extend beyond the perimeter of the viewable area, and in the latter case, any grouping of ADC elements can be made positionable, for example, in response to a user employing a user input device to click a cursor within cloud display area 68 and then drag the cloud contents in any desired direction using a click-and-drag technique (preferably with any off-screen content being instantly redrawn and displayed when positioned into a displaying area).

FIG. 4 further illustrates ADC elements that can be generated and/or configured according to the preferences of advertisers. In one embodiment of the invention, registered participant advertisers, preferably having entered and/or verified user authenticating log-in and/or password data, are provided a user interface ADC element configuring arrangement wherein one or more ADC configuration can be Setup or determined by the advertiser. For example, the advertiser can select an “Advertising” Tool or system-component CSAT which provides the means for entering new, or choosing among available, GT&C or GT&S specific ADC elements and for completing an arrangement to make one or more payments for the right to display user-interactive and/or transaction-enabling ADC element(s) for a specified or predetermined period of time in one or more desired clouds.

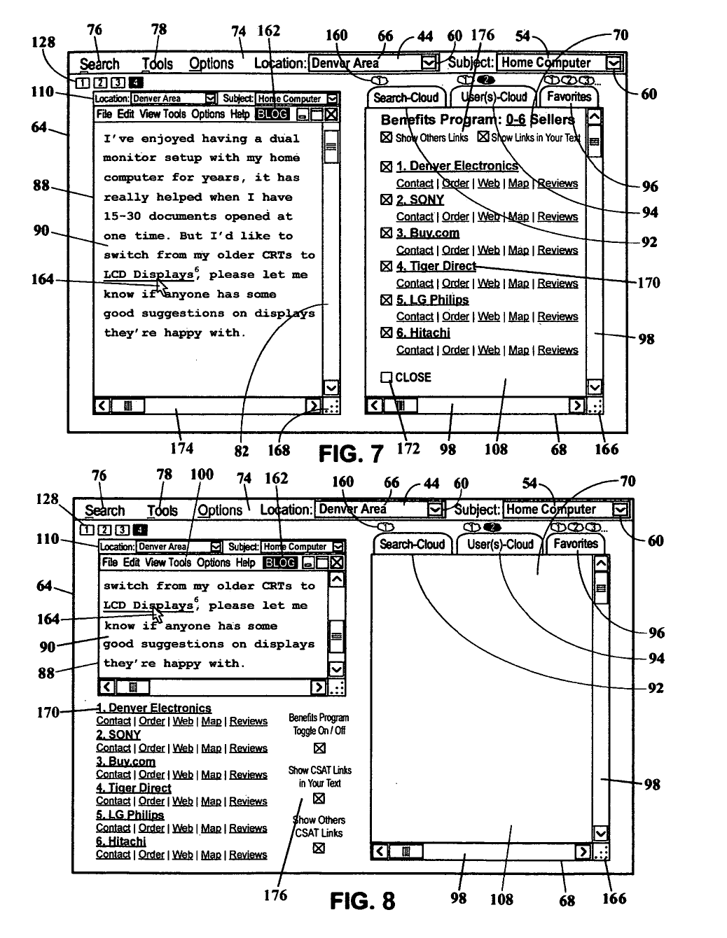

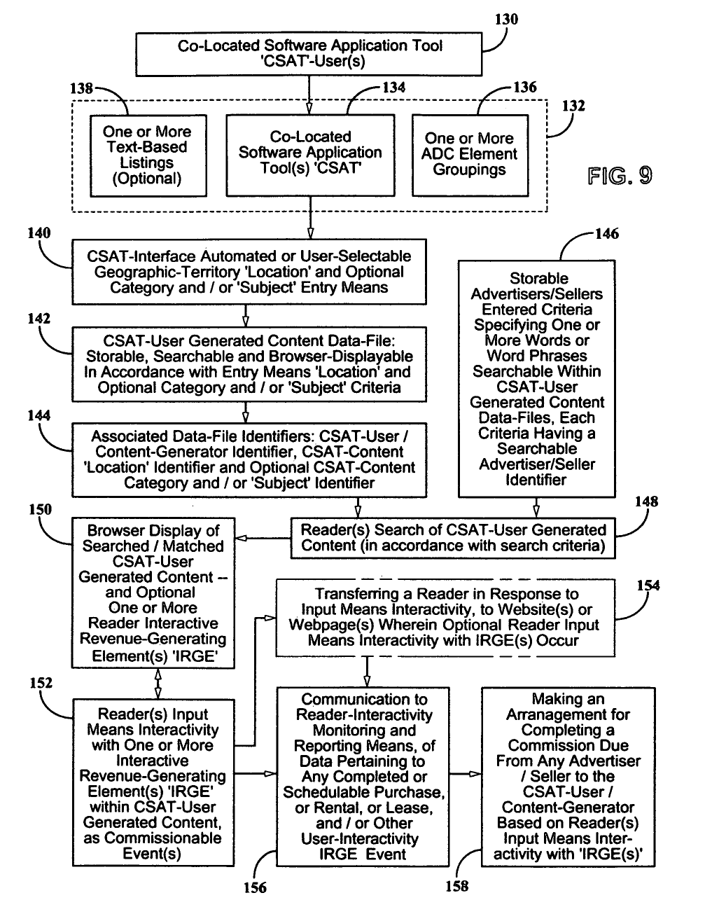

FIGS. 5 and 6 are views similar to the GT&C/S specific component page 64 depicted in FIG. 4, and further illustrate the exposure probability-enhancing and awareness-increasing ‘proximity effect’ and inter-relatedness of one or more cloud-adjacent or cloud-proximate co-located, complementary software application ‘Tools’ (e.g., preferably selectable from a menu or listing of a plurality of software applications) wherein the software ‘Tool’ user interface 88 of at least one user-selectable ‘Tool’ (co-locatable component) when launched or opened is operable next to one or more cloud(s) 70 (or cloud display areas) on the same GT&C/S specific component page 64 and provides one or more outcomes, such as storing, retrieving and/or referencing user-entered data and/or data-files related to the subject matter, or geographic-territory subject matter, of the co-located cloud(s). The co-locating of the cloud-like ADC element grouping and software application Tool(s) and their inter-operability, in combination with a juxtapositioning of related and complementary cloud page elements, provides enhanced exposure probability and an increased awareness of content displayed within the cloud page, particularly when users are motivated to sustained and/or repeated engagement with such components due to a separate or combined utility or usefulness, and/or geographic-territory relevance they provide. While FIGS. 7 and 8 depict a Web page having an area in which one or more GT&C/S specific clouds can be displayed, it is noted that in another embodiment of the present system which does not include a displaying of clouds, that one or more similar outcomes can alternatively be achieved with the other co-locatable software components described herein.

As previously described, the system provides software whereby reduced-sized user interface elements or icons are displayed and provide user interactivity. FIG. 5 depicts an example of such elements being numbered and arranged in a grid or matrix of reduced-sized CSAT elements 128. Alternatively, elements 128 (or the like) can be arranged in a row or column. In operation, user interactivity with a reduced-sized element causes the display of an expanded and operational CSAT.

Similarly, cloud-like Icons 160 such as the type depicted in FIG. 6 can alternatively or additionally be employed within the single user interface ‘SUI’ cloud page, optionally including icons having the appearance of small clouds, or numbered or named clouds, or a plurality of such having the appearance of a group of clouds or a storm. A matrix or grid of reduced-size elements, icons, ‘thumbnails’ or cloud representations, can be aligned on a cloud page, for example being vertically or horizontally aligned on the page, or within a viewable display area of a browser apparatus display screen, or be arranged as a grouping of icons or thumbnails within a cloud, and in response to a user input means interaction with any one of the reduced sized elements (such as a mouse cursor pointed within the perimeter of an icon, or a mouse clicking on the icon), be expanded to a previous (or to an adjustable) size and/or location. When one or more clouds are scaled to a reduced size on a cloud page, the system software optionally provides for a user-configurable sizing of any one or more other components within the page such as the sizing of one or more cloud co-located GT&C/S specific software application Tool(s), or text-based listing(s), and the like. Similarly any software application Tool or text-based listing within a cloud page can be reduced, represented by an icon or thumbnail, aligned, located, positioned, and expanded, and the like. When one or more text-based listings are displayed or represented in a reduced size, preferably the system provides software for sizing a listing to fill as much of the cloud page display area as the user desires and then be manually re-sized, or automatically re-sized, to a previous size and location in a manner similar to one of the cloud element sizing procedures previously described.

Preferably any one or more of the previously described sizing and re-sizing, locating or positioning, or icon, or thumbnail, or grid, or matrix representations, and the like, or any combination thereof, are displayable in the single user interface ‘SUI’, and optionally the system provides parameters or preferences that are user-configurable and/or selectable and can be stored in an Options or Setup procedure.

Each co-locatable software application Tool (CSAT) is preferably employable as an independent software application having its own user interface and is launchable source code and operable in a single standardized user interface ‘SUI’ or in a single Web site cloud page of the system (e.g., launchable software residing in the Web page source code such as embedded code, or an applet, or plug-in, or javascript and the like) and provides software routines whereby user-entered and storable data or data-files of a CSAT can be stored to one or more storing media or servers (or the like) accessible to the system. Preferably, such data can include metadata or one or more metatags such as an HTML code line or command that identifies content, words or keywords of the user-entered input(s) and any of such data, or data-files, or metadata, or metatags, or any combination thereof, are storable with data-file identifiers or descriptors pertaining to an indexed geographic-territory criteria, a category criteria, a subject criteria, or any combination thereof and are accessible and searchable by search engine software routines of the system. Preferably, the one or more software application ‘Tool(s)’ (CSATs) made available to users provide a usefulness or utility that is attractive to the users such that a user is likely to use the utility of the ‘Tool’ in a repeated and/or sustained manner and thereby, the ‘Tool’ provides a exposure probability-enhancing and awareness-increasing ‘proximity effect’ for the one or more co-located GT&C/S specific clouds or groupings of ADC elements. Thus, the longer or more regularly a CSAT of the system is used by a user, the more likely that any one or more ADC elements of a co-located cloud will be seen and/or interacted with by the user. To a limited degree, the co-located software application Tools (CSATs) of the present system are somewhat akin to browser launchable software applications which have recently been referred to as ‘web applications’, or ‘web apps’, or ‘browser-enabled web applications’ which typically function as standalone programs such as a spreadsheet or word processor. However, unlike the CSATs of the present system, ‘web apps’ have not been provided which produce outcomes pertaining to, or that automatically save searchable files having, the geographic-territory specificity of one or more co-located groupings of interactive, transaction-enabling ADC elements displayed in a single standardized user interface or single Web site or Web page. Thus, such ‘web apps’ have no relational geographic-territory relevance by which a user can conduct a search resulting in the display of a plurality of co-located geographic-territory related components, including one or more location specific (and optional category and/or subject specific) interactive ADC element grouping(s) within the same user interface or Web page. Thus, no exposure probability-enhancing and awareness-increasing outcomes attributable to a co-locating or simultaneous display of such components have previously been provided.

While the selection of an exposure probability-enhancing and awareness-increasing software application CSAT is depicted being selectable from a menu, it is noted that one or more of such Tools can alternatively be selected or launched co-located next to one or more GT&C/S specific clouds or ADC element grouping(s) in any among a variety of ways, such as any conventional method employed in the launching of a commercially available software application in computer software or browser software interfaces, or in any of the ways similar to those previously described for searching among a plurality of GT&C or GT&S specific clouds and making a selection of a cloud. For example, a software application ‘Tool’ of the system being selected and opened from among one or more alphabetic or alphanumeric ranges or indices (‘Social’ Tool being selected from ‘S-V’ alphabetic letter range), or from among one or more text-based listings, menus, sub-menus, pop-ups, windows, panes, and the like. Or alternatively one or more clouds can display numerous filenames that have been saved by a user and a user clicking or double-clicking on any of such filenames causes the corresponding software application Tool to be displayed in the same cloud page or viewable area of a browser equipped apparatus.

While some cloud-adjacent software ‘Tools’ have previously been described, several others are hereafter provided having one or more geographic-territory related purposes to further illustrate one or more of the following: a cloud-adjacent Tool's geographic-territory specific relevance relative to a co-located cloud, its exposure probability-enhancing and awareness-increasing properties and/or ‘proximity effect’ particularly in view of its usefulness or utility, and/or its inter-relatedness with one or more other co-located component displayed in the same cloud page. For the purpose of further illustrating cloud-adjacent ‘Tools’ having software routines providing one or more geographic-territory relevant outcomes, or data, or files (or any combination thereof), additional examples of various Tools are provided below having a local or community aspect and relevance. For ease of reference the examples begin with the term “Community” in their titles, however it is noted that the system can alternatively provide other software application Tools having one or more, or similar types of outcomes, or data, or files (or any combination thereof) that are not identified as a ‘Community’ Tool per ser, for example, wherein one or more of the Software Tools is a ‘Social’, or ‘Group’, or ‘Personal’. Or ‘Advertising’ software application, and so forth. The following examples also illustrate how the system can provide for one or more in a wide range of optional user-selectable Software Tools wherein each Tool, and user entered input and/or data pertaining to the Tool, is storable on a storage medium accessible to the system (e.g., one or more Web site server storage medium/databases) and provides software routines wherein a user can add, store, edit, and delete data or information about a particular subject or range of subjects, and preferably do so in a manner relating to a geographic-territory of interest to the user. Thus, any data stored in the system can subsequently be referenced and/or displayed. In the case where the quality or integrity of one or more outcomes, or user inputs, or data, or data-files, or any combination thereof of a co-located Software Application Tool can be ensured from the oversight of one or more authorized administrators monitoring displayed subject matter (e.g., wherein it is essential to ensure that such content when displayed is always ‘family friendly’ or ‘community friendly’) the system provides software routines to facilitate such administrator monitoring and/or a filtering of such content so as to provide editing as needed to ensure quality assurance and age appropriateness of any viewable and/or listen-to content, and may optionally also provide a content rating system for example similar to the types of ratings used with feature films. As previously described, user-entered data input into, or data-files storable via of a cloud-adjacent software application Tool, can be referenced or cross-referenced by one or more software routines of the system to provide ‘cloud-building’ utility in the same cloud page. Preferably non-incidental words or word phrases most-often used (or entered) by a single user or multi-users in a software ‘Tool’ user-input area 90 (see FIGS. 5 and 6) are made displayable and given prominence in one or more co-located clouds proportionate to their usage, and preferably such data are GT&C or GT&S related and are storable, retrievable and editable by the user (and/or one or more other authorized administrators providing cloud monitoring and oversight).

Community Wiki Software Application Tool(s): The word ‘wiki’ is a Hawaiian word that means fast. Thus when Hawaiians say, “Go wiki-wiki” they mean “Do it quick” or “Go quickly.” A wiki in the present invention is an optional user-selectable software application Tool openable within a geographic-territory specific cloud page that lets groups of people collaborate to share knowledge and ideas. When employing this optional user-selectable Software Tool of the system, Wiki collaborators can add, edit, and delete information about a particular category, or subject, or range of subjects. This sharing of information and collaborative authoring can quickly build a locality-centric or community history storable and retrievable data-file document (e.g., in one or databases or memory buffers accessible to the system). For example, young and old community members can add their recollections of the community's history in the Wiki. They can add their own news and stories, and voice their opinions and any of such can be stored, retrieved and displayed within a Community wild software interface on a geographic-territory specific cloud-page. For example, a wiki could be started called “The History of Cedar Park, Tex.” or “The History of Williamson County”, and be co-located within the same cloud page next to a GT&C/S specific cloud relating to the same location (providing an exposure probability and increased-awareness enhancing juxtapositioned added-value utility). In short, a wiki is about collaborative authoring, accordingly storable, retrievable, editable and displayable ‘Community Wikis’ would enable community members to collaboratively author different wikis about subjects of value to their particular community.

Community Forum Software Application Tool(s): The Roman forum was a public square surrounded by government institutions. In more modern times, the city square was a place for people to meet and discuss things. In the context of the present invention, a forum is an optional Software Tool that enables a public or private meeting or assembly for open discussion on the internet. The discussion can be free-form or structured with different sections of a forum dedicated to different subjects all focused under one general subject. For example, a ‘Cedar Park Community Library Forum’ would allow the librarian in Cedar Park to announce new books, to publicly post the cost of fines of late books, and to hold open discussions regarding various topics including fund raising, or book reviews, and so forth. A ‘Cedar Park Community Fire Department Forum’ would allow the Cedar Park Fire Chief to give seasonal advice concerning hazards and fire prevention that are unique to Cedar Park. He could also host an open discussion regarding home fire safety tips that any participant community member could add comments too. In short, such forums enable and facilitate community-based discussions. Each Community Forum would serve its respective community by enabling community discussions which can include any subject that is locality-centric, and which may be primarily of interest and importance to a particular community.

Community Event Calendar Software Application Tool(s): Event calendars help people see current and coming future events in a familiar, neatly scheduled and well organized manner. A Community Event Calendar would help community members to schedule events or activities that don't conflict with other events or activities. Different communities have different events. Depending on the community, for example, there may be Craft Fairs, County Fairs, Festivals and Parades, Art Exhibits, Plant Shows, Culinary Events, Ethnic and Multi-Cultural Events, Fundraisers and Benefits, Sports, Lectures and Workshops, Musicals and Concerts, Performing Arts Events, Special Events, and even Family Events. A General Community Event Calendar could be one big calendar fed by hundreds of little calendars. For example, the Cedar Park Community Events Calendar could be fed by the Cedar Park Boy Scouts Troop 19 Events Calendar, the Cedar Park Girl Scouts Troop 37 Events Calendar, the Cedar Park Public Library Events Calendar, the Cedar Park High School Events Calendar, the Cedar Park Rotary Club Calendar, and so on. Generally, the Events Calendar Tool enables community organizations to publish current and future events, and, also, update and edit the information about each event as needed. Community Event Calendars would serve each geographic-territory specific community and enable community organizations to publish information about their events.

Community Blog Software Application Tool(s): A blog is an online journal or diary that is ongoing and which is generally written by one person as a chronological publication of their comments, or thoughts, or opinions, and the like, or any combination thereof. A blog written by a doctor as a service to a particular community might be called ‘The Cedar Park Year Around Allergens’ Blog, or a blog written by a mom who is concerned with crime in her community might be called ‘The Cedar Park Crime Alert Blog’. Blogs can be written by anyone. All that is required is an interest in the subject and the ability to write your comments. There are millions of blogs on the internet; so many that there are numerous blog directories, however the current number of directories are unable to keep up with fast expansion of new blogs, and the present system could assist in categorizing new blogs by communities and subjects and thereby giving more community-specific exposure to each of the new blogs. Such Community Blogs serve the community and allow that community's members to write about subjects that would serve their specific geographic community.

Community-Based Questions Software Application Tool(s): Millions of people ask questions on the internet. However, most community and or locality based questions cannot be answered in a timely manner, if at all. The Community Questions software lets people in a specific geographic locality or authorized administrators and the like, add to one or more databases e.g., locality-based FAQs or databased questions, whereby users can ask for help and advice from data entered by community members preferably including user input in the form of ‘Reviews’ and/or ‘Comments’ (e.g., as described in the Comments Software Application Tool(s) below). Thus, a broad scope of databased subject matter can be stored and inquired into and accessed by the system, which depending on the databased data acquired from user and/or Web site administered input could generally include questions like: What is a great local bakery? Who is your favorite real estate agent? Where can I get a good haircut? Does anyone know where the Little League is playing today? and the like. Preferably the system's software includes one or more routines wherein a user asking a question can specify that the question being asked is for a specific geographic territory, for example, a city, county, state, country or international scope, and the like, whereby the software then provides an answer that is specific to the user specific geographic territory. Additionally, a user's questions and answers, and preferably questions and answers of others that the user has selectively chosen, can be compiled, stored and accessed as a viewable listing accessible to the user within the Questions Tool user interface, wherein the listing is preferably sortable, for example, by subject, or category, or date, or date range, or by respondent, and the like, and questions and/or answers thereof, or user-configurable Questions lists, can optionally be stored in and retrieved from folders named by the user.

Community Polls Software Application Tool(s): Each community has a variety of unique issues that may be important only to that community. The Community Polling Software Tool provide users with software means for creating and posting online customized polls and includes software routines for computationally analyzing poll responses, for ensuring one vote per registered poll participant and for displaying and optionally storing/retrieving poll results. Thus, the locality-centric or ‘Community’ aspect of the Polling Software Tool facilitates the building of and reinforcing of a sense that what the members of the community think carries weight, and with such results being available for all to see, community leaders are also provided with a readily accessible feedback means whereby they can choose among options in light of a publicly-accessible polling of their community, and the community can see how responsive their leaders are to the will of the community. Alternatively, a Community Authorized Voter Balloting Software Tool can provide a similar one vote per registered voter/participant means for securely casting one's vote online.

While the previously described polling CSAT provides a community service based information at a local level, it is noted that computer executable instructions of the system can alternatively provide a poll-taking CSAT (as one of the system's co-locatable software tool user interface components) for searching among and analyzing data pertaining to users not limited to a single local area, for example, users in one or more, or many cities, or rural areas, or larger areas such counties, regions, states, territories, islands, countries, continents, hemispheres, globally and the like, or any combinations thereof and can also include one, or a plurality, or a multiplicity of location-specific and/or user-specific types of poll information.

When polls are taken, pollsters want to know who they are polling and need the means to best qualify their audience. Since CSAT users, readers and content generators of the system preferably include a demographically diverse makeup of individuals, or individuals within groups, counties, regions cities, towns, and audiences and the like, and the system provides software for storing, retrieving, searching among and managing files such as data, information or data-files pertaining to users' interests, content generation, clickstream, searches, Web site visitation, inquires, activities, transactions, interactions, commission events, CSAT usage, and the like, registered and logged-in pollsters can benefit from access to the system's data. As previously described, data-files of the system are storable in and retrievable from one or more storing media accessible to the system, wherein identifiers, such as one or more of the following: a geographic-territory specific identifier; a category specific identifier; a subject specific identifier, a user or user-type identifier, and the like, can be associated with a data-file and wherein any one or more of the data-file identifiers (in view of their respective data-files) are searchable by the system. Thus users or groups of users can be individually and/or collectively targeted to answer polls, survey questions, market research questions, and the like. Accordingly, various types of demographically relevant or congruent polls of select individuals and/or groups, beneficial to marketing related organizations, can be conducted and content or data pertaining thereto can be made available commercially to such entities to generate revenue.

Optionally, a poll is displayable by software of the system within or proximate to CSAT content or the text of a text-based listing, or co-located in proximity to one or more clouds, thus such polls are an integral part of the system's single GUI multi-component content experience.

A purpose of the system is to provide, within a single user interface of browser-equipped apparatus, a data acquisition arrangement wherein any of the aforementioned types of data-files are acquired and wherein one or more category specific and/or subject matter specific identifiers pertaining to a data-file are associated with any data-file, either in an automated mode (via one or more computer executable instructions, such as an auto-tagging procedure described elsewhere in this specification) or by a user manually inputting or selecting among one or more data-file identifier choices (for example, in a file saving mode and/or a user profile setup mode). An advantage of the single user interface approach is that the system provides a search-engine user interface and one or more search results displaying components or elements which facilitate a searching and displaying of data-files, data or information pertaining to users in view of the respective associated identifiers of such data, and also provides (within the single user interface) one or more arrangements whereby any of such data can be cross-referenced with previously entered, configured and/or selected advertiser/seller entered criteria to find content which matches or is similar to that criteria, and to display interactive elements whereby transactions and/or commissions based on user interaction with such elements are provided. By having access to some of such databased information, and by the system preferably also providing one or more computer executable software routines whereby the confidentiality of the certain user data can be ensured, pollsters are provided an ideal search-engine and database from which users can be qualified for any poll, and/or from which an automated virtual polling or market research, transparent to the user, can be conducted in view of the system's databased data such as any one or more of the following: user specific data, geographic-territory specific data, category specific data, subject matter specific data, demographic specific data, psychographic specific date, and the like.

The system's poll data are especially valuable to pollsters because user profile information and the interactions of each registered user, such as transaction events, commissionable events, clickstreams, CSAT-type usage, CSAT-content subject matter, and the like, are recorded and stored by the system (e.g. by computer executable instructions) and such information is subsequently accessible to and employable by the system's software to provide highly user specific information which can be of significant polling value. Thus one or more of the following demographic factors/data can be provided or ascertained, such as a user's age, gender, race, income, mobility, vehicles, education, ownership, employment status, location, and psychographic factors/data such as those pertaining to a user's personality, values, attitudes, interests and lifestyles can be provided or ascertained. Thus highly targeted polls, based on such data, can be conducted which are ideal for testing or perfecting marketing appeals, direction of product development, purchase behavior, products or services appeal, products or services concept, business concepts, political platforms, the appeal of movies, songs, books, individuals, and the like.

As such data can be of significant commercial value, for example in the fields of polling, marketing and market research, the system provides computer executable instructions whereby a secure arrangement to receive one or more financial transaction instrument payments from a buyer (preferably a registered user of the present system) for poll and/or market research information can be completed. Such transaction means can be any one or more in a variety of those currently in use on the internet and/or can be any one or more of the payment arrangements described elsewhere in this specification.

As previously described, the polling technology of the system prevents duplicate or fraudulent poll responses by limiting poll input to registered users and a one poll-entry per user for any one or more issues or questions of a given poll.

Community Video (and/or Audio) Galleries Software Application Tool(s): Communities can benefit from community specific digital media file galleries because digital files, such as videos (and/or audio recordings) made by members of a community are typically most interesting to that community's members. For example, a Cedar Park Video Gallery might include videos taken by various community members who attended Cedar Park specific events, such as: ‘The Cedar Park Cedar Chopper Festival’, ‘Cedar Park Pioneer Day’, ‘Cedar Park Veteran's Day Parade’, ‘Cedar Park's18th Annual 4th of July Fireworks’, and so forth. Additionally, video and/or audio media files that the user has selectively chosen, can be compiled, stored and accessed as a viewable listing or as one or more Playlists accessible to the user within the Galleries Tool user interface, wherein the listing is preferably sortable, for example, by subject, or category, or date, or date range, or by the person who posted it, and the like, and media files or references thereto (e.g., links), or user-configurable Playlists, can optionally be stored in and retrieved from folders named by the user.

Community Photo Galleries Software Application Tool(s): Community members also enjoy using software Tools for creating, or adding to, or saving, or retrieving, or editing photo galleries and like to collect and organize photos taken for example by various community members who attend events in their community, e.g., Cedar Park Little League games, Cedar Park Soccer League games, Cedar Park High School Football games, Dance Competitions, other sporting events, dances, Scout Troop events, and so forth. Posting photos like these in galleries randomly dispersed all over the internet would make them difficult to find, whereas a posting of them in an organized fashion as community-specific/accessible galleries makes them much easier to find and use. Such utility also fosters a sharing experience and a form of expressing a community spirit and pride, and since any user-selectable Software Tool of the system provides databased data-file storing retrieval, referencing and displaying means, many more GT&C specific and/or GT&S specific data-files, such as digital photographs, can be accessed, previewed and/or viewed than typically would be taken by one set of parents or family member e.g., of a little league game in which a relative such as a son, grandson or brother has played. Additionally, photographs that the user has selectively chosen, can be compiled, stored and accessed as one or more viewable listings accessible to the user within the Galleries Tool user interface, wherein the listing is preferably sortable, for example, by subject, or category, or date, or date range, or by the person who posted it, and the like, and the photographs or references thereto (e.g., links), or user-configurable Playlists, can optionally be stored in and retrieved from folders named by the user.

Although a number of ‘Community’ specific Software Application Tool examples have been provided, it is noted that any one or more in a variety of other user-selectable Tool categories (or any Tool subordinate thereto), can additionally or alternatively be provided by the system to open a Tool adjacent or near to a displayed cloud preferably having one or more geographic-territory relevant GT&C/S specific cloud or User-Cloud and/or listing outcomes, or benefits and advantages, or data and/or data-file handling functions (or any combination thereof).

For example, other menu selection options may include, but are not limited to, any one or more of the following Tool categories: ‘Social’, ‘Group’, ‘Personal’, ‘Advertising’, ‘Organization’ Tool(s) and/or one or more GT&C/S specific Transaction software application Tool(s) wherein any Tool selected is preferably opened proximate to the currently-displayed cloud such as the GT&C (or GT&S) specific component page 64. In the latter case, a user-seller (renter or leaser) can make a Transaction Tool sub-menu selection from one or more transaction-related menu items such as ‘For Sale’, ‘Auction’, ‘Garage Sale’, ‘Yard Sale’, ‘For Rent’, ‘For Lease’, ‘Flea Market’, ‘Bizarre’, ‘Swap Meet’, (or the like) and a respective cloud-proximate software application Tool will be opened in which a user-seller, preferably having logged into the system, can enter and/or import, save and ‘post’ text and/or non-text based information (such as one or more graphic or video files) pertaining to the item(s) for sale (rent or lease) and their location. Additionally any of such menu items can have one or more selectable sub-categories such as the ‘For Sale’ menu having sub-menu items such as ‘Auto’, ‘Motorcycle’, ‘Boat’ and the like. Subsequently, a user-buyer (renter or leaser), preferably having logged into the system and having made a Transaction software application ‘Tool’ menu selection, can enter geographic-territory and subject search criteria in a manner similar to those previously described such as user search criteria entering techniques or methods, which may include for example, entering the ‘Location’ criteria into geographic-territory specific text criteria field 44 and/or ‘Subject’ criteria into category or subject specific text criteria field 54 (FIGS. 5 and 6). Following the entering of the search related criteria, one or more software routines of the system references previously-saved user-seller entered data and displays any items for sale (rent or lease) matching the user-buyer's (renter's or leaser's) search criteria, for example in a text-based listing adjacent to a cloud, and displays a transaction completing procedure for each matched reference, for example, whereby a user-buyer can make a payment by using any one or more of the payment procedures previously described.

Another category of cloud page co-located software application Tool(s) can optionally include any one or more of the following tools for purchasing and/or replenishing edible consumables a ‘Cupboard’, ‘Pantry’, ‘Refrigerator’, ‘Freezer’, or ‘Favorite Recipes’ Tools or for pets a ‘Pet Food’ Tool and the like (or any combination thereof), wherein information pertaining to food and/or beverage items, usage, preferences and the like are listed by a user in any one of such Tools, and/or are automatically recorded according to a user usage, for example, when purchases facilitated by user interaction with a cloud ADC element or a link in a text-based listing within a cloud page have been made by the user, and in either or both cases the information is included as part of the databased data of the system. Thus, when any of such data input, or any of the previously described user and/or system administrated data input is accessed by the system (as previously described), it provides for the display of one or more clouds and ADC elements based on the Tool and/or purchase-history databased data, including the option of listing items that need, or are, or are about to be, or are calculated (e.g., by time) to be, depleted/needed or expired, and need to be re-ordered by the user. Cloud ADC elements reflective of the user's Tool input and/or purchase-history are preferably made available to and are purchasable by advertisers, whereby user interaction with any of such advertiser purchased ADC elements provides the means for the user to complete the purchase of one or more food and/or beverage items, including the option to have any of such items delivered to a location specified by the user.

A similar Tool/Co-Located Cloud(s) approach can optionally be taken based on users' other regular/repeated transaction-based needs, such as the payment of utility bills, monthly online banking and/or financial needs, and the like, or for area-specific needs pertaining to a user's ‘Garden’, ‘Plants’, ‘Office’, ‘Bedroom’, Living Room, ‘Garage’ (or one or more other user specified rooms) and the like, wherein a user's recordable input and/or recordable payment-history creates storable databased data accessible to the system. For example such data is created and stored when any one or more regular, or repeated, or periodic user input, or user transaction input occurs, such as any one or more of the following: re-ordering goods or activities or services, paying bills and/or utilities online, managing online checking, online banking, online credit or debit card banking, and the like. Cloud ADC elements reflecting a user's CSAT input and/or purchase-history, or data pertaining thereto, are preferably made available to advertisers for a fee (for example, a fee paid by a business competing for cable services, or utility services, or banking/financial services, and the like), whereby user interaction with any of such advertiser purchased ADC elements provides the display of an arrangement whereby the user can make or complete one or more transactions pertaining to and/or payments for, any of such services.

Optionally, one or more menu selections can be provided within a cloud Web page of the system for a user to select a co-locatable software application Tool (CSAT) having educational or instructional value, whereby one or more Tool menu categories can be accessed by a user such as ‘Educational’, or ‘Instructional’, or ‘Training’, or Tutorial” menu-selectable categories, and the like, and wherein a desired CSAT subordinate to a category can optionally also be selected. For example, the system can provide menu-selectable educational or instructional material about how to create and/or best manage a wiki, blog, forum, calendar, or the like, so that a user wanting to learn more about any cloud-proximate software application Tool of the system can access the educational or instructional material (e.g., text, audio or video material) as needed.

Software of the system provides the means whereby any cloud-proximate co-locatable software application Tool (CSAT) and/or educational or instructional material pertaining thereto, can be provided free, or free for a trial period, or can be provided on a pay-per-use basis and paid for using any one or more of the previously described payment means.

Preferably, whenever a logged-in user-buyer (renter or leaser) employing the system makes a secure online payment, one or more transaction-related computer executable instructions of the system also provide an arrangement for the buyer to make one or more payments online or by mail (or other carrier) and for automatically deducting a commission and/or transaction fee (or charge) from any payment and paying any balance due to the seller (renter or leaser or service provider) in accordance with one or more selectable, system-required and/or seller-specified transaction payment parameters. For example, a payment due to a seller may be transferred to one or more secure financial institution accounts, or to an eWallet type of account specified by and accessible to the seller by secure and/or encrypted communications means. Similarly, a commission due to the intermediary business or entity providing the present system or any of its services can automatically be transferred to one or more secure financial institution accounts selectable and/or specified by an authorized administrator of the system, and the like.

Preferred system embodiments include one or more co-locatable software application Tools ‘CSATs’, which when employed by a user are preferably equipped to produce outcomes pertaining to, or relating to, a geographic-territory of a cloud displayed on the same Web page as the Tool(s). For example, CSATs can consist of one or more of the following software applications, providing: instructional and/or educational material, blog-creation with or without blog-managing templates, forum-creation with or without managing templates, Web site or Web page-creation with or without managing templates, wild-creation with or without managing templates, software for creating and posting text on a Web page, software for creating and posting one or more audio-files on a Web page, software for posting one or more video-files on a Web page, software for posting one or more graphic-files on a Web page, software for posting one or more multimedia-files on a Web page, and the like. Preferably CSATs are made accessible and/or deployable adjacent to, or in close proximity with, one or more geographic-territory specific word and/or subject specific clouds on the same Web page so that there is optimum proximity-effect and interrelated geographic-territory congruence or relevance between a cloud and the co-located Tool(s). Thus the variety of CSAT type openable adjacent or proximate to any geographic-territory word cloud(s) can be quite diverse and/or robust, including but not limited to one or more of the following application types: online-deployable software applications such as one or more programs making up a typical office suite of programs, VoIP programs, teleconferencing programs, webcam communication programs, online video games, interactive online video games, drawing programs, graphic-editing and or displaying software routines or programs, video-editing and or displaying software routines or programs, 2D and or 3D CAD programs, online-deployable Web page-enhancing tutorials or instructional materials, one or more templates for starting and maintaining community based discussions or forums, or organization forums, or combinations thereof, and the like.

In reference to FIG. 5, a viewable area of a GT&C/S specific component page 64 or browser displayable area similar to that of FIG. 4 is depicted wherein the GT&C/S specific cloud page header 74 alternatively is shown including: (i) an optional geographic-territory specific text criteria field 44 in which a cloud page specified geographic-territory 66 is displayed (editable by a user) and optional drop-down menu user control means 60 (which when clicked on can optionally list and provide for a user selection among a number of previously used ‘Location’ criteria), and (ii) an optional category or subject specific text criteria field 54 in which a user may enter one or more category or subject criteria to cause the display of one up to dozens or up to hundreds of suggestive and/or associative discernible content ‘ADC’ elements 72 pertaining to the user-entered “Location” and “Subject” criteria and displayable within a GT&C (or GT&S) specific cloud display area 68. The category or subject specific text criteria field 54 may also include an optional drop-down menu user control means 60 (which when clicked on can optionally list and provide for a user selection among a number of previously used ‘Subject’ criteria). When a user enters or selects either or both criteria (in fields 44 and 54), one or more computer executable instructions of the system immediately perform a search of databased data and/or data-files corresponding to the search criteria and access files identifiable with the criteria to display ADC elements 72 (of the sought-after cloud 70) and optionally may also provide the display of a text-based listing based on or related to the matched criteria such as the type depicted in FIG. 4 (80). Preferably displayed ADC elements 72 are interactive and responsive to input from suitable user input means in any of the ways previously described.

FIG. 5 further illustrates the option of a user selecting one or more cloud-proximate co-locatable software application tools ‘CSATs’, for example, from a cloud-page menu ‘Tools’ selection means 78, wherein, a cloud-page ‘Tools’ menu 84 can provide users one or more ‘Tool’ choices and one or more of those displayed choices can, as needed, provide a ‘Tools’ sub-menu selection means 86. When a cloud-proximate CSAT is selected it is openable next to, or in close proximity with a cloud 70 displayed on the same page. Preferably, as depicted in FIGS. 5 and 6, a user is provided one or more optional cloud-switching user interface elements responsive to user input so that the user can easily switch or make a selection between a plurality of clouds (and a viewing of a cloud's respective ADC elements) such as one or more ‘Search-Cloud(s)’ tab 92 (e.g., to switch to/between one or more clouds found as a result of a user-conducted search), and/or ‘User(s)-Cloud(s)’ tab 94 (e.g., to switch to/between one or more clouds displayed as a result of input made by a single user, or alternatively input made by multiple users employing one or more co-locatable software application tools ‘CSATs’). While a plurality of software interface ‘tabs’ are depicted as the means whereby cloud switching may occur, it is noted that one or more check boxes, or radio buttons, or menu selections, or drop-down or pop-up menu selections (and/or sub-menus thereof), or the like, can alternatively be provided adjacent to, or within, or in close proximity with a cloud 70 to provide similar, or the same, functions for switching to/between clouds. For example a menu providing selections reading ‘Search-Clouds’ or ‘User-Clouds’ or ‘Favorites’ can be equipped with one or more menu sub-selections such as a text list or displaying of bookmarked, or recently viewed and selectable clouds. Preferably, during any user session, cloud data pertaining to the display of one or more tab-selectable clouds or menu switchable clouds and/or ‘Favorites’ clouds within a cloud display area 68 is retained in a memory buffer which can be instantly accessed in response to user input to provide rapid re-draw of cloud displayed content when any of such switching input occurs. Preferably, when a user switches among two or more clouds within one or more cloud pages any ‘Location’ and/or ‘Subject’ criteria pertaining to the switched-to cloud is automatically accessed from a memory buffer or databased data by the system and displayed in their respective geographic-territory specific text criteria field 44 and/or category or subject specific text criteria field 54. It is noted that user entered or pre-configured search criteria such as Cloud page specified geographic-territory 66 (and/or a search criteria category or subject) can alternatively be located elsewhere within component page 64, for example within cloud display area 68 and/or at the top of optional GT&C/S specific text-based search result listing 80 (FIG. 4) or within software Tool interface 88 or software ‘Tool’ menu bar 100 thereof and the like. Additionally, it is also possible to include a cloud ‘Favorites’ drop-down or pop-up type of menu accessible within a cloud page, e.g., in cloud page header 74, whereby the selecting of one or more user favorite clouds can be easily recalled by a user. Thus, a user having entered a ‘Location’ and ‘Subject’ criteria (or having entered or chosen a simpler Default) and ‘navigated to’ (caused the display of) one or more ‘Search-Cloud(s)’, and subsequently employing one or more cloud-adjacent co-locatable software application tools ‘CSATs’ to enter text inter-operably causing a display of related cloud text (i.e., text ADC elements) in one or more viewable ‘User-Cloud(s)’, can rapidly switch between a plurality of Location and/or Subject identified clouds. For example, a user can switch from a more recently viewed ‘User-Cloud’ to a former viewed Search-Cloud (and back again, or to one or more ‘Favorites’) by using any one or more of the aforementioned types of cloud-switching user interface elements.

In reference to FIG. 6, a GT&C/S specific component page 64 is depicted which is similar to the cloud page of FIG. 5, however the multi-ADC element cloud display area 108 of FIG. 6 (depicted with an optional border and scroll bar) accommodates and displays non-text ADC elements, or the combination of text and/or non-text interactive ADC elements such as hyperlinked (or otherwise interactively-enabled) graphical representations of video and/or audio content playable in response to a user input from a suitable user input device (not shown). Optionally, the cloud display area 108 can also be equipped for displaying RSS feeds, and the like. Thus, cloud display area 108 can be used for playback of text, video and/or audio announcements, user notifications, advertisements and the like. Preferably cloud display area 108 also includes cloud-switching means such as those described in reference to FIG. 5 (e.g., 92, 94 and 96), whereby a user can switch between one or more clouds such as ‘Search-Clouds, or ‘User-Clouds’ (displaying ADC elements derived from user data entered into and/or saved by one or more interoperable, co-located software application Tools), or ‘Favorites’, and the like, or any combination thereof. FIG. 6 further illustrates the aforementioned advantages of an enhanced exposure probability and increased awareness of cloud page elements and content when juxtapositioning one or more software application ‘Tool(s)’ which are openable and operable next to, or near to, a displayed location and/or subject related cloud.

Preferably a co-locatable software application tool ‘CSAT’ user interface 88 includes a software application Tool menu bar 100 (FIG. 6) from which one or more software application Tool menus 102 can be opened by a user as needed to select one or more menu options. For example, a menu may include conventional menu selection items found in common software applications and/or cloud related selections such as an “Update Cloud” menu option 104 which when selected causes recently entered data or inputs made by a user in a CSAT to be displayed i.e., updated, in the respective displayed or displayable cloud (preferably in accordance with one or more preset and/or user-configurable parameters affecting the display of ADC elements). Also depicted is an optional “Print Cloud” menu selection 106, which when selected causes a printer/printout controlling software window to be displayed from which a user may select one or more printing options relating to the printing of a cloud's contents. As can be seen in FIG. 6, the software application Tool menu bar 100 may include any among a variety of common or custom menu bar selections including but not limited to “File”, “Edit”, “View”, “Tools”, “Options”, “Help” and the like. For example, a clicking on the “Tools” menus selection can provide the user with a selection among one or more other CSATs, or a selection among one or more already opened but nested Tool(s) e.g., hidden from view in a layered Tool window or pane under one or more layers of opened Tools. Each CSAT may also include an “Options” or “Preferences” or “Setup” menu selection whereby one or more parameters pertaining to that Tool can be configured by a user or advertiser, and so forth.

Optionally non-text ADC elements, or a combination of text and non-text ADC elements are displayable within a multi-ADC element cloud display area 108 (FIG. 6) for example in a displayed ‘Search-Cloud’ (and in some cases a displayed User-Cloud or ‘Favorites’ cloud). Any of such ADC elements are procurable as a form of GT&C/S specific advertisement, can be proximately-arranged to other elements in a cloud-like arrangement and can be hyperlinked or otherwise equipped to be responsive to user interaction in one or more of the ways previously described (having one or more user-interactive parameters selectable and/or configurable by an advertiser).

Non-text ADC elements or combinations of text and non-text ADC elements of a multi-ADC element cloud are storable and retrievable in a digital file format in a memory accessible to the system, and can include, but are not limited to, any one or more of the following: indicia; keywords; alpha-numeric keywords; text; text-strings; text ads; classified ads; display ads; audio ads; video ads; slogans; mottos; logos; trademarks; service marks; brand names; cloud tags; graphical elements; animated graphical elements; bar codes, optically scannable content; animated content; video content; audio content; MP3 files; audio and video content; graphical representations of compressed digital media; elements responsive to user interaction with a user input means; elements responsive to user voice commands via a microphone and or other signal generating device connected with the system; elements responsive to the touch of a user's digit on a browser equipped apparatus having a touch-sensitive screen; elements responsive to or displayed in accordance with GPS generated data; maps; scalable maps; elements providing one or more user interactivity during a cursor interaction or rollover; elements providing a visible indication as to their current purchase-availability status; elements providing their current purchase-availability status during interaction with a user input means; elements which change size and/or appearance according to the number of times they're clicked on; elements which change size and or appearance according to the amount of a paid advertising fee; elements which change location and or appearance according to the amount of a paid commission fee; elements which change location and or appearance according to whether or not they are currently paid for; elements which change location and/or appearance within a word cloud; elements which are animated to move or be positioned within a word cloud in a manner similar to the movement of cloud portions circulating within actual clouds; elements which are animated to pan horizontally within a word cloud; elements which are animated to move or be positioned in separate horizontal rows at different speeds within a word cloud preferably relative to the fee-amount paid for an element in a given row (e.g. higher fee/slower panning, lower fee/faster panning); elements which change color and or appearance; text elements which are configurable by a user in a manner similar to the configuring of text or fonts within a word processor or graphic editing software program; elements having a location-specific relevance to a user's locale; printed content, and the like. It is noted that one or more in a variety of other procurable, proximately-arranged and hyperlink-equipped GT&C/S specific ADC element types may alternatively be employed and that the examples provided herein are illustrative and therefore, not meant to be considered exhaustive in their scope.

In a co-pending patent application by an applicant of the present patent application, the combination of conventional advertising printed media having a printed matrix, or 2-axis grid or table, of thumbnail advertisements (ads) and a complementary Web site-displayable matrix of thumbnail ads related thereto, is disclosed, wherein the latter is displayed in response to an internet user entering a code associated with, and represented in, the conventional advertising printed media format, or a code seen in a video or Web site format, or alternatively a code heard on the radio or in a audio and/or video format. In the present system, one or more optional computer executable instructions provides for the displaying of a similar matrix of discreet thumbnail ads (or a single bitmapped representation of the ads having an interactive transaction-enabled placeholder positioned over each graphic representation of an ADC element) within a cloud display area of a multi-ADC element cloud or user interface display area, in response to a user seeing or hearing a code associated with the ad in a printed, audio, video or Web site format, and the user entering the associated code, for example, by entering the code within one of the text-entry fields or cells of cloud page header 74 or within the location and subject entry bar 110 of a CSAT, or within a text entry field or cell identified for the entering of a code, or as criteria entered into a search field of the system's search user interface. Preferably the advertisements displayed in the thumbnail ads format are paid for by sellers/advertisers who are registered participants of the system. Software of the system can alternatively or additionally provide the displaying of a bitmapped representation of such thumbnail ads displayable within a cloud display area or as a separate co-located component within a single user interface display area of the system. Any thumbnail ad image displayable in the matrix arrangement of ads can provide interactivity as previously described, and/or any thumbnail ad appearing within a bitmapped representation of a plurality of ads can optionally further comprise a respective interactive placeholder element (e.g., a transparent placeholder), whereby each of the former separate ads, or each of the latter bitmapped ads, are responsive to user input from a user input device to provide one or more of the functions previously described in reference to ADC element interactivity. As depicted in FIGS. 5 and 6 one or more clouds 70 and/or cloud display area 68 can be made vertically or horizontally scrollable, or both, by scrolling means such as an optional cloud-scroll bar 98.

Similarly, in the case of completing one or more ADC element related deliverables transactions, a user can employ browser apparatus user input means to click on, or rollover (or engage via another common user interface element interactivity) a GT&C/S specific cloud associative discernible content ‘ADC’ element comprising a word, or plurality of words, or other non-text element(s), and be presented with the user interface arrangement for accepting and completing one or more payments for each transaction by the user entering information pertaining to a financial transaction instrument, such as credit card, credit-line, debit card, payment account, a PayPal or eWallet payment, or any other financial transaction instrument suitable for use in secure online transactions.

FIGS. 7 and 8 are views similar to the embodiments of the user interface depicted in FIGS. 5 and 6, wherein in FIG. 7 a co-located software application Tool ‘CSAT’ is shown being identified as a ‘Blog’ tool by a CSAT-type indicator 162, the tool being selectable by users for generating, editing, managing and reading blog (CSAT-generated) content. For example, a user choosing a CSAT from a CSAT selection menu as shown in FIG. 5 (e.g., 78) can select a ‘Social’ CSAT category and a ‘Blog’ CSAT as a tool sub-category thereof, which causes the Blog CSAT to be opened and operable, for example, as depicted in FIG. 7. In one CSAT Blog mode a registered user opens the CSAT and creates or generates blog content and saves it or posts it (or ‘publishes’ it). In another CSAT Blog mode a content reader can search among and open CSAT blog content which the reader is interested in reading.

As previously described, one or more CSATs can be opened and/or made operable and can be switched among or otherwise launched (e.g. as a preset or default CSAT) by a user input device interactivity, such as a clicking on or rolling over a reduced-sized icon or user interface element, such as those depicted in a software application tool icon grid 128. Optionally an icon can be highlighted to indicate that a corresponding CSAT is currently active. For example, the fourth icon highlighted in the tool icon grid 128 corresponds to the ‘Blog’ tool being currently operable. By clicking on another icon, a different CSAT corresponding to that icon can instantly be displayed and given priority. Hovering over an icon optionally can cause the display of information pertaining to that icon's respective CSAT, for example, a small pane or user interface element can display the CSAT type, and optionally the location and/or category or subject, and/or a filename given to the current CSAT data-file which has been named by CSAT user.

A similar approach is provided in an optional reduced-size cloud icon row 160 wherein one or more clouds, or cloud-types, can be opened and/or made operable and can be switched among or launched (e.g. as a preset or default CSAT) by a user input device interactivity, such as a clicking on or rolling over a reduced-sized cloud icon. Optionally a cloud icon can be highlighted to indicate that a corresponding cloud or cloud-type is currently active. For example the second cloud icon above the cloud-type ‘User(s)-Cloud’ is highlighted in the reduced-size cloud icon row 160 indicating priority being given to the currently viewable/displayed cloud. Preferably the header bar 74 of the user interfaces depicted in FIGS. 7 and 8 include a geographic-territory specific text criteria field 44 (or cell) and a category or subject specific text criteria field 54 (or cell) and each CSAT preferably includes a location and subject entry bar 110 whereby one or more of such criteria can be entered by a user, or can be automatically duplicated from fields 44 or 54 into the criteria fields of location and subject entry bar 110 (e.g., by default, or when a CSAT is opened or displayed, or by a selectable option made in a setup mode). Fields 44 and 54 and the criteria fields of location and subject entry bar 110 respectively are depicted in FIGS. 7 and 8 having a location criterion of the “Denver Area” and a category or subject criteria of “Home Computer”. Preferably, any of the criteria displayed in a field can be over-written by a user entering other alpha-numeric content at any time or can be replaced by the user making a criterion selection from a menu, such as a drop-down or pop-up menu (including user selections being made from a menu, or from a history record or bookmark record of one or more criteria previously employed by a user). Preferably a filename given to a current CSAT data-file which has been named by a CSAT user can also be displayed for example in an upper portion of the software ‘Tool’ user interface 88 and/or in the header bar 74.

It has been recently observed that Web sites providing the means for users to upload, post or otherwise publish content online (such as text, graphic, photographic, audio and video files) have the problem of such postings or uploadings not being sufficiently tagged (i.e., by a categorizing or identifying process) to facilitate finding the content during subsequent searches. For example, files can be uploaded by users having names using poor, little, abstruse or no file-naming conventions, which are not conducive to being categorized in a manner which facilitates effective searching. As a result, a significant percentage of uploaded files are poorly categorized making them difficult or impossible to find during criteria specified searches. In a recently completed ‘Web 2.0 ’ framework aimed at improving internet practices, the need for uploaded content to have improved tagging was emphasized and the point stressed that it would be beneficial to create new approaches which encourage users to tag-identify uploadable content, and that doing so would significantly improve Web site and internet searching capabilities and generally improve the internet user-experience.

To address this need, the present invention provides optional auto-tagging functionality wherein, in one mode, one or more criteria displayed in header bar 74 and/or CSAT location and subject entry bar 110 (optionally also configurable as one or more default in a setup or preferences mode) can be automatically associated with a CSAT data-file as criteria-identifier(s), for example when the user performs a CSAT data-file managing step such as a ‘Save’, ‘Save As’, ‘Publish’ or ‘Post’ step (or by the system performing a periodic auto-save function). Thereafter, any data-file having the associated criteria-identifier tagged content can be searched, and referenced by data-file managing software routines of the system, such that data-files of a desired CSAT/content type, associated with a desired location and/or category or subject, can be retrieved or cross-referenced within any matching criteria previously entered by one or more advertisers/sellers, and are displayable as needed e.g., within the system's single GUI. For example, such data-file managing software routines of the present system can be implemented in response to a CSAT-user or CSAT content reader: (a) conducting a search for content or (b) seeking to find and then open a data-file related to one or more criteria, or (c) when the system searches, references or cross-references CSAT user and/or advertiser/seller entered criteria. Thus the relevancy of displayable interactive element matches, between previously entered advertiser/seller criteria and CSAT-user entered content is improved by the addition of searchable auto-tagged location-specific and/or category (or subject) specific identifiers. In each case, criteria-identifiers provide enhanced exposure probability and increased awareness of automatically (and/or optional manually) tagged content because such found and/or matched content is related to a location and/or category or subject of interest specified by a user. Thus, the aforementioned auto-tagging approach of the system provides the means to ensure the display of location and/or subject relevant (or congruent) content, whereby one or more interactive elements or hyperlinkable content can be embedded or otherwise displayed within the content display area of one or more CSATs (or within one or more of the system's other complementary, co-locatable components that are also displayable within a single GUI). Preferably such interactive elements are made responsive to user input means interaction, facilitate the completing of deliverables transactions resulting from the display of one or more criteria-matching offerings or propositions of advertisers/sellers that are made congruent (by the system) with a location and/or subject of interest to a CSAT-user, and preferably also facilitate various types of transaction-related and/or commission-related events relating thereto. Another auto-tagging functionality can alternatively or additionally be provided as a result of the system reading and analyzing CSAT content as it is being inputted by a user, or during one of the previously described data-file searches or data-file managing steps, and then suggesting tags, for example by temporarily highlighting, underscoring or hyperlinking: (i) text in the CSAT content which is most-often used (not including incidental words such as “and”, “or”, “but”, “the” and the like which can be filtered) and/or (ii) text matching or relating to one or more advertiser-entered criteria, or (iii) text within a text-based listing component, and preferably in each case, providing the user the means to accept or reject any one or more of the suggested tags, or to manually add (e.g., type) or subtract other tags to and from the tags that have been proposed.

Thus the aforementioned auto-tagging functionalities provide enhanced exposure probability and increased awareness of advertising content because the system ensures that displayed CSAT content and interactive elements thereof and advertising content, have a congruence and relevance to one or more location and/or subject criteria specified by, and of particular interest to, a user.

FIGS. 7 and 8 further illustrate the inter-operability, and enhanced exposure probability and increased awareness of advertising content when displayed by the system within co-located components viewable in the same user interface, e.g., displayed within a single GT&C/S specific component page 64, Web site or Web page thereof, or a viewable display area within browser-equipped apparatus, and the like.

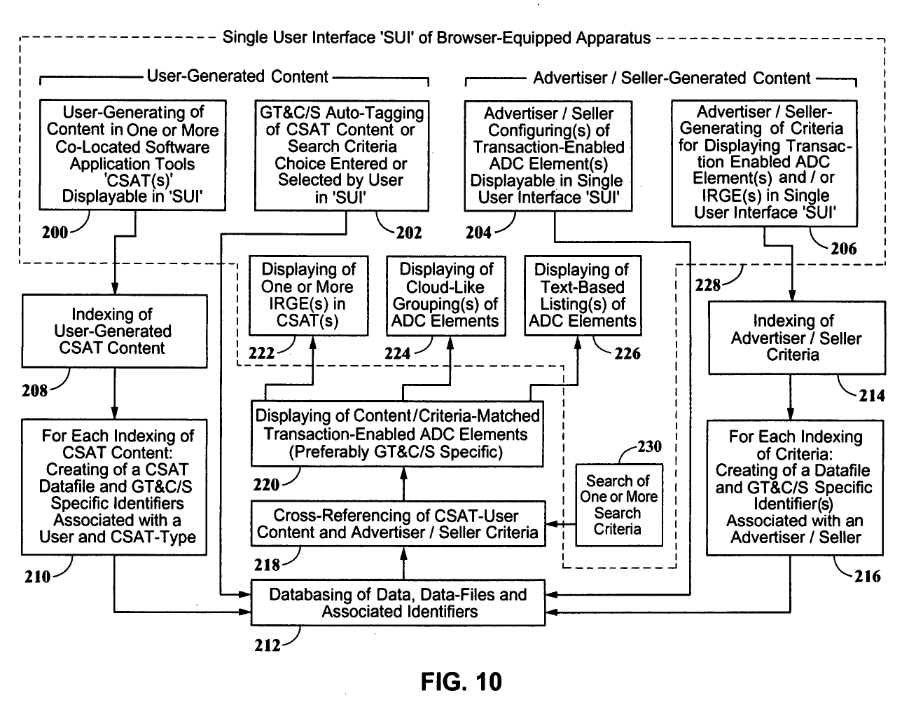

FIGS. 7 and 8 illustrate an embodiment of the invention wherein a plurality of the inter-operable complementary components simultaneously displayable in a single GUI of the system are optionally equipped to provide an auto-linking functionality. For example, in reference to FIG. 7, the software ‘Tool’ user-input area 90 of software ‘Tool’ user interface 88 (of a ‘Blog’ CSAT) depicts text as it might appear when a blog CSAT user is generating or has saved, posted or published geographic-territory and/or subject specific blog content, or when a content reader is reading blog content. Prior to the creation of the blog text depicted in the tool user interface 88, six system participant (registered) advertisers/sellers who each sell ‘Home Computer’ related deliverables made available in the Denver Area (or who provide shipment of deliverables to Denver) have entered or selected auto-linkable computer-related criteria in an advertising content parameters setup/configuring mode (se FIG. 9, 300) such as “LCD Displays” (and optionally enter or select other synonymous words) among advertising criteria they wish to have referenced when searches are conducted by users within the system, or referenced as users are generating and/or saving content within one or more CSATs. Following the entering or selecting of auto-linkable criteria by one or more advertisers/sellers, CSAT content can then be referenced (or searched) in view of such criteria, by software of the system. Accordingly, when computer executable instructions determine an exact match (or optionally an approximate match) of one or more of the criteria entered by advertisers/sellers found within stored CSAT content, software of the system makes the content interactive (such as “LCD Displays” depicted in FIGS. 7 and 8) for example by making the matched content hyperlinked. When input from either the user input means of a CSAT content generator or a content reader (reading the CSAT content within a Web page of, or made displayable external to, the system) causes an interaction with the auto-linked content, for example by the positioning of an input device cursor 164 over (or by a clicking on, or input from other user input means) the hyperlinked content, such interactivity immediately causes the display of a representation of one or more (or a specified range of) advertisers/sellers or one or more propositions or offerings thereof associated with the hyperlinked content and preferably also causes the display of a small adjacent numeric element indicating the number of advertisers/sellers and/or any propositions or offerings thereof associated with the hyperlinked content (e.g., as depicted adjacent to the hyperlinked ‘LCD Displays’ text). In response to input from suitable user input means, the display of advertiser(s)/seller(s) (or any proposition or offering thereof) can be presented within a pop-up pane or window, for example adjacent to cursor 164 (not shown), or displayed within another co-located component of the user interface, for example the text-based listing depicted in the multi-ADC element display area 108 of FIG. 7, or within a text-based listing, for example beneath the blog CSAT as depicted in FIG. 8. In each case the listing can provide additional interactive options to the content generator or content reader (which preferably can be individually or collectively selected or deselected by a user). Optionally, when a user interaction such as a rollover is discontinued, the display of the advertiser(s)/seller(s) listing (or any proposition or offering thereof) can also be immediately discontinued, or a close check box 172 can be provided to discontinue the displaying of a list. Accordingly, a content generator, or content reader, or both, can be presented with the system's auto-links or other interactive content resulting from the system software finding matches between CSAT content and advertising criteria entered, configured or selected by one or a plurality of advertisers/sellers, and making the criteria-matching CSAT-content hyperlinked or otherwise responsive to input from suitable user input means, and displaying it in one or more of the co-locatable components of the system's GUI. Information pertaining to one or a plurality of advertisers/sellers, or their offering(s) or proposition(s), associated with an auto-link are immediately displayed in response to user input device interaction(s). Preferably, auto-link interactivity options are also displayed, such as one or more transaction-related and/or commission-related events leading from user interaction(s), and wherein such interactivity and multi-component inter-operability occurs seamlessly within co-located components of the system within the same user interface, e.g., displayed within a single GT&C/S specific component page 64, Web site or Web page, or a viewable display area within browser-equipped apparatus. Such auto-linking functionality also facilitates the display of Interactive Revenue-Generating Elements or ‘IRGE(s)’ (such as the hyperlinked ‘LCD Displays’ example) which are described in detail below in the descriptions pertaining to FIG. 10.

At the option of an authorized administrator of the present system, the system can process certain types of data, or metadata or be configured to do so automatically. For example, user generated CSAT content can be enhanced with metadata which includes information about the user generated content which can be appended to searchable source code of a displayable Web page. The metadata can include any in a wide variety of information including, but not limited to, the geographic location of the content generator, and may also include metadata related to one or more of the following types of information: category, subject, time, date, user information, and the like.

In the status quo approaches to the facilitating of commissionable events within the eCommerce/Internet arena, the means are provided for a user who generates or compiles content readable online, to configure one or more hyperlinked words or elements within that content that will produce commissions by content readers interacting with, or completing transactions based on, that hyperlinked content. This type of user is referred to as an ‘affiliate’ and has, by a previous registration and fee-based arrangement with one or more intermediary affiliate program Web sites, been provided means to generate and/or compile text content covering subject matter that is of interest to online content readers and which can result in the display of one or more interactive text hyperlinks in that content that match subject matter which, through another separate arrangement, has previously been selected or entered as advertising-related words, or keywords by advertisers selling related goods, services or activities.

In contrast to requiring users and/or advertisers to make such arrangements at one or more, or various, Web sites different from the Web sites used by content readers and different from the Web sites used by those offering various types of deliverables, the present system provides a consolidating or integrating approach, wherein complementary user interface components, co-locatable and operable within a single GUI of the system (or within a single Web page or cloud page of the present system) can seamlessly provide one or more of the following outcomes: the generating of content by CSAT users; the reading of content by content readers; the matching of content with advertiser/seller configured criteria and the displaying of matched content as interactive elements within one or more of the system's co-locatable components; arrangements for completing of transactions resulting from the display of such interactive elements; and the configuring and implementing of commissionable events and the payment of commissions based on any of those events.

FIGS. 7 and 8 also illustrate optional Benefits Program configuring arrangements, wherein Benefits Program option settings 176, optionally displayable within or proximate to a plurality of the co-located components of the system (e.g., displayable within a second CSAT, or cloud display area as depicted in FIG. 7, or next to a text-based listing as depicted in FIG. 8) can be configured by a user to facilitate transaction-related and/or commission-related events or user interactivity. For example, FIG. 7 depicts a Benefits Program ‘Show Others Links’ on/off user interface element, and in reference to a text-based listing FIG. 8 depicts a similar ‘Show Other CSAT Links’ on/off user interface element whereby, in either case, a content generator or a content reader can turn on or off the displaying of auto-linked advertiser/seller entered criteria matches (and any respective transaction-related and/or commission-related events pertaining thereto). Similarly, Benefits Program option settings 176 also depicts a ‘Show Links in Your Text’ on/off user interface element (in FIG. 7) and similarly depicts a ‘Show CSAT Links in Your Text’ on/off user interface element (in FIG. 8), whereby, a content generator has the option to turn on or off the display of auto-linking in content he or she is generating or displaying within a CSAT. FIGS. 7 and 8 also illustrate a global ‘Benefits Program Toggle On/Off’ user interface element option. While the on/off user interface element is depicted as a check box it is noted that other common user interface elements providing the same or similar interactivity and functionality can alternatively be employed. It is also noted that such configurings of the Benefits Program can instead be made in an options, or preferences, or setup mode, for example in a separate pane or window, or by selections made from a menu or by one or more keys or function key commands, and the like. Preferably the displaying of advertiser/seller related content optionally includes one or more links such as a business name link (e.g., as depicted adjacent to each of the numbers 1-6 in the test list), and/or one or more links similar to those previously described as being included within text-based listings (e.g., ‘Contact’, ‘Order’, ‘Web’, ‘Map’, ‘Reviews’ links or the like) so as to facilitate advertisement and commerce-related interactions inter-operability, as well as the making or completing of any one or more of the aforementioned commissionable events and/or transactions, in the same-page displayed complementary components of the system. For example, a linked ‘Contact’ selection can provide one or more ways for a user to communicate with an advertiser/seller company or entity, such as phone number(s), fax number(s), email address(es), Instant Messaging, text messaging, voice messaging, and the like.

While FIG. 7 depicts advertisers/sellers associated with previously entered or configured advertising criteria within the blog CSAT content (namely, ‘LCD Displays’) and displays that association in the form of a text listing in cloud 70, it is noted that each matching advertiser/seller can instead be represented by a text or any of the previously described non-text ADC elements e.g., arranged proximately to other ADC elements in a cloud-like manner. Optionally a cloud, such as the Benefits Program cloud depicted in FIG. 7, can be opened or closed selectively by a user e.g., by double-clicking on a respective and/or associated interactive element or hyperlinked element within a CSAT.

The co-located components displayable in the single user interface of FIGS. 7 and 8 are preferably scalable, for example by CSAT sizing means 168 or by cloud sizing means 166, or by conventional user interface element sizing means, or according to any of the methods previously described. Thus, any co-locatable component of the present system can be expanded to a maximum viewable display area within the single user interface, or component page 64, or Web page, of viewable area of a browser-equipped apparatus, and can be minimized as needed.

FIG. 8 depicts a cloud 70 similar to the cloud 70 of FIG. 7 wherein the advertiser/seller-listing 170 (co-locatable component) optionally displayed as text ADC elements within a cloud display area in FIG. 7 is shown alternatively being displayed beneath the blog CSAT in FIG. 8 providing the same or similar interactive options (as in FIG. 7) and having an optional vertical arrangement of the Benefits Program option settings 176. The software ‘Tool’ user interface 88 is shown having been decreased in size, for example by a user employing a user input means to click on and drag the CSAT sizing means 168 (FIG. 7) at the lower right hand corner of the user interface in an upward direction.

In reference to FIG. 9, a generalized diagrammatical depiction illustrates how Auto-Linking and Auto-Tagging operations of the system are implemented within a single user interface, Web page or cloud page. The Auto-Tagging aspect is generally represented on the left half of FIG. 9 using reference numerals 200, 202, 208, 210, and 121, and the Auto-Linking aspect is generally represented on the right half of FIG. 10 using reference numerals 204, 206, 214, 216, and 212. With the exception of the left half steps 208, 210, 212, 218 and 220, and the right half steps 214, 216, 212, 218 and 220, all other operations or steps, can be implemented within the single user interface 228 of the present system.

For example, in the Auto-Tagging operation, one or more Co-Located Software Application Tool(s) ‘CSAT(s)’ 200 are opened by a CSAT User 202 and the Location entry field and optionally the category and/or subject entry field(s) of any opened CSAT are configured (as previously described) to receive CSAT with Geographic-Territory and Optional Category or Subject (GT&C/S) Specific Identifier(s) or ‘Tag(s)’ 204 which can be entered or selected manually by a user, automatically duplicated from any of such criteria or data displayed in the Web page ‘Location’ field or ‘Category’ field, or both. Alternatively, one or more identifiers or tags can be derived from a default or a ‘Favorite’ parameter, selected from one or more ‘History’ records or bookmarks, or otherwise pre-configured, for example, during a setup, options or preferences mode. Alternatively, any criteria entered into or showing in the Location entry field and optionally the category and/or subject entry field(s) of the Web page in which a CSAT is displayed (see FIGS. 5-8, 44 and 54 respectively of cloud page header 74) can instead provide geographic-territory and optional category or subject (GT&C/S) specific identifier(s) or ‘tag(s)’. With any of such auto-tagging approaches enabled, any CSAT Content Generated by an Identified CSAT-User 206 which is then saved, either manually or via an auto-save function, causes a GT&C/S Specific AUTO-TAGGING of CSAT Content 208 (associating one or more of the aforementioned identifiers with the data-file of the CSAT content) and stores the auto-tagged related content in Databased Records in System-Accessible Memory 212. Optionally, general CSAT Content 210 without auto-tagging, or with other forms of manual tagging can also be stored in the system's databased records. For example, a user employing user input means to cause a highlighting of a single text reference ‘tag’ within a CSAT content display area, or manually cause the highlighting of a plurality of different text references ‘tags’ by using the combination of a keyboard control-key and input device highlighting, can in either case then choose a menu selection such as ‘Store Tags’ CSAT menu function, which stores any manually selected (highlighted) ‘tag’ in System-Accessible Memory 212. Thereafter, a system Search for GT&C/S Auto-Tagged CSAT Content Record Matches 214 (or other manually tagged matches) can be conducted. Additionally or alternatively, system Search for CSAT Content Record Matches 216 (i.e., CSAT content without any tags) can be conducted as previously described. In either case, the search will result in Display/Representation of CSAT Content Search Results 218.

With respect to the auto-linking operation of the system, the auto-linking of portions of CSAT content which match advertiser/seller content, can also be implemented within a single user interface, web page or cloud page of the system, by an advertiser/seller advertising content parameters setup/configuring mode, wherein advertiser/seller advertising content ‘ASAC’ entered or selected among a plurality of advertising content, by an advertiser/seller as auto-linking criteria is stored in databased records in system-accessible memory 212 such that system cross-referencing of CSAT content and ASAC record matches, as previously described, results in the auto-linking of interactive revenue generating element(s) ‘IRGE(s)’ within CSAT content and the display of CSAT content with auto-Inked ASAC match(es). Optionally the operation or step of cross-referencing the CSAT and ASAC can result in the display of CSAT content without an ASAC match.

Data stored in Databased Records in System-Accessible Memory 212 can be augmented by in any one or more in a variety of methods or operations previously described for data acquisition and can be searched or referenced or cross-referenced by one or more computer executable instructions of the system.

In reference to FIG. 9, a generalized diagrammatical depiction of an embodiment of the system illustrates a plurality of co-located components (each being responsive to user input via a user input device) wherein: at least one Co-Located Software Application Tool ‘CSAT’ 134 equipped to specify a geographic-territory ‘Location’ (and optionally equipped to specify a category and/or subject) is employable by Co-Located Software Application Tool ‘CSAT’-User(s) 130, and is located (or locatable) proximate to one or more ADC element groupings 136, and/or one or more optional text-based listings 138, wherein the co-located plurality of components are viewable and accessible to users within a single standardized user interface screen 132 such as a single Web page or a single viewable display area of browser-equipped apparatus (the multi-component consolidating single user interface being represented as a dashed rectangle encompassing components 134, 136 and 138). For example, the CSAT is openable and/or operable next to, or near to, an ADC element grouping (136) and optional One or More Text-Based Listings 138, with the CSAT preferably having CSAT-Interface Automated or User-Selectable Geographic-Territory ‘Location’ and Optional Category and/or ‘Subject’ Entry Means 140 (e.g., similar to 110 of FIGS. 5 and 6). Each CSAT 134 is equipped with software routines for creating files having geographic-territory specificity and optionally also having category and/or subject specificity in accordance with criteria specified in Entry Means 140 and the software is equipped to associate and store any of such information in the form of a CSAT-User Generated Content DataFile: Storable, Searchable and Browser-Displayable in accordance with Entry Means ‘Location’ and Optional Category and/or ‘Subject’ Criteria 142, wherein such CSAT output includes Associated Data-File Identifiers. For example, data-file identifiers can include, but are not limited to one or more of the following: CSAT-User/Content-Generator Identifier, CSAT-Content ‘Location’ Identifier and Optional CSAT-Content Category and/or ‘Subject’ Identifier 144. Preferably, CSAT-User(s) 130 can selectively choose among setup, preferences or menu selectable or configurable options to have content they generate within one or more CSATs be made publicly accessible, e.g., for public or general disclosure, or be kept secure and private e.g., readable only by content-readers whom they selectively choose.

While the previous description discloses certain new types of identifiers which can be associated with CSAT data-files that can referenced by the system (for example geographic-territory specific identifiers), it is noted that any one or more in a variety of other data-file related data can optionally be incorporated and processed by the system, for example, including but not limited to: advertiser/seller data, company data, product-related data, service-related data, user/advertiser/buyer activity-related data, pricing-related data, transaction parameter-related data (preferably including any returns, refunds, rebates, coupons, redeemable points), commission-related data, payment-related data, chronological-related data (e.g., date/time specific data, and the like), advertiser/seller-related data, reader/buyer-related data, form of payment-related data, search usage related data, and the like.

While the previous descriptions have also disclosed user-generated content and/or advertiser-related content each being generated in any among a plurality of CSATs, it is noted that content can otherwise be generated and/or acquired in a manner which is storable, retrievable, displayable and searchable by the system. For example, the system can be equipped with one or more crawlers, or spiders, or bots, or any combination thereof, and the like, for gathering publicly accessible data and configuring it to be storable in the storage media of the system in a manner which is searchable, retrievable and displayable. Another means for the acquisition of substantial amounts of data can be through the integration of the present system into the services provided by a well-established search-engine company, whereby any of that company's data can be made accessible to the present system. Alternatively, webmasters can be contacted to provide data that they would like to be made accessible to the present system, and so forth. In each case, or in the combining of one or more data acquisition approaches, a substantial amount of data can be made accessible to the system and such data can be configured by software of the system so as to include any of the data-file and data-file identifier(s) or auto-tagging advantages previously described.

It is noted that automated types of geographic-territory ‘location’ and optional category and/or ‘subject’ entry means can include, as previously described, the system being equipped to automatically accept and process data from GPS means as ‘Location’ criteria (preferably being a user selectable or configurable option). Alternatively, the ‘Location’ criteria and optional category and/or ‘subject’ criteria can be user selectable, or user-configurable to automatically match any geographic-territory specific criteria previously entered by a user, such as data entered into geographic-territory specific text criteria field 44 and/or category or subject specific text criteria field 54 (see FIGS. 5 and 6), or according to one or more setup options, preferences or default locations configured by a user.

In each case, data-files created in a CSAT can be stored and retrieved having a geographic-territory or ‘Location’ specificity and optionally having a category and/or subject (GT&C/S) specificity, and any of such data-files and any of their respective IRGE(s) can optionally be made available, e.g., displayed at the discretion of an administrator, or owner, or operator of the system, in a datafile format viewable in a browser-equipped apparatus and preferably suitable for being accessed publicly on the internet via other search engines. For example, data-files and/or IRGE(s) or hyperlinked content selectively made publicly available can be provided having, or being associated with an ‘htm’ or ‘html’ file format and the like, or a general http://protocol, and data-files and/or IRGE(s) intended for private and secure use within the system (for example by logged-in and/or password-authenticated users, advertisers/sellers, or content-readers) can optionally be provided having, or being associated with a general https://protocol. The publicly accessible data-files of the system are thereby searchable by a wide range of search engines. The hyperlinked content generated by the system preferably remain associated with their respective Web pages such that searches conducted by other search engines result in content readers seeing the hyperlinks within the Web pages and can click on them.

Where it may be advantageous to provide the display of one or more clouds of the system at other Web sites or in programs equipped for viewing email (e.g., to further facilitate enhanced exposure probability and an increased awareness of the system's cloud content and any commissionable events and/or transactions deriving therefrom), at the discretion of an administrator, or owner, or operator of the system, the system's clouds can be provided in a transmittable datafile format or displayed by a transmittable cloud-displaying software plug-in or utility program which make one or more clouds viewable, and preferably make any ADC elements thereof interactive, at other Web sites, and optionally viewable and interactive within one or more formats that can be emailed. Preferably interactive ADC elements of such clouds and one or more offerings, propositions or transactions deriving therefrom, are GT&C/S specific as previously described, and optionally include the means to automatically switch a user, or for a user to selectively switch, from such a Web site (or email program) to the user interface of the present system as a result of one or more user interactions with any element of the externally displayed cloud(s), thus providing a cloud advertisement and commerce inter-operability between various or numerous Web sites or email programs and the Web site (or Web page, or cloud page) of the present system. The software plug-in or utility program is provided in a manner which is operable at other Web sites or in email programs and is equipped with software routines for accessing, in a secure manner, ADC elements stored in a memory accessible to the system, and for displaying the ADC elements proximate to one another in a cloud-like arrangement. The software plug-in or utility program can alternatively provide the displaying of a bitmapped representation of any cloud and one or more optional interactivities providing the aforementioned ADC element transactions and/or switching of a user from a Web site external to the system to the user interface of the present system. Any ADC element graphically depicted within the displayable bitmapped representation can optionally include an interactive placeholder (e.g., a transparent placeholder) which is equipped with one or more computer executable instructions responsive to user input from a user input device to provide one or more of the functions previously described in reference to ADC element interactivity.

Users, advertisers/sellers and content-readers of the system do not have to be concerned with the entry of location specific data or criteria entry once they have provided such information by any of the means previously described, and preferably such criteria ‘stamping’, ‘tagging’ or ‘auto-tagging’ occurs at a level which is in effect transparent to such users. For example, criteria or information pertaining to one or more locations, categories or subjects (or any combination thereof) can by one or more computer executable instructions be included in the source code of a any Web page of the system or in, or associated with, any data-file pertaining to any displayable location-specific or category/subject specific content or element(s). Similarly, when a CSAT user is saving a CSAT data-file, for example, by choosing a ‘Save As’ menu function of the CSAT which saves the data-file to a server or storage medium accessible to the system, any information specified in either the location and subject entry bar 110 of the CSAT, or in the 44 geographic-territory specific text criteria field 44 and optionally in the category or subject specific text criteria field 54 (FIGS. 5-8) can automatically be saved as a location specific (and optional category and/or subject specific) identifier with the data-file. Accordingly, whether such data is recorded at a source code level (e.g., in an .htm file) or as information associated with a CSAT data-file, it can be stored in an automated mode such that the user does not have to be concerned with seeing such file information or with manually entering it.

FIG. 10 is a generalized diagrammatical depiction of steps provided by computer executable instructions of the system in a preferred method of employing the system. In an upper portion of the figure, a single user interface ‘SUI’ display area 228 is represented as a dashed-line polygon encompassing steps 200 through 206 and steps 222 through 226 and 230 (steps taken with complementary, interoperable software components of the system that are co-locatable within a single user interface ‘SUI’, Web page or Web portal, and made accessible therein to users and/or advertisers/sellers). Steps 208 through 220 (shown outside of SUI display area 228), are each performed by computer executable instructions of the system in response to user and/or advertiser/seller input. FIG. 10 further illustrates the facility provided by the system in its consolidating of user and advertiser/seller content-generating procedures in a single user interface SUI, Web site, or Web portal, and the inter-relating and simultaneously displaying of content produced by those procedures so as to enhance the exposure probability and relevance of transaction-enabling elements also displayed to users.

The system provides computer executable instructions for the operating of and simultaneous displaying of different co-locatable software components and elements within the SUI or single viewable portion of display area 228. For example, one or more co-locatable software application tools ‘CSAT(s)’ (e.g., such as a CSAT referred to in step 200) are simultaneously displayable in the SUI display area 228 along with one or more displaying of cloud-like grouping(s) of ADC elements 224 and/or displaying of text-based listing(s) of ADC elements 226. Preferably the computer executable instructions also provide for the simultaneous displaying of one or more interactive revenue-generating elements ‘IRGE(s)’ in CSAT(s) 222.

In a preferred method approach, a configuring of ADC element parameters by a advertiser/seller occurs via ADC element configuring step 204 (e.g., in a search criteria ‘Setup’, ‘Options’ or ‘Preferences’ mode, or the like). For example, an advertiser/seller can choose options as to how transaction enabling ADC elements representing one or more offerings or propositions appear in any one or more of the following: displaying of cloud-like grouping(s) of ADC elements 224; displaying of text-based listing(s) of ADC elements 226; displaying of one or more IRGE(s) in CSAT(s) 222. In the step of an advertiser/seller generating of criteria for displaying transaction-enabled ADC element(s) and/or IRGE(s) 206, the advertiser and/or seller can enter criteria or select from a selection of such criteria (e.g., in an advertiser and/or seller criteria configuring CSAT or Options, Preferences or Menu component of the system). The entered and/or selected criteria are storable and accessible to the system. Preferably each of the criteria entered and/or selected in step 206 is subject to a categorizing and/or indexing of advertiser/seller criteria 214 and, for each indexing of criteria: creating of a datafile and GT&C/S specific identifier(s) associated with an advertiser/seller 216 (and optionally associated with one or more propositions or offerings of the advertiser/seller). Similarly, content entered (and/or imported) into a CSAT (via step 200) is preferably subject to a categorizing and/or indexing of user-generated CSAT content 208 and, for each indexing of CSAT content: creating of a CSAT datafile and GT&C/S specific identifier(s) preferably associated with a user and CSAT-type 210. The content or data pertaining to any of steps 206, 214 and 216, and any of steps 200, 208 and 210, are storable in a databasing of data, data-files and associated identifiers 212 step. Thus, data, data-files and data-file identifiers are associated with criteria entered or selected by an advertiser and/or seller, and separately associated with user-generated (and/or imported) CSAT content, either optionally also having a geographic-territory and/or category or subject (GT&C/S) specificity.

Cross-referencing of the CSAT-user generated content and advertiser/seller generated content provides a number of complementary, interoperable functionalities between simultaneously displayable, co-locatable software components in the SUI (or Web portal, Web page or Web site) of the system. To illustrate some of these functionalities, following the steps leading up to and including the databasing of data (step 212), the following five examples (although not exhaustive) are provided:

In a first example, a search is conducted (following the generating and databasing of advertiser/seller content) by a user employing a displayable search user interface component of the system for searching among the user and advertiser/seller databased data of the system. When a search of one or more search criteria 230 is conducted by a user, preferably within a SUI, or single Web page, simultaneously displaying one or more other co-locatable components of the system, the user configures, enters or selects one or more search criteria for the search (e.g., as previously described in reference to FIGS. 1 through 4). In response to the user initiating the search process, computer executable instructions provide a cross-referencing of CSAT-user content and advertiser/seller criteria 218 which searches among databased data generated within the SUI, or single Web site of the system, to find matches between user-generated content and advertiser/seller content. When matches are found the software includes routines which provide a displaying of content/criteria-matched transaction-enabled ADC elements 220 (preferably also GT&C/S-specific) in one or more, or two or more of the system's simultaneously displayable software components (e.g., viewable within a CSAT, and also within a cloud-like grouping of ADC elements and/or text-based listing). For example, an advertiser/seller is interested in having ‘skiing’ related subject matter as advertising-related, proposition-related and/or offering-related criteria, which will subsequently be referenced during searches conducted by users (or automatically associated with CSAT user-generated content, or IRGEs thereof). To enhance the exposure probability and an increased user awareness of one or more offerings or propositions pertaining to skiing products and services provided by his company, he employs the SUI or single Web site accessible advertising-configuring steps of the system to enter and/or select among category and/or subject (‘C/S’) criteria relevant to his offerings as search criteria (subsequently searchable by a user) such as any one or more of the following: “skis”, “ski poles”, “parkas”, “gloves”, “boots”, “snow shoes”, “lift tickets”, “resort accommodations”, “travel arrangements”, and includes one or more optional geographic-territory (‘GT’) criteria such as “Aspen, Colo.”. A subsequent search conducted by a user which includes one or more of the same (C/S, GT or GT&C/S) criteria, causes a cross-referencing of CSAT-user content and advertiser/seller criteria 218 and a displaying of criteria-matched transaction-enabled ADC elements 220 in two or more of the system's simultaneously displayable software components, for example in any two or more of the following: cloud-like grouping(s), text-based listing(s) and IRGE(s) or other content within CSAT(s). While the foregoing description describes one or more displayings of commerce-enabled elements in the SUI of the system, it is noted that the search results, in response to the user's search criteria, preferably also displays CSAT-displayable content (e.g., GT&C/S CSAT-content) which is also of interest to the user.

In a second example, a search is conducted (following the generating and databasing of advertiser/seller content) by a user employing a search user interface component of the system, or a search element or function included in a CSAT. In response to the search computer executable instructions provide a cross-referencing of CSAT-user and advertiser/seller generated content 218 and a displaying of criteria-matched transaction-enabled ADC elements 220 as IRGE(s) within one or more CSAT(s).

Similarly, in a third example, an interoperability and complementary relationship between two types of content-generating, co-locatable software components is provided, wherein, following the generating and databasing of advertiser/seller content, a user generates content within a CSAT which is automatically or selectively storable. In response to the input and/or storing of CSAT content, computer executable instructions provide a cross-referencing of CSAT-user and advertiser/seller generated content 218 and a displaying of criteria-matched GT&C/S-specific, transaction-enabled ADC elements and/or IRGE(s) in two or more of the system's simultaneously displayable software components, for example in any one or more of the following: cloud-like grouping(s), text-based listing(s) and IRGE(s) within CSAT(s). Thus, in this third example, a search is not required for the displaying of ADC elements or IRGE(s).

In a fourth example, a user can be provided an option to select a ‘Search for Advertiser/Seller Criteria’ from a menu or software element choice of a CSAT (SUI or Web page) and cause either a hi-lighting and/or hyperlinking of any matched text ‘criteria’ within the user's CSAT content, any of which, at the user's choosing, can selectively become a commissionable-enabled IRGE displayed within the CSAT which can be saved with the CSAT content (e.g., automatically, or by means of a common file managing function such as ‘Save As’).

In a fifth example of the system's interoperable, complementary functionalities, user interface and/or CSAT computer executable instructions of the system provide for an auto-tagging of user-entered and/or selectable geographic-territory and category and/or subject ‘GT&C/S’ specific criteria. For example, a user employing a CSAT (or other co-locatable component) of the system can enter or select “Aspen Colo.” in a ‘geographic-territory’ specific auto-tagging text field provided by the CSAT and can enter or select “Skiing” as a ‘Favorite’ or as an auto-tagging text field entry for a category specific and/or subject specific criteria relating to the CSAT content he is creating, adding to, or editing. Preferably auto-tagging text field criteria are subject to the aforementioned data conditioning steps of 208 and 210 or the like, and made storable in, and accessible from, a databasing of data, data-files and associated identifiers 212. Thus, any one or more of the displayings of steps 222, 224 and 226 can occur as a result of the aforementioned CSAT (or other UI) auto-tagging steps and the databased auto-tagged CSAT content being cross-referenced to previously entered and/or selected advertiser and/or seller generated criteria or content.

FIG. 10 further depicts an arrangement wherein commissionable events, transactable within a single standardized user interface or single Web site of the system (and optionally within Web sites or Web pages external to the user interface), are generated by the combination of (i) at least one CSAT being equipped with file-managing software for storing the input of, and subsequently displaying, CSAT-user generated content, and (ii) the system providing advertising-managing software such as an advertising CSAT or utility program (or user interface window or pane) for accepting and storing advertiser/seller input or criteria such as text-entry of one or more words, word phrase(s) or text-string(s), text ads, display ads, as system-searchable databased content (optionally also including graphic, audio or video elements storable and retrievable in a digital file format). Such databased content is subsequently searched or referenced during CSAT-related searches conducted by users or content readers (or as previously described), and when content is found matching one or more search criteria entered by a user or content reader, it is then displayed as an interactive element within the body of the CSAT-user generated content (e.g., as a hyperlinked element or other element providing user interactivity). In the event that a plurality or multiplicity of ‘hits’ are found matching search criteria entered by a content reader, the hits can be displayed in the single user interface or Web page as a text-based listing (e.g., co-located next to or near to one or more ADC element groupings, or within the interface of a CSAT) preferably displayed so that any match or text excerpt within the listing can be clicked on (or double-clicked) to cause an expanded display view of related text and/or non-text elements. Preferably any previously entered advertiser/seller content found matching (or similar to) one or more search criteria entered by the content reader, is also displayed as an interactive revenue-generating element (IRGE) within the body of the CSAT-user generated content. For example, a plurality of advertisers/sellers each separately having employed a CSAT or other utility program as an initial IRGE-configuring means, can enter or select “Chicago” as a geographic-territory identifier and can enter or select “pizza” as a category and/or subject identifier, as part of the advertiser/seller criteria searchable during searches subsequently conducted by content readers. When such steps are taken by a plurality of advertisers/sellers within an advertiser/seller IRGE criteria entry, setup or configuring user interface screen, window or pane, the “Chicago/Pizza” criteria entered and saved provides storable search data whereby a multiple listing of the “Chicago/Pizza” criteria hits relevant to or congruent with a user's locale and subject of interest will be displayed, preferably with each hit in an excerpt format, from among which a content reader can selectively choose any to be expanded in size or fully displayed.

Preferably the system provides software means in an advertiser/seller IRGE criteria entry or setup mode accessible within a single user interface screen, Web page, window or pane, wherein criteria entry can include input and/or the configuring of parameters pertaining to one or more IRGE types, such as hyperlinked or content-reader interactive elements selected from the group consisting of one or more text, graphic, photographic, audio, video or audio/video digital media files, and the like. Following a configuring or selection of an IRGE type the advertiser and/or seller can then associate and/or configure one or more propositions or offerings and/or one or more deliverables for any IRGE, optionally including one or more configurable and/or selectable options for completing an arrangement to make one or more payments for any transaction pertaining thereto. Thus the system provides the means whereby a plurality of registered advertisers/sellers can configure their own advertisements displayable in a single graphical user interface ‘GUI’ within a cloud-like grouping of transaction-enabled interactive ADC elements (preferably being GT&C/S specific) and optionally displayable as an IRGE format in one or more other co-locatable complementary components of the system, wherein such elements are accessible to registered users in a manner wherein an arrangement for completing one or more payments for a transaction pertaining to any of such interactive elements is provided.

Such IRGE configuring related advertiser/seller input is storable and retrievable by data-managing software of the system in a data-file format which preferably includes one or more associated identifiers, for example, in a manner similar to any of those previously described. For example, IRGE related identifier(s) can include data and/or information pertaining to and/or identifying: the advertiser/seller, a geographic-territory, a category and/or subject, one or more parameters of a proposition or offering or any transaction and/or buyer related data pertaining thereto, and the like.

Preferably, the entering and storing of such input provides a data-file which is identifiable with a given location, or category and/or subject (or any combination thereof) that can be cross-referenced or otherwise referenced or searched by computer executable instructions of the system. For example, a content reader employing the system's search function(s) to search for criteria matching CSAT-user generated content (such as a matching text word, words or word string, or data pertaining to a digital media file) causes each match within stored CSAT-user generated content to (i) be displayed in a listing of openable CSAT datafiles, or (ii) when one or more search criteria also match criteria previously entered by one or more advertisers/sellers each match within the CSAT content of an openable CSAT data-file is displayed as an Interactive Revenue-Generating Element ‘IRGE’. For example, an IRGE comprising text can be displayed having the appearance of a typical hyperlinked word or word phrase.

For example, subsequent to the system accepting and storing the text input of Storable Advertisers/Sellers Entered Criteria Specifying One or More Words or Word Phrases Searchable Within CSAT-User Generated Content Data-Files, Each Criteria Having a Searchable Advertiser/Seller Identifier 146 (FIG. 9), a Reader(s) Search of CSAT-User Generated Content (in accordance with search criteria) 148 can be conducted at any time.

Accordingly, in a search conductible within a single standardized user interface, component page 64, or single Web site of the system, wherein one or more commission-enabled elements such as IRGEs are displayable, a search/referencing of two data-file types occurs in accordance with a searcher's search criteria, wherein: (1) data-files pertaining to CSAT-user generated content are cross-referenced with (2) data-files pertaining to advertiser/seller entered criteria, so as to display any criterion-match found between the two data-file types as an IRGE, and CSAT-user generated content matching the content reader's search criteria and having any displayable IRGE(s) is made accessible to the reader and/or presented within a software user interface component of the standardized user interface or single Web site of the system. Multiple matches of, or ‘hits’ matching, a content reader's search criteria can optionally be presented in one or more co-located text-based listings 138, for example, in an abbreviated format such as an excerpt, or as a partially displayed or reduced-sized representation, or as a listing of data-file hits, or optionally displayed in one or more co-located ADC element groupings 136, whereby user interaction via user input means with any of the same causes the ‘hit’ to be displayed in a manner wherein its full content can be viewed.

Whether or not any commission-enabled content is made displayable following a reader conducted search (for example in the case where such a feature/option can selectively be turned on or off by a reader or user), the two data-file types and any one or more of the associated data-file identifiers and advertiser/seller identifiers are storable and searchable among the databased data of the system in accordance with any of the methods or means previously described. Subsequent to a Browser Display of Searched/Matched CSAT-User Generated Content—and Optional One or More Reader Interactive Revenue-Generating Element(s) 150 (FIG. 9), a content reader's interaction with one or more IRGE(s) as commissionable event(s) can be completed such as Reader(s) Input Means Interactivity with One or More Interactive Revenue-Generating Element(s) ‘IRGE’ within CSAT-User Generated Content, as Commissionable Event(s) 152. Preferably, commissionable events are selected from any one or more of the group consisting of completed, schedulable or otherwise pending purchase(s), rental(s), lease(s), one or more transferrings to another Web site or Web page, and/or as a result of other user-interactivity IRGE event such as one or more click-on events, rollover events, voice-activated commands, and the like. When one or more IRGEs are displayed within CSAT-user generated content matching a content reader's search criteria, a content reader interaction with a IRGE causes a Communication to User-Interactivity Monitoring and Reporting Means, of Data Pertaining to Any Completed or Schedulable Purchase, or Rental, or Lease, and/or Other Reader-Interactivity Event 156, wherein, such communication includes the transmission of data associated with any one or more of the previously described data-file identifiers to the software-enabled reader-interactivity monitoring and reporting means of the system, whereby, such data-file identifier related data is employable by the system for automatically Making an Arrangement for Completing a Commission Due From Any Advertiser/Seller to the CSAT-User/Content-Generator Based on Reader(s) Input Means Interactivity with ‘IRGE(s)’ 158. For example, a content reader interactive event can simply be the reader employing a user input device to click on an IRGE, or a clicking on or a cursor-rollover of an IRGE can result in the display of a more comprehensive software user interface, window or pane equipped to accept a content reader's text entries and/or interactions preferably including one or more selectable interface elements (e.g., check boxes, radio buttons, and the like) whereby means or options are provided for completing or scheduling a transaction and/or payment for one or more purchase(s), rental(s), or lease(s) for any deliverable(s) type such as those previously described.

In response to a user's or reader's IRGE or other interactive element event(s) software of the system causes a communication to the system which includes the transmission of data associated with and/or pertaining to any one or more of the previously described data-files (such as one or more identifiers). When data is being sent from one or more Web sites external to a single user interface or single Web site embodiment of the invention, the content reader interactivity monitoring and reporting software of the system preferably also include the system receiving data such as any one or more of the following: user ID, user preferences, shopping or shopping-cart related information, shopping-in-progress information, current and/or historical shopping cart information, user names, passwords, Web page visitation related information, browsing patterns and preferences, and the like. The transferring of a user from within the user interface of the present system to one or more Web sites external to the interface can optionally or additionally include the system making an association of a cookie, or cookie-like data, with such transferring(s) to sustain the continuity of any transaction between that user, the present system and any Web site from which a transaction can be arranged.

Accordingly, the system is equipped in response to a reader's interaction with an IRGE to cause a communication of one or more types of data, such as data pertaining to the identity of the user who originally generated the CSAT content in which any interactive IRGE appears, and/or data pertaining to the identity of the advertiser/seller who entered the criteria found matching or associated with the CSAT content that was displayed as an IRGE, and optionally may also include one or more of the following: data pertaining to the event type(s), the category and/or subject of the transaction(s), the transaction(s) amount(s), deliverable(s) type, data pertaining to the identity of the reader who caused one or more IRGE interactions, data pertaining to a content reader referring CSAT-generated content or one or more IRGEs to one or more other content readers, IRGE offerings, or IRGE propositions to one or more other content readers, data pertaining to any coupons, bonuses or points or usage or redemptions thereof, and the like.

The reader-interactivity monitoring and reporting means include one or more computer executable software routines for receiving the communicated data and storing it in a format readable by data-file managing software of the system thereby building a database of commissionable-event records to provide an accounting of, and make an arrangement for the payment of, any commissions due from an advertiser/seller to a CSAT-user content generator. Thus, reader-interactivity monitoring and reporting means are provided whereby, (in addition to the making of arrangements for any payments, credits or bonus points due), notices, or reports, or records, or statistics, or the like, or any combination thereof, can automatically be provided to, or displayed for advertisers/sellers and CSAT-user content generators. Preferably computer executable instructions of the system cause such information to be sent in the form of an email communication, or accessed and read by the system and displayed within a co-located software application tool ‘CSAT’ type selectable by a registered and/or logged-in advertiser/seller or CSAT-user content generator or CSAT content reader, or can selectively access and view such information and display it elsewhere within the single standardized user interface or single Web site of the system.

The system provides secure transaction managing means, for example, by incorporating any one or more of such means currently in use in managing secure transactions over the internet, and preferably includes transaction means displayable within a single user interface or Web site of the system equipped to accept and process one or more payments made by, or to: users, content readers, content generators, advertiser/sellers, and the like, for example of such using a credit card, debit card, check, money order, traveler's check, gift card, eWallet, PayPal®, bonus or purchase points, coupons, redeemable prizes, giveaways, and the like.

Following the making of one or more payments, for example made by a content reader/buyer for one or more deliverables ordered as a result of the content reader's interaction with an IRGE, and optionally following any waiting period in which the ordered product may be returned, the system forwards a commission payment to the registered CSAT-user who generated the content in which the IRGE appeared using secure transaction managing means or sends the commission by mail or by another carrier. The system can take partial payments or full payment for one or more deliverables ordered by a content reader, and after deducting any commissions and/or other processing fee(s) or intermediary charge(s) for the transaction, transmit or otherwise send the balance of the payment to one or more specified, predetermined or selectable financial institutions or accounts of a registered advertiser/seller of the deliverable(s) using secure transaction managing means of the system or send any payment (for example in the form of a check) by mail or other carrier.

One or more commissions can be provided to the CSAT-user who generated the content, or be transferred to another person or entity specified by the registered CSAT-user. For example, commissions, or any specified portion thereof, can automatically be allocated and transferred to a charity or non-profit organization, and the like, of the user's choosing.

When IRGE(s) or other hyperlinked content are commissionable, and are setup or configured (e.g., by an advertiser/seller) to be responsive to user interactivity to cause a transferring of a content reader to one or more Web pages external to a standardized interface of the system, computer executable instructions of the system send browser interactivity monitoring data (such as a cookie) to data storing means of the browser-equipped apparatus of the content reader which communicates interactivity such as clickstream data, or transaction related and/or commission related data pertaining to one or more advertiser/seller propositions or offerings to the present system. For example, data reporting on a commissionable event or transaction that has been initiated or has transpired can be sent to the present system from the Web page or Web site having such user interactivity.

Preferably computer executable instructions of the system monitor and employ GT&C/S-specific clickstream (or other user input means) history of a user's input and/or interactions, such as interactivity with IRGEs, ADC elements, hyperlinked content, transaction-related user input events or the like. Optionally such GT&C/S-specific data can be enhanced and/or further customized by the computer executable instructions also monitoring and keeping records of a user's most-frequent or repeated CSAT-generated content subject matter, including any of such matter that matches or is similar to any clickstream-related record and/or any advertising criteria entered by advertisers/sellers. Any of such data can subsequently be accessed or referenced by computer executable instructions to generate highly specific/personalized ADC elements within a cloud such as a User Profile Cloud or User Activity History Cloud.

Optionally, one or more software routines of the system also include monitoring clickstream record data of each user's visits to and click (or other user input device) activities at external Web sites and/or Web pages, particularly Web sites associated with and/or having registered to use one or more features of the present system. For example, registered external Web site users can be required to employ one or more cookies which communicate user activity data back to the system and computer executable instructions of the system then employs any of such data in the generating of one or more ADC elements of a User Profile or User Activity-History Cloud.

Computer executable instructions of the system can optionally provide an interactive element (such as a single commission-enabled IRGE or other hyperlinked content) setup or configuring procedure for making an interactive element a multi-linked element which, in response to user input means input displays more than one linked advertisers/sellers, or transaction-enabled and/or commission-enabled offerings or propositions thereof, for example being displayable within a CSAT, a pop-up window or pane, a text-based listing (wherein a plurality of links are displayed within a listing), or cloud, or other user interface element or component (see FIGS. 5-8).

When a CSAT-user is generating CSAT content, such as entering one or more typed words, and data accessing and matching-word or matching text-string searching software of the system determines a match, or a similarity to, text or digital content previously entered, configured, or selected by one or more advertisers, preferably the software can automatically display (to the CSAT-user) a user interface arrangement for associating and representing each match found with one or more offerings or propositions of a respective advertiser/seller. For example, a registered CSAT-user wishing to participate in the ‘Benefits Program’ of the system (i.e., in commissionable events) generates CSAT content concerning his home-office computer and states that he's interested in finding a good LCD Screen. Six advertisers having businesses that make and sell LCD Screens have previously each entered ‘LCD Monitor’ and/or ‘LCD Screen’ as some of their chosen advertising criteria, accordingly, as the CSAT-user types and/or saves any words matching (or similar/related to) that criteria, the software of the system determines there are six advertiser/seller matches (see FIGS. 7 and 8). Preferably, the content generator can selectively choose one or more, or all, of the advertisers/sellers to be associated with his newly entered content. For example, the content generator can be provided the option to choose among one or more, or a range of, advertisers/sellers such as 1-3, 1-9, or unlimited (e.g., via a menu selection or preferences setting) or may optionally toggle on or off the Benefits Program option.

When CSAT content is subsequently read by a content reader, for example by means of a CSAT made for browsing among, opening and displaying CSAT content data-files (or the content reader reads such content when made available external to the user interface of the system, in email content, or blogs, forums or other text readable at a Web site external to the system's Web site) CSAT content matching one or more criteria previously configured or entered by advertiser(s)/seller(s) is displayed as an interactive element, such as an IRGE or hyperlinked content, and may optionally include adjacent thereto an indicator such as a small number which indicates how many advertisers/sellers or displayable propositions are associated with the CSAT interactive element. When a content reader employs an input device to interact with the user generated ‘LCD Screen’ content, such interactivity causes the display of one or more selectable propositions or offerings associated with each advertiser/seller having previously been matched to the ‘LCD Screen’ content/criteria (i.e., the six sellers of LCD Screens).

Accordingly, a single word, or single group of words generated by a CSAT user and found by the system to be matching previously selected or specified criteria of one or more advertisers/sellers, can result in an automatic hyperlinking of an element or IRGE displayable in a CSAT (or in emails, or content provided in a format viewable at external Web sites, and the like), thereby providing CSAT or multi-component inter-operability such that another CSAT employed by a content reader provides one or more commissionable events viewable to that reader within a single Web site, or Web page, or single user interface of the present system. Thus, the clicking on a single displayed hyperlinked word or group of words within CSAT generated content can cause a first commissionable event and result in the display of a plurality of links or propositions or offerings of each advertiser/seller, and each proposition can also provide commissionable interactivity such as ‘click-ons’, rollovers, text-entry, and the like, or an interactive user interface transaction arrangement whereby one or more payments for any displayed proposition or offering can be arranged (whether displayed within the user interface of the system or within a Web site or email program external thereto).

Accordingly, a multi-transaction enabled and/or multi-commission enabled hyperlink or interactive element arrangement is provided within a single Web page or user interface of the present system. The arrangement accommodates any one or more of the following: the inputting or configuring of advertiser/seller advertising criteria input; the configuring and subsequent display of one or more links and/or propositions or offerings pertaining thereto; the accepting of one or more specified time-period payments for such configurings; the storing of data-file information pertaining thereto in a manner wherein searches of advertiser/seller criteria are automatically conducted by the system in response to user input and/or storing of data in a CSAT; the displaying of matching criteria in a CSAT and displays matching criteria to content readers in an interactive and inter-operable manner in at least one other CSAT such as a CSAT employed by a content reader, or displayed in a co-located text-based listing, or displayed as one or more elements within a co-located ADC element cloud, or displayed in any combination of such components. Thus, the multi-transaction enabled and/or multi-commission enabled interactive element or link is responsive to content reader interactivity with an initial single interactive element to display of a plurality of interactive elements each of which can be configured to: produce a commissionable event and/or transaction; provide commissionable-event data associated with each interactive element such that a record of content reader interactivity with any advertiser/seller link, proposition or offering, or transaction pertaining thereto, is automatically communicated to the system; calculate according to a predetermined configurable arrangement, an allocation of any commission, transaction/intermediary fee or revenue, credit, bonus points, and the like, due as a result of content reader interactivity and credits what is due to a CSAT content generator; and, an arrangement for paying or crediting of any revenue due to (or from) an advertiser/seller.

Optionally, content reader interactivity with any of such interactive elements, for example within the user interface of a CSAT, can cause the display of advertiser/seller hyperlinked content, or the display of an interactive digital media representation, or display of one or more propositions or offerings, or the displaying of an arrangement for completing one or more payments pertaining thereto, wherein such displaying occurs within one or more co-located text-based listings or co-located clouds, thereby providing increased inter-operability between the co-located components, including doing so within a single Web site, or Web page, or single user interface of the present system. Preferably, content readers are also given the option to choose how many advertiser/seller links, or propositions, or offerings, are displayed in response to a user input device interaction, for example, one or more, or a range of, advertisers/sellers such as 1-3, 1-9, or unlimited (e.g., via a menu selection or preferences setting) or may optionally toggle on or off the option.

Thus, CSAT-users, or CSAT-content generators and/or content readers can be presented with one or more multi-transaction enabled links and/or multi-commission enabled links providing multiple choices and can choose to click on any of the displayed links. Optionally, any of such multi-links can alternatively or additionally be displayed in a listing, CSAT or cloud or combination thereof. For example, an advertising hyperlinked phrase “Roman Holiday” can appear being displayed within CSAT-user generated content (e.g. within the standardized user interface or at a Web site external to the system) wherein a CSAT content generator has written, “I saw the movie Roman Holiday yesterday and thought it was great”, and wherein a plurality of advertisers have each previously entered “Roman Holiday” (or “Rome Vacation”) as preferred and/or related searchable criteria. Subsequently, when a content reader conducts a search using the same, similar or related criteria and reads the displayed content having the hyperlinked phrase, and then places his cursor over the phrase, a popup window or pane can automatically be displayed having a plurality of selectable links, for example: a first link reading “Roman Holiday—Buy DVD at Amazon”, and a second link reading “Roman Holiday—Travel Special Orbitiz” and so forth. When the content reader clicks on one of the multiple links he or she is either present with a proposition within the user interface (or webpage) of the system or alternatively can be transferred to a Web page associated with the link, or to a page, window or pane user interface element of the present system, and in either case is presented with an arrangement whereby payment for one or more deliverables can be completed, according to any of the methods previously described, and data pertaining to any commissionable event or transaction can automatically be communicated to the system as previously described. Alternatively, if a content reader clicks such a hyperlinked phrase or IRGE instead of employing a rollover and clicking one among a multiple choice of links, the system can be equipped to automatically choose which advertiser/seller to link to, or transfer the content reader to, as a result of the click. For example, one or more software routines can cause: a random choice; sequencing through each link-choice with each new click; a pre-determined choosing of an advertiser/seller having paid a higher fee to be prioritized during a click, and so forth. Alternatively, one or more software routines can be responsive to a content reader placing his or her cursor over a linked phrase, or IRGE, to cause the display of a related ADC element grouping or ‘cloud’ over, or near to, the phrase, and the content reader can choose among the suggestive and/or associative related content (ADC elements) according to any of the methods previously described.

Thus, in the aforementioned description pertaining to FIG. 7 one or more among a variety of commissionable events are practicable or transactable within a single standardized user interface or single Web site of the system, and external intermediary commission-managing Web sites and the considerable fees typically charged by such intermediaries, and the inconvenience of having to leave one Web site or Web page to setup or configure (and pay for) commissionable events at an intermediary commission-managing Web site, are not required.

While the description pertaining to FIG. 7 describes a self-contained or seamless approach to the transacting of commissionable events wherein CSAT-user generated content can automatically be matched to advertiser/seller entered content and be displayed as one or more IRGE(s) within a single standardized user interface or single Web site of the system (thus not requiring content readers to leave the Web site/system), it is noted that optionally, one or more interactive elements such as hyperlinks can be provided within CSAT-user generated content whereby content readers can be transferred to non-system Web sites or Web pages equipped with one or more IRGE(s) where previously described types of transactions can alternatively be completed. For example, wherein Web sites owned or operated by participant merchants, service or activity providers, or advertiser/sellers, registered with the system agree to provide a configuring of IRGEs such that the transmission of data pertaining to previously described data-file identifiers is sent to the system in response to reader interaction with any IRGE displayable within their Web site or associated with their Web site(s).

For example, a content reader's input means interactivity with an IRGE displayed within the present system can result in Transferring a Reader in Response to Input Means Interactivity, to Web site(s) or Web page(s) Wherein Additional Reader Input Means Interactivity with ‘IRGE(s)’ Occur 154 of FIG. 9 (rectangle 154 is represented as being outside of a standardized user interface or single Web site of the present system by having a border including parallel phantom lines). Following the content reader being transferred, user input means interaction with a correctly configured IRGE at any of such Web sites or Web pages causes the communication of one or more previously described data-file identifiers to be sent to the reader interactivity monitoring and reporting means of the system. Accordingly, any IRGE interactivity available within a single standardized user interface or single Web site of the system can alternatively occur at such other Web sites or Web pages (or within any user interface elements, windows, or panes thereof).

It is noted that while a seamlessly integrated approach to configuring and providing transactions and commissionable events has been described which is practicable or transactable within a single standardized user interface or single Web site of the system, it is also noted that one or more software routines of the system can alternatively be provided, whereby, commissionable events of the status quo type(s) made through a third-party ‘Affiliate-like’ or other intermediary-based arrangement is also possible and accommodated by the present system. For example, wherein a commissionable event occurring at a Web site outside of the single standardized user interface or single Web site of the present system causes information pertaining to an interactive commission generating element (e.g., a hyperlinked text element) having at least some the previously described data-file identifiers (or like information), or cookie information, to be communicated to the reader interactivity monitoring and reporting means of the system.

Any of the previously described data, data-files, preferences, options, setup data, parameters, configurations and the like, are databased and/or indexed, are storable, maintained, editable and updateable in one or more databases accessible to and under the control of one or more data-managing software routines of the system (e.g., databases on one or more Web site servers or proxy servers, and the like). Such data may include but is not limited to: data pertaining to search criteria, searches, cloud searches, cloud pages, one or more clouds within cloud pages, ADC element groupings (including Search-Clouds, User-Clouds, Favorites, and the like). The system storable and retrievable data, whether generated and stored for public use or for private use, can also include information pertaining to, but not limited to: Web site administrator-configurations, user-configurations, preferences or options, log-ins, and/or passwords, advertiser/seller-configurations preferences or options, log-ins, and/or passwords, content reader information, preferences or options, log-ins, and/or passwords, CSAT-user information, CSAT-user content, CSAT-user content generator information, data-files, data-file associated identifiers, multi-transaction enabled link(s) or IRGE(s), multi-commissionable enabled link(s) or IRGE(s), commissionable events, commissions, clickstream data, user interaction data, affiliates, affiliate-related codes, transaction data, payment data, cookie data, the recording, tracking and reporting of user, advertiser and commissionable events, the recording, tracking and reporting of transaction events, user options, user interaction parameters, search configurations, location specific data, category specific data, subject specific data, geographic-territory data, longitude and latitude coordinates data, setup options, preferences, listings, playlists, galleries, hyperlinks, hyperlink-associated and/or other user interface elements providing offerings or propositions or deliverables or text descriptions including means for purchasing one or more ADC element advertisement, or for purchasing, renting or leasing one or more deliverables and the like; and user-configurings and/or preferences pertaining to one or more cloud page(s), or software application Tool(s), or search Default(s), or Favorite(s), or bookmark(s) and/or visitation history records, and the like, or any combination thereof.

As was previously described in the background of the invention section, it is an object of the present system to provide a new type of advertising arrangement wherein an advertising client (of a registered advertiser of the present system) can be charged and pay for advertising in relation to timed durations during which the client's advertising has been made viewable to one or more registered users of the present system. For example, when an ad-exposure-duration monitoring and reporting mode of the present system is optionally employed, and when one or more displayable advertising-related files are accessed by the system and displayed by browser equipped apparatus in a form which is made viewable to one or more users, the ad-exposure-duration computer executable instructions provide an (a) initiating of a timer function which records when the stored advertising content was accessed and displayed in a browser-application window which also has ‘focus’ (i.e., a top-most window not obscured under one or more other windows) as a ‘Start Display Time,’ and (b) a timer function for recording and reporting of how long the advertising content is displayed in a viewable condition, by providing periodic and regular sampling (such as one or more samplings per second) for monitoring and reporting how long the same browser-application window remains in focus. Preferably the ad-exposure-duration monitoring and reporting is provided for advertising content known or predetermined to be viewable within a certain scroll-range of a browser-application window displayed at a screen-display resolution which is known or which can be determined by the system. Thus, if an in-focus browser-application window is scrolled beyond that scroll-range, the advertising content ad-exposure-duration reporting can be ceased for the time in which the advertising content is scrolled out of viewable range, and can be resumed if and when the same content is brought back into view (within the viewable scroll-range). The cumulative exposure time of ‘in-focus’ advertising content is summed to determine a ‘Total Display Time’ which is then stored in as storable data format as reportable ad-exposure-duration data of the system. Preferably such data is identifiable with each registered user to whom the content was made viewable (and/or their user-profile, system-usage history, and the like). For example, any one or more of the co-locatable components of the system equipped for displaying advertising content e.g., within cloud-like groupings, text-based listings, or CSAT(s) (or any combination thereof) can include a data-file identifier which associates the component(s) with the identity of a registered user, such that advertising content, when displayed in any of the system's components is automatically identified with that registered user. Preferably the displayed and viewable advertising content is also identifiable with the advertiser who generated, selected and/or configured it and includes data-file identifier information such that a relationship between one or more users to whom advertising content was made viewable and the advertiser(s) who provided the content is also known and reportable. If a plurality of exposures is repeated with the same advertising content (including being made viewable to a plurality or a multiplicity of different users) those exposures can be summed to provide a combined ‘Total Display Time’ which is then reportable to advertisers and/or to the advertisers' clients.

To reduce or prevent inaccuracies in advertising content exposure-time reportings, for example, to filter out or reduce advertising exposures which are merely displayed for sustained periods while no user interactions occur, the ad-exposure-duration computer executable instructions preferably provide a monitoring of typical forms of user inputs made within a browser-application window over one or more predictable and reasonable timeframes. False ad-exposure-duration measurements can be eliminated or substantially reduced (e.g., from Web pages being opened but hidden dormantly under one or more layers of other opened apps or Web pages) by requiring a minimum user interactivity/input threshold (e.g., per minute) in the in-focus URL, Web page or user interface, in order for a recorded duration to be considered valid. For example, the system can also provide computer executable instructions for monitoring normal-use or typical-use inputs commonly made with a user input device within an ‘in-focus’ browser-application window, such as, but not limited to: up or down scrolling of a window, clicking on one or more viewable interactive elements, clicking on, maximizing, sizing or opening a browser-application window such that it is brought into focus, and the like, made within a reasonable or predictable timeframe or time-duration threshold. If one or more pre-determined, reasonable thresholds of user inactivity are met or exceeded, then the system no longer records and/or tallies an ad-exposure-duration during such period(s). Similarly, if one or more pre-determined, reasonable thresholds of user activity are met, then the system records and/or tallies an ad-exposure-duration during such period(s). Preferably such normal-use monitoring is provided for advertising content that is generated, selected and/or configured by registered advertisers of the system, and made viewable to one or more registered users of the system, such that one or more other checks and balances can be provided to improve accuracy on ad-exposure-duration reportings.

For example, the system can include computer executable instructions for comparing and/or cross-referencing displayed advertising content to determine if, or the degree to which, it relates to or is congruent with typical or most-often accessed types of data and/or subject matter viewed by a user, such as one or more of the following types of data storable in the present system's data storing apparatus, a user's: user-profile data, system-usage records, search-criteria records, ‘History’ records, ‘Bookmark’ records, transaction-related records, commission-related records, interactivity-related records, ‘Favorite’ records, or records of preferred categories and/or subjects, favorite or preferred clouds, location-specific data, GT&C/S-related data, records of menu selections, and the like (any one or more of which are preferably maintained as confidential information and used discreetly for improving or enhancing the accuracy of ad-exposure-duration reportings).

Accordingly, advertisers and their clients can be provided with ad-exposure-duration reporting of their advertising content which is displayed in a viewable condition and can be charged more proportionately and fairly (in a ‘pay-per-view-duration’ manner) for such viewable duration(s), and such reporting can include information pertaining to registered and identified users matching one or more demographic criteria which is of interest to advertisers and/or their clients. Thus, the ratio between advertising content which conventionally would not have been seen and that which is now displayable in a viewable condition is significantly improved, providing enhanced exposure probability and increased awareness of the content. While certain exemplary embodiments of the invention have been described in detail above, it should be recognized that other forms, alternatives, modifications, versions and variations of the invention are equally operative and would be apparent to those skilled in the art. The disclosure is not intended to limit the invention to any particular embodiment, and is intended to embrace all such forms, alternatives, modifications, versions and variations. Accordingly, while this specification, for the sake of clarity and disclosure, at times uses specific terminology and constructs to refer to certain aspects of the invention and its operating environment, it will be recognized that the invention set forth herein is applicable in other areas, as well. For example, this specification frequently refers to the Internet, Web sites, Web pages, and documents; it should be observed that the invention is equally applicable to other types of networks, documents, databases, and document collections. Moreover, references to bookmarks, favorites, defaults and preferences are not intended to be limited to any particular implementation (or set of implementations) for retaining information on users' browsing habits, but instead should be construed to apply to all means and methods for specifying and retaining \9 such information.

1. A method for implementing a network-based, integrated advertising and data searching system and enhancing the advertising exposure probability of transaction-enabling, associative discernible content ‘ADC’ elements proximately arranged on a website, the method comprising:
storing transaction-enabling ADC element-related files in data storing apparatus;
associating geographic location-related data and one or more of the following types of data: subject matter-related data, advertiser/seller-related data and transaction-related data, with each of said transaction-enabling ADC element files and storing the associated data in said data storing apparatus;
providing communication between the network-based, integrated advertising and data searching system, browser-equipped apparatus and data managing software, via a network connection;
displaying within a display area viewable by said browser-equipped apparatus one or more search-related user interface elements configured to accept transaction-enabling ADC element-related search criteria;
executing data managing software to search and select among said transaction-enabling ADC element files and said associated data to display one or more groupings of proximately arranged transaction-enabling ADC elements as advertising on said website based on geographic location-related data and at least one other among said types of data; and
displaying the grouping(s) of transaction-enabling ADC elements in accordance with a geographic location associated with a user to enhance exposure probability and increased awareness of the advertised transaction-enabling ADC elements, and displaying to the user one or more transactionable offerings associated with at least one advertiser/seller in response to user interactivity with any of the ADC elements.

2. The method for implementing a network-based, integrated advertising and data searching system, as recited in claim 1, further comprising:
displaying, via said browser-equipped apparatus, a user registration user-interface element;
receiving and storing user registration information comprising at least user identification-related information, user transaction-related information and one or more user-specified geographic locations of interest;
associating data pertaining to one or more user-specified geographic locations of interest with the geographic location-related data of any of said transaction-enabling ADC element files having the same, proximate or similar associated location(s), and storing the associated data in said data storing apparatus.

3. The method as recited in claim 2, further comprising:
executing the data managing software to search and select among said transaction-enabling ADC element files and said associated data; and
displaying one or more groupings of proximately arranged, location-specific transaction-enabling ADC elements as advertising on said website based on said one or more user-specified geographic locations of interest.

4. The method for implementing a network-based, integrated advertising and data searching system, as recited in claim 1, further comprising:
displaying one or more search-related user interface elements, selectable by a user in a display area of said browser-equipped apparatus, configured to accept a user-definable geographic area range;
executing computer executable instructions to associate, the user-definable geographic area range, with any of said transaction-enabling ADC element files having a geographic location falling within the user-definable range, and storing the associated data in said data storing apparatus.

5. The method as recited in claim 4, further comprising:
executing the data managing software in response to a user-conducted search to select among said transaction-enabling ADC element files and said associated data; and
displaying one or more groupings of proximately arranged, geographic area-related transaction-enabling ADC elements as advertising on said website based on said user-definable geographic area range.

6. The method for implementing a network-based, integrated advertising and data searching system, as recited in claim 1, further comprising:
displaying a choice of user-selectable geographic area ranges in a user-interface element selectively operable by a user,
executing computer executable instructions to associate, a user-selected geographic area range, with any of said transaction-enabling ADC element files having an associated geographic location falling within the user-selected geographic area range, and storing the associated data in said data storing apparatus.

7. The method as recited in claim 6, further comprising:
executing the data managing software in response to a user-conducted search to select among said transaction-enabling ADC element files and said associated data; and
displaying one or more groupings of proximately arranged, geographic area-related transaction-enabling ADC elements as advertising on said website based on said user-selected geographic area range.

8. The method for implementing a network-based, integrated advertising and data searching system, as recited in claim 1, further comprising:
displaying one or more search-related user interface elements, selectable by a user in a display area of said browser-equipped apparatus, configured to accept user-definable search criteria consisting of a geographic territory;
executing computer executable instructions configured to search said transaction-enabling ADC element files and said associated data; and
displaying one or more groupings of proximately arranged, location-related transaction-enabling ADC elements as advertising on said website in accordance with geographic territory criterion.

9. The method for implementing a network-based, integrated advertising and data searching system, as recited in claim 1, further comprising:
displaying one or more search-related user interface elements, selectable by a user in a display area of said browser-equipped apparatus, configured to accept user-definable search criteria consisting of a category or subject;
executing computer executable instructions to search said transaction-enabling ADC element files and said associated data; and
displaying one or more groupings of proximately arranged transaction-enabling ADC elements as advertising on said website in accordance with the category or subject criteria.

10. The method for implementing a network-based, integrated advertising and data searching system, as recited in claim 1, further comprising:
displaying one or more search-related user interface elements, selectable by a user in a display area of said browser-equipped apparatus, configured to accept user-definable search criteria consisting of a geographic territory and a category or subject,
executing computer executable instructions configured to search said transaction-enabling ADC element files and said associated data; and
displaying one or more groupings of proximately arranged transaction-enabling ADC elements as advertising on said website in accordance with the search criteria.

11. The method for implementing a network-based, integrated advertising and data searching system, as recited in claim 1, further comprising:
displaying one search-related user interface element, selectable by a user in a display area of said browser-equipped apparatus, configured to accept user-definable search criteria consisting of a plurality of different search criteria;
executing computer executable instructions to search said transaction-enabling ADC element files and said associated data; and
displaying one or more groupings of proximately arranged transaction-enabling ADC elements as advertising on said website in accordance with the plurality of different search criteria.

12. The method for implementing a network-based, integrated advertising and data searching system, as recited in claim 1, further comprising:
displaying one or more search-related user interface elements, selectable by a user in a display area of said browser-equipped apparatus, configured to display a ‘Favorites’ listing of user-selectable geographic territories;
executing computer executable instructions to search said transaction-enabling ADC element files and said associated data; and
displaying one or more groupings of proximately arranged transaction-enabling ADC elements as advertising on said website in accordance with a geographic territory selected by the user from the Favorites listing.

13. The method for implementing a network-based, integrated advertising and data searching system, as recited in claim 1, further comprising:
displaying one or more search-related user interface elements, selectable by a user in a display area of said browser-equipped apparatus, configured to display a ‘History’ listing of user-selectable geographic territories;
executing computer executable instructions to search said transaction-enabling ADC element files and said associated data; and
displaying one or more groupings of proximately arranged transaction-enabling ADC elements as advertising on said website in accordance with a geographic territory selected by the user from the History listing.

14. The method for implementing a network-based, integrated advertising and data searching system, as recited in claim 1, further comprising:
displaying one or more search-related user interface elements, selectable by a user in a display area of said browser-equipped apparatus, configured to display a category ‘Favorites’ listing of user-selectable categories;
executing computer executable instructions to search said transaction-enabling ADC element files and said associated data; and
displaying one or more groupings of proximately arranged transaction-enabling ADC elements as advertising on said website in accordance with a category selected by the user from the Favorites listing.

15. The method for implementing a network-based, integrated advertising and data searching system, as recited in claim 1, further comprising:
displaying one or more search-related user interface elements, selectable by a user in a display area of said browser-equipped apparatus, configured to display a subject ‘History’ listing of user-selectable categories;
executing computer executable instructions to search said transaction-enabling ADC element files and said associated data; and
displaying one or more groupings of proximately arranged transaction-enabling ADC elements as advertising on said website in accordance with a category selected by the user from the History listing.

16. The method for implementing a network-based, integrated advertising and data searching system, as recited in claim 1, further comprising:
displaying one or more search-related user interface elements, selectable by a user in a display area of said browser-equipped apparatus, configured to display a subject ‘Favorites’ listing of user-selectable subjects;
executing computer executable instructions to search said transaction-enabling ADC element files and said associated data; and
displaying one or more groupings of proximately arranged transaction-enabling ADC elements as advertising on said website in accordance with a subject selected by the user from the Favorites listing.

17. The method for implementing a network-based, integrated advertising and data searching system, as recited in claim 1, further comprising:
displaying one or more search-related user interface elements, selectable by a user in a display area of said browser-equipped apparatus, configured to display a subject ‘History’ listing of user-selectable subjects;
executing computer executable instructions to search said transaction-enabling ADC element files and said associated data; and
displaying one or more groupings of proximately arranged transaction-enabling ADC elements as advertising on said website in accordance with a subject selected by the user from the History listing.

18. The method for implementing a network-based, integrated advertising and data searching system, as recited in claim 1, further comprising:
displaying one or more search-related user interface elements, selectable by a user in a display area of said browser-equipped apparatus, configured to display one or more user-selectable geographic territory and category or subject ‘Default’ choices;
executing computer executable instructions to search said transaction-enabling ADC element files and said associated data; and
displaying one or more groupings of proximately arranged transaction-enabling ADC elements as advertising on said website in accordance with the Default setting choice(s) made by the user.

19. The method for implementing a network-based, integrated advertising and data searching system, as recited in claim 1, further comprising:
displaying one or more search-related user interface elements, selectable by a user in a display area of said browser-equipped apparatus, configured to display one or more user-definable geographic territory and category or subject ‘Preferences’ or Setup settings;
executing computer executable instructions to search said transaction-enabling ADC element files and said associated data; and
displaying one or more groupings of proximately arranged transaction-enabling ADC elements as advertising on said website in accordance with the Preferences or Setup setting choice(s) made by the user.

20. The method for implementing a network-based, integrated advertising and data searching system, as recited in claim 1, further comprising:
displaying one or more search-related user interface elements, selectable by a user in a display area of said browser-equipped apparatus, configured to accept one or more user-definable geographic territory and category or subject settings; and
co-locating the one or more search-related user interface elements adjacent or proximate to said one or more groupings of proximately arranged transaction-enabling ADC elements on said website.

21. The method as recited in claim 20, further comprising:
positioning and simultaneously displaying said user-interface element(s) and said one or more groupings of proximately arranged transaction-enabling ADC elements in a single user interface ‘SUI’, display area or webpage on said website.

22. The method for implementing a network-based, integrated advertising and data searching system, as recited in claim 1, further comprising:
displaying one or more groupings of proximately arranged transaction-enabling ADC elements comprising a plurality or numerous text-only ADC elements each equipped to display transaction-enabling information, associated with at least one advertiser/seller, to a user in response to input received from a user input device.

23. The method as recited in claim 22, further comprising:
interacting with a single text-only transaction-enabling ADC element to cause a displaying to a user of an option to play one or more data-files associated with the ADC element, comprising one or more among the following types of digital data-files: video files, audio files, MP3 files, compressed multimedia files, podcasts, commercials and infomercials.

24. The method for implementing a network-based, integrated advertising and data searching system, as recited in claim 1, further comprising:
displaying one or more groupings of proximately arranged transaction-enabling ADC elements are comprised partly, or entirely, of a plurality of non-text, graphically depicted ADC elements each equipped to display transaction-enabling information, associated with at least one advertiser/seller, to a user in response to input received from a user input device.

25. The method as recited in claim 24, further comprising:
interacting with a single non-text, graphically-represented transaction-enabling ADC element to cause a displaying to a user of an option to play one or more data-files associated with the ADC element, comprising one or more among the following types of digital data-files: video files, audio files, MP3 files, compressed multimedia files, podcasts, commercials and infomercials.

26. The method for implementing a network-based, integrated advertising and data searching system, as recited in claim 1, further comprising:
simultaneously displaying in a single user interface ‘SUI’, display area or webpage of said website one or more groupings of transaction-enabling ADC elements, at least one co-locatable software application tool ‘CSAT’, and one or more search-related user interface elements configured to accept search-related input from a user input device adjacent, proximate or within a menu of the one or more webpages.

27. The method for implementing a network-based, integrated advertising and data searching system, as recited in claim 1, further comprising:
simultaneously displaying in a single user interface ‘SUI’, display area or webpage of said website one or more groupings of transaction-enabling ADC elements, at least one CSAT, and one or more search-related user interface elements configured to accept search-related input from a user input device adjacent, proximate or within a menu of each CSAT.

28. The method for implementing a network-based, integrated advertising and data searching system, as recited in claim 1, further comprising:
receiving via one or more user interface elements and storing in said data storing apparatus, user-specific transaction-related information employable in the completing of orders placed by a user for one or more of said transactionable offerings.

29. The method for implementing a network-based, integrated advertising and data searching system, as recited in claim 1, further comprising:
receiving via one or more user interface elements and storing in said data storing apparatus, advertiser/seller-specific transaction-related information pertaining to an order placed by a user for one or more of said transactionable offerings.

30. The method for implementing a network-based, integrated advertising and data searching system, as recited in claim 1, further comprising:
receiving via one or more user interface elements and storing in said data storing apparatus, advertiser/seller-specific transaction-related information pertaining to an order placed by an advertiser/seller for transaction-enabling ADC element-related content.

31. The method for implementing a network-based, integrated advertising and data searching system, as recited in claim 1, further comprising:
associating content generated in, or inputted into, a CSAT by a user, with one or more of the following criteria: a geographic area, a category, or a subject;
storing the CSAT content and associated content in a manner accessible by, and displayable in, at least one CSAT;
associating one or more transaction-facilitating ADC elements configurable by an advertiser/seller and displayable in a grouping or cloud-like arrangement, with the one or more criteria;
simultaneously displaying within a single user interface ‘SUI’, browser displayable area, or webpage, in accordance with the one or more criteria: a grouping or cloud-like arrangement of transaction-facilitating ADC elements, a CSAT and CSAT content, and one or more text-based elements equipped for interactivity within the CSAT content;
displaying one or more transactionable offerings, for a product, service or activity associated with at least one advertiser/seller, in response to input made via a user input device with one of said text-based elements; and
displaying a user interface component equipped for completing one or more secure payment arrangements pertaining to the one or more transactionable offerings.

32. The method as recited in claim 31, further comprising:
monitoring and recording user interaction pertaining to said text-based elements; and
providing compensation to a registered CSAT-content generator from an advertiser/seller, for each user interactivity pertaining to, or each user payment deriving from, monitored and recorded user interaction with said text-based elements.

33. The method for implementing a network-based, integrated advertising and data searching system, as recited in claim 1, further comprising:
associating and storing one or more words, or word phrases chosen by an advertiser/seller, with the advertiser/seller;
associating and storing CSAT-generated content with one or more of the following data-file identifiers: a CSAT-user/content-generator data-file identifier; a CSAT-content geographic area-specific data-file identifier; a CSAT-content category or subject data-file identifier;
conducting a search based on one or more search criteria to determine matching, or similar word(s), or word phrase(s) associated with one or more advertisers/sellers and one or more data-file identifiers; and
displaying one or more transaction-facilitating CSAT-displayable words, or word phrases, each associated with one or more advertisers/sellers as a transaction-facilitating, interactive text-based element within the displayed content of at least one CSAT.

34. The method as recited in claim 32, further comprising:
displaying information pertaining to one or more products, services or activities associated with at least one advertiser/seller, in response to input made via a user input device with one of said transaction-facilitating, interactive text-based elements.

35. The method as recited in claim 32, further comprising:
displaying transactionable offerings, for one or more products, services or activities associated with at least one advertiser/seller, in response to input made via a user input device with one of said transaction-facilitating, interactive text-based elements; and
displaying a user interface component equipped for completing one or more secure payment arrangements pertaining to the one or more transactionable offerings.

36. The method as recited in claim 32, wherein one or more of said text-based elements is configured as a multi-transaction enabled text-based element of a CSAT, wherein input made via a user input device with one of said a multi-transaction enabled text-based elements causes a displaying of a plurality of transactionable offerings, for one or more products, services or activities, each of said offerings associated with one of a plurality of different advertisers/sellers.

37. The method for implementing a network-based, integrated advertising and data searching system, as recited in claim 1, further comprising:
displaying one or more non-text, graphically depicted elements within CSAT-content of proximately arranged transaction-enabling ADC elements are comprised partly, or entirely, of a plurality of non-text, graphically depicted ADC

38. The method for implementing a network-based, integrated advertising and data searching system, as recited in claim 1, further comprising:
associating and storing one or more non-text, graphically depicted elements chosen by an advertiser/seller, with the advertiser/seller;
associating and storing the each non-text, graphically depicted element with at least one associated non-text data-file identifier which pertains to a geographic area and a category or subject;
associating and storing CSAT-generated content with one or more of the following data-file identifiers: a CSAT-user/content-generator data-file identifier; a CSAT-content geographic area-specific data-file identifier; a CSAT-content category or subject data-file identifier;
conducting a search based on one or more search criteria to determine matching, or similar non-text, graphically depicted elements associated with one or more advertisers/sellers and one or more of the data-file identifiers; and
displaying one or more transaction-facilitating CSAT-displayable non-text elements, each associated with one or more advertisers/sellers as a transaction-facilitating, interactive non-text element within the displayed content of at least one CSAT.

39. A method for implementing a network-based, integrated advertising and data searching system and enhancing the advertising exposure probability of transaction-facilitating, associative discernible content ‘ADC’ elements proximately arranged on a website,
the method comprising:
storing ADC element-related files in data storing apparatus;
associating geographic location-related data and one or more of the following types of data: subject matter-related data, advertiser/seller-related data and transaction-related data, with each of said ADC element files and storing the associated data in said data storing apparatus;
providing communication between the network-based, integrated advertising and data searching system, browser-equipped apparatus and data managing software, via a network connection;
displaying within a display area viewable by said browser-equipped apparatus one or more search-related user interface elements configured to accept ADC element-related search criteria;
executing data managing software for searching and selecting among said transaction-facilitating, ADC element files and said associated data to display one or more groupings of proximately arranged ADC elements as advertising on said website based on geographic location-related data or at least one other among said types of data.

40. The method as recited in claim 39, further comprising:
displaying the grouping(s) of transaction-facilitating ADC elements in accordance with a geographic location associated with a user to enhance exposure probability and increased awareness of the advertised transaction-facilitating, location-related ADC elements, and displaying to the user one or more transactionable offerings associated with at least one advertiser/seller in response to user interactivity with any of the ADC elements.

41. The method as recited in claim 39, further comprising:
displaying the grouping(s) of transaction-facilitating ADC elements in accordance with a geographic area and a category or subject determined by a user, to enhance exposure probability and increased awareness of the advertised transaction-facilitating, ADC elements, and displaying to the user one or more transactionable offerings associated with at least one advertiser/seller in response to user interactivity with any of the ADC elements.

42. The method as recited in claim 41, further comprising:
displaying to an advertiser/seller, a user interface component equipped for completing one or more secure payment arrangements pertaining to a configuring and displaying of one or more transaction-facilitating, ADC elements associated with the advertiser/seller.

43. The method as recited in claim 41, further comprising:
displaying to a user, a user interface element equipped for completing one or more secure payment arrangements pertaining to one or more transactionable offerings for a product, service or activity associated with at least one advertiser/seller.

44. The method as recited in claim 43, further comprising:
calculating and deducting a commission or transaction fee derived from, and paying the at least one advertiser/seller from, the one or more secure payment arrangements.

45. A network-based, integrated advertising and data searching system for enhancing the exposure probability of transaction-enabling, associative discernible content ‘ADC’ elements proximately displayable on a website, comprising:
data storing apparatus configured to store transaction-enabling ADC element related files;
computer executable instructions which associate geographic location-related data and one or more of the following types of data: subject matter-related data, advertiser/seller-related data and transaction-related data, with each of said transaction-enabling ADC element files and store the associated data in said data storing apparatus;
browser-equipped apparatus and data managing software having communication with said network-based, integrated advertising and data searching system via a network connection, and one or more search-related user interface elements displayable by said browser-equipped apparatus configured to accept transaction-enabling ADC element-related search criteria;
each of said transaction-enabling ADC elements configured for user interactivity and to display one or more transactionable offerings associated with at least one advertiser/seller in response to input received from a user input device;
said data managing software configured to search and select among said transaction-enabling ADC element files and said associated data, to display one or more groupings of proximately arranged transaction-enabling ADC elements as advertising on said website based on geographic location-related data and at least one other among said types of data; and
computer executable instructions to display the one or more groupings of transaction-enabling ADC elements in accordance with one or more geographic locations associated with a user to enhance exposure probability and increased awareness of the advertised transaction-enabling location-related ADC elements of grouping(s), and transaction-enabling information displayed to the user in response to user interactivity with any of the displayed ADC elements.

46. The network-based, integrated advertising and data searching system as recited in claim 45, further comprising, said one or more user interface elements including a user registration user-interface element displayable to a user by said browser-equipped apparatus, configured to receive and store user registration information comprising at least user identification-related information and one or more user-specified geographic locations of interest; and computer executable instructions, which, when executed, associate the one or more user-specified geographic locations of interest with the geographic location-related data of any of said transaction-enabling ADC element files having the same, proximate or similar associated location(s), and store the associated data in said data storing apparatus.

47. The network-based, integrated advertising and data searching system as recited in claim 46, further comprising, data managing software configured to search and select among said transaction-enabling ADC element files and said associated data to display one or more groupings of proximately arranged, geographic area-related transaction-enabling ADC elements as advertising on said website based on said one or more user-specified geographic locations of interest.

48. The network-based, integrated advertising and data searching system as recited in claim 45, further comprising, one or more search-related user interface elements displayable by said browser-equipped apparatus selectively employable by a user, configured to accept user-definable geographic area range input; and computer executable instructions, which, when executed, associate the user-definable geographic area range with any of said transaction-enabling ADC element files having a geographic location falling within the user-definable range, and store the associated data in said data storing apparatus.

49. The network-based, integrated advertising and data searching system as recited in claim 48, further comprising, data managing software configured to search and select among said transaction-enabling ADC element files and said associated data to display one or more groupings of proximately arranged, geographic area-related transaction-enabling ADC elements as advertising on said website based on said user-definable geographic area range.

50. The network-based, integrated advertising and data searching system as recited in claim 45, further comprising, one or more search-related user interface elements displayable by said browser-equipped apparatus, and selectively employable by a user, configured to display a choice of user-selectable geographic area ranges; and computer executable instructions, which, when executed, associate any of said transaction-enabling ADC element files having an associated geographic location falling within a user-selected geographic area range, and store the associated data in said data storing apparatus.

51. The network-based, integrated advertising and data searching system as recited in claim 50, further comprising, data managing software configured to search and select among said transaction-enabling ADC element files and said associated data to display one or more groupings of proximately arranged, geographic area-related transaction-enabling ADC elements as advertising on said website based on said user-selected geographic area range.

52. The network-based, integrated advertising and data searching system as recited in claim 45, further comprising, one or more search-related user interface elements displayable by said browser-equipped apparatus selectively employable by a user, configured to accept user-definable search criteria consisting of a geographic territory; and computer executable instructions, which, when executed, search said transaction-enabling ADC element files and said associated data to display one or more groupings of proximately arranged, location-related transaction-enabling ADC elements as advertising on said website in accordance with the geographic territory criterion.

53. The network-based, integrated advertising and data searching system as recited in claim 45, further comprising, one or more search-related user interface elements displayable by said browser-equipped apparatus and selectively employable by a user, configured to accept user-definable search criteria consisting of a category or subject; and computer executable instructions, which, when executed, search said transaction-enabling ADC element files and said associated data to display one or more groupings of proximately arranged transaction-enabling ADC elements as advertising on said website in accordance with the category or subject criteria.

54. The network-based, integrated advertising and data searching system as recited in claim 45, further comprising, one or more search-related user interface elements displayable by said browser-equipped apparatus and selectively employable by a user, configured to accept user-definable search criteria consisting of a geographic territory and a category or subject; and computer executable instructions, which, when executed, search said transaction-enabling ADC element files and said associated data to display one or more groupings of proximately arranged transaction-enabling ADC elements as advertising on said website in accordance with the search criteria.

55. The network-based, integrated advertising and data searching system as recited in claim 45, wherein said one or more search-related user interface elements consists of a single search-related user interface element displayable by said browser-equipped apparatus and selectively employable by a user, configured to accept user-definable search criteria consisting of a plurality of different search criteria; and computer executable instructions, which, when executed, search said transaction-enabling ADC element files and said associated data to display one or more groupings of proximately arranged transaction-enabling ADC elements as advertising on said website in accordance with the plurality of different search criteria.

56. The network-based, integrated advertising and data searching system as recited in claim 45, further comprising, one or more search-related user interface elements displayable by said browser-equipped apparatus and selectively employable by a user, configured to display a ‘Favorites’ listing of user-selectable geographic territories; and computer executable instructions, which, when executed, search said transaction-enabling ADC element files and said associated data to display one or more groupings of proximately arranged transaction-enabling ADC elements as advertising on said website in accordance with a geographic territory selected by the user from the Favorites listing.

57. The network-based, integrated advertising and data searching system as recited in claim 45, further comprising, one or more search-related user interface elements displayable by said browser-equipped apparatus and selectively employable by a user, configured to display a ‘History’ listing of user-selectable geographic territories; and computer executable instructions, which, when executed, search said transaction-enabling ADC element files and said associated data to display one or more groupings of proximately arranged transaction-enabling ADC elements as advertising on said website in accordance with a geographic territory selected by the user from the History listing.

58. The network-based, integrated advertising and data searching system as recited in claim 45, further comprising, one or more search-related user interface elements displayable by said browser-equipped apparatus and selectively employable by a user, configured to display a category ‘Favorites’ listing of user-selectable categories; and computer executable instructions, which, when executed, search said transaction-enabling ADC element files and said associated data to display one or more groupings of proximately arranged transaction-enabling ADC elements as advertising on said website in accordance with a category selected by the user from the Favorites listing.

59. The network-based, integrated advertising and data searching system as recited in claim 45, further comprising, one or more search-related user interface elements displayable by said browser-equipped apparatus and selectively employable by a user, configured to display a subject ‘History’ listing of user-selectable categories; and computer executable instructions, which, when executed, search said transaction-enabling ADC element files and said associated data to display one or more groupings of proximately arranged transaction-enabling ADC elements as advertising on said website in accordance with a category selected by the user from the History listing.

60. The network-based, integrated advertising and data searching system as recited in claim 45, further comprising, one or more search-related user interface elements displayable by said browser-equipped apparatus and selectively employable by a user, configured to display a subject ‘Favorites’ listing of user-selectable subjects; and computer executable instructions, which, when executed, search said transaction-enabling ADC element files and said associated data to display one or more groupings of proximately arranged transaction-enabling ADC elements as advertising on said website in accordance with a subject selected by the user from the Favorites listing.

61. The network-based, integrated advertising and data searching system as recited in claim 45, further comprising, one or more search-related user interface elements displayable by said browser-equipped apparatus and selectively employable by a user, configured to display a subject ‘History’ listing of user-selectable subjects; and computer executable instructions, which, when executed, search said transaction-enabling ADC element files and said associated data to display one or more groupings of proximately arranged transaction-enabling ADC elements as advertising on said website in accordance with a subject selected by the user from the History listing.

62. The network-based, integrated advertising and data searching system as recited in claim 45, further comprising, one or more search-related user interface elements displayable by said browser-equipped apparatus and selectively employable by a user, configured to display one or more user-selectable geographic territory and category or subject ‘Default’ choices; and computer executable instructions, which, when executed, search said transaction-enabling ADC element files and said associated data to display one or more groupings of proximately arranged transaction-enabling ADC elements as advertising on said website in accordance with the Default setting choice(s) made by the user.

63. The network-based, integrated advertising and data searching system as recited in claim 45, further comprising, one or more search-related user interface elements displayable by said browser-equipped apparatus and selectively employable by a user, configured to display one or more user-definable geographic territory and category or subject ‘Preferences’ or Setup settings; and computer executable instructions, which, when executed, search said transaction-enabling ADC element files and said associated data to display one or more groupings of proximately arranged transaction-enabling ADC elements as advertising on said website in accordance with the Preferences or Setup setting choice(s) made by the user.

64. The network-based, integrated advertising and data searching system as recited in claim 45, further comprising, one or more search-related user interface elements displayable by said browser-equipped apparatus selectively employable by a user, configured to accept one or more user-definable geographic territory and category or subject settings; said search-related user interface element(s) co-locatably inter-operable adjacent or proximate to said one or more groupings of proximately arranged transaction-enabling ADC elements on said website.

65. The network-based, integrated advertising and data searching system as recited in claim 64 wherein said user-interface element(s) is positionable, and simultaneously displayable, in a single user interface ‘SUI’, display area, or webpage, configured to display said one or more groupings of proximately arranged transaction-enabling ADC elements on said website.

66. The network-based, integrated advertising and data searching system as recited in claim 45 wherein each of said one or more groupings of proximately arranged transaction-enabling ADC elements comprises a plurality, or numerous, text-only ADC elements each equipped to display to a user, one or more transactionable offerings associated with at least one advertiser/seller, in response to input received from a user input device.

67. The network-based, integrated advertising and data searching system as recited in claim 65, further comprising, user input device interaction with a single text-only transaction-enabling ADC element causing a displaying to a user of the option to play one or more data-files associated with the ADC element, comprising one or more among the following types of digital data-files: video files, audio files, MP3 files, compressed multimedia files, podcasts, commercials and infomercials.

68. The network-based, integrated advertising and data searching system as recited in claim 45, wherein said one or more groupings of proximately arranged transaction-enabling ADC elements are comprised partly, or entirely, of a plurality of non-text, graphically-represented ADC elements each equipped to display to a user, one or more transactionable offerings associated with at least one advertiser/seller, in response to input received from a user input device.

69. The network-based, integrated advertising and data searching system as recited in claim 68, further comprising, user input device interaction with a single non-text, graphically-represented transaction-enabling ADC element causing a displaying to a user of the option to play one or more data-files associated with the transaction-enabling ADC element comprising one or more among the following types of digital data-files: video files, audio files, MP3 files, compressed multimedia files, podcasts, commercials and infomercials.

70. The network-based, integrated advertising and data searching system as recited in claim 45, further comprising, said website having one or more webpages each equipped to simultaneously display one or more groupings of transaction-enabling ADC elements, at least one co-locatable software application tool ‘CSAT’, and one or more search-related user interface elements configured to accept search-related input from a user input device, and said search-related user interface element(s) operable adjacent, proximate or within a menu of the one or more webpages.

71. The network-based, integrated advertising and data searching system as recited in claim 45, further comprising, said website having one or more webpages equipped to simultaneously display one or more groupings of transaction-enabling ADC elements, at least one CSAT, and one or more search-related user interface elements configured to accept search-related input from a user input device, and said one or more search-related user interface elements operable adjacent, proximate or within a menu of each CSAT.

72. The network-based, integrated advertising and data searching system as recited in claim 45, further comprising, one or more user interface elements configured to receive and store user-specific transaction-related information employable in the completing of orders placed by a user for one or more of said transactionable offerings.

73. The network-based, integrated advertising and data searching system as recited in claim 45, further comprising, one or more user interface elements configured to receive and store advertiser/seller-specific transaction-related information pertaining to an order placed by a user for one or more of said transactionable offerings.

74. The network-based, integrated advertising and data searching system as recited in claim 45, further comprising, one or more user interface elements configured to receive and store advertiser/seller-specific transaction-related information pertaining to an order placed by an advertiser/seller for transaction-enabling ADC element-related content.

75. The network-based, integrated advertising and data searching system as recited in claim 45, further comprising, computer executable instructions which, when executed, cause said browser-equipped apparatus to display the proximately arranged transaction-enabling ADC elements in a word-cloud like arrangement, based on geographic location-related data associated with or entered by a user, and at least one other among said types of data.

76. The network-based, integrated advertising and data searching system as recited in claim 45, wherein each of the transaction-enabling ADC elements of the word-cloud like arrangement consists of a terse suggestive or associative word, or words, pertaining to one or more transactionable offerings for one or more products, services or activities associated with at least one advertiser/seller.

77. The network-based, integrated advertising and data searching system as recited in claim 75, further comprising, selecting among a plurality of word-cloud like arrangements or ‘word-clouds’ storable in a memory or memory buffer, displayable in a single user interface ‘SUI’, browser displayable area, or webpage, each cloud comprised of interactive, transaction-enabling ADC elements, and each word-cloud having a displayable, reduced-size user interface element associated with the word-cloud configured to display a desired word-cloud in response to a user input device interaction with a reduced-size user interface element associated with the word-cloud.

78. The network-based, integrated advertising and data searching system as recited in claim 77, wherein each reduced-size user interface element associated with a word-cloud consists of at least one of the following: a single small word-cloud icon; a selectable small icon within a matrix of similar icons; a titled-tab located proximate or adjacent to a word-cloud displaying area or window; a selectable titled-tab located among a plurality titled-tabs located proximate or adjacent to a cloud display area or window.

79. The network-based, integrated advertising and data searching system as recited in claim 74, wherein the word-cloud like arrangement consisting of transaction-enabling ADC elements appears within a viewable display area and the display area user interface element is configured with one or more scroll bars for scrolling the content of the word-cloud like arrangement.

80. The network-based, integrated advertising and data searching system as recited in claim 45, further comprising said browser-equipped apparatus configured for wireless communication with the networked-system including one or more of the following wireless communication devices: cell phones, wireless PDAs, wireless handheld devices, laptops, computing devices equipped for wireless communication, and portable computing devices equipped for wireless communication.

81. The network-based, integrated advertising and data searching system as recited in claim 45, further comprising, said browser-equipped apparatus configured to receive input from a user input device including one or more of the following: a touch-screen, a microphone, a microphone and voice-recognition software, a microphone and voice-command software, an OCR enabled device and OCR software equipped to read machine printed or hand-written text.

82. The network-based, integrated advertising and data searching system as recited in claim 45, further comprising, at least one projector equipped to receive ADC-related projectable content, whereby the content is projectable onto an indoor or outdoor surface.

83. The network-based, integrated advertising and data searching system as recited in claim 45, further comprising, printable ‘offline’ ADC elements, whereby the content is printable for inclusion in one or more printable media.

84. The network-based, integrated advertising and data searching system as recited in claim 45, further comprising:
one or more co-locatable software application tools ‘CSATs’ displayable proximate, adjacent to, or within the same user interface as, said one or more groupings of proximately arranged transaction-enabling ADC elements;
each of the one or more CSATs equipped to store, access and display CSAT-content generated in, or inputted into, a CSAT by a user, and associate the CSAT-content with one or more of the following criteria: a geographic area, a category, or a subject;
one or more transaction-facilitating ADC elements configurable by an advertiser/seller and displayable in a grouping or cloud-like arrangement, in accordance with the one or more criteria;
a single user interface ‘SUI’, browser displayable area, or webpage, equipped to simultaneously display in accordance with the one or more criteria: a grouping or cloud-like arrangement of transaction-facilitating ADC elements, a CSAT and CSAT content, and one or more text-based elements configured for interactivity within the CSAT content;
each of said text-based elements equipped to display one or more transactionable offerings, for a product, service or activity associated with at least one advertiser/seller, in response to input made via a user input device with one of said text-based elements; and
a user interface component equipped for completing one or more secure payment arrangements pertaining to the one or more transactionable offerings.

85. The network-based, integrated advertising and data searching system as recited in claim 84, further comprising:
computer executable instructions for monitoring user interaction pertaining to said text-based elements and for providing compensation to a registered CSAT-content generator or CSAT-content displayer from an advertiser/seller, for each user interactivity pertaining to, or each user payment deriving from the monitored user interaction with said text-based elements.

86. The network-based, integrated advertising and data searching system as recited in claim 84, further comprising:
computer executable instructions, for associating of one or more words, or word phrases chosen by different advertisers/sellers, with each advertiser/seller, and for associating and storing CSAT-generated content with one or more of the following data-file identifiers: a CSAT-user/content-generator data-file identifier; a CSAT-content geographic area-specific data-file identifier; a CSAT-content category or subject data-file identifier;
a co-locatable search conducting user interface element configured to conduct a search based on one or more search criteria to determine a matching, or a similarity, of said word(s), or word phrase(s) associated with one or more advertisers/sellers and one or more data-file identifiers; and
one or more transaction-facilitating, interactive text-based elements configured to display content of at least one CSAT, and one or more transaction-facilitating CSAT-displayable words, or word phrases, each associated with one or more advertisers/sellers.

87. The network-based, integrated advertising and data searching system as recited in claim 84, further comprising:
each of said transaction-facilitating, interactive text-based elements configured to display information pertaining to a product, service or activity associated with at least one advertiser/seller, in response to input made via a user input device.

88. The network-based, integrated advertising and data searching system as recited in claim 84, further comprising:
each of said transaction-facilitating, interactive text-based elements configured to display information pertaining to a product, service or activity associated with at least one advertiser/seller, in response to input made via a user input device; and
a user interface component displayable in response to the user input device input, equipped to complete one or more secure payment arrangements pertaining to the one or more transactionable offerings.

89. The network-based, integrated advertising and data searching system as recited in claim 45, further comprising:
one or more co-locatable software application tools ‘CSATs’ displayable proximate, adjacent to, or within the same user interface as, said one or more groupings of proximately arranged transaction-enabling ADC elements;
each of the one or more CSATs equipped to store, access and display CSAT-content generated in, or inputted into, a CSAT by a user, and associate the CSAT-content with one or more of the following criteria: a geographic area, a category, or a subject;
computer executable instructions, which, when executed cause a displaying of one or more ADC elements based on said criteria in at least one cloud-like arrangement co-locatable within the same, single user interface, browser displayable area, or webpage as the CSAT.

90. The network-based, integrated advertising and data searching system as recited in claim 89, further comprising, one or more of said ADC elements configured as transaction-enabled elements and equipped to display one or more transactionable offerings; and, a user interface component equipped for completing one or more secure payment arrangements pertaining to the one or more transactionable offerings.

91. The network-based, integrated advertising and data searching system as recited in claim 45, further comprising, computer executable instructions, which, when executed, limit transaction-related and commission-related activities to registered users.

92. The network-based, integrated advertising and data searching system as recited in claim 91, further comprising, computer executable instructions, which, when executed: limit the generating, storing and associating of CSAT-content, and the inclusion of interactive revenue-generating elements ‘IRGEs’ within CSATs to registered users; monitor the frequency or redundancy of CSAT-generated or displayable content, thereby enhancing fraud-reduction, which can otherwise occur with browser generated or browser-displayable content that is created without being monitored and associated with a specific user.

93. The network-based, integrated advertising and data searching system as recited in claim 45, further comprising,
computer executable instructions, which, when executed, provide one or more authorized websites external to the system access to:
data storing apparatus configured to store transaction-enabling ADC element related files;
computer executable instructions which associate geographic location-related data and one or more of the following types of data: subject matter-related data, advertiser/seller-related data and transaction-related data, with each of said transaction-enabling ADC element files and store the associated data in said data storing apparatus;
browser-equipped apparatus and data managing software having a network connection, and one or more search-related user interface elements displayable by said browser-equipped apparatus configured to accept transaction-enabling ADC element-related search criteria;
each of said transaction-enabling ADC elements configured for user interactivity and to display one or more transactionable offerings associated with at least one advertiser/seller in response to input received from a user input device;
said data managing software configured to search and select among said transaction-enabling ADC element files and said associated data, to display one or more groupings of proximately arranged transaction-enabling ADC elements as advertising on said website based on geographic location-related data and at least one other among said types of data; and
computer executable instructions to display the one or more groupings of transaction-enabling ADC elements in accordance with one or more geographic locations associated with a user to enhance exposure probability and increased awareness of the advertised transaction-enabling location-related ADC elements of grouping(s), and transaction-enabling information displayed to the user in response to user interactivity with any of the displayed ADC elements.

94. A network-based, integrated advertising and data searching system for enhancing the exposure probability of transaction-enabling, associative discernible content ‘ADC’ elements proximately displayable on a website, comprising:
data storing apparatus configured to store transaction-enabling ADC element related files;
computer executable instructions which associate geographic location-related data and one or more of the following types of data: subject matter-related data, advertiser/seller-related data and transaction-related data, with each of said transaction-enabling ADC element files and store the associated data in said data storing apparatus;
browser-equipped apparatus and data managing software having communication with said network-based, integrated advertising and data searching system via a network connection, and one or more search-related user interface elements displayable by said browser-equipped apparatus configured to accept transaction-enabling ADC element-related search criteria;
each of said transaction-enabling ADC elements configured for user interactivity and to display one or more transactionable offerings associated with at least one advertiser/seller in response to input received from a user input device;
said data managing software configured to search and select among said transaction-enabling ADC element files and said associated data, to display one or more groupings of proximately arranged transaction-enabling ADC elements as advertising on said website based on geographic location-related data or at least one other among said types of data.

95. The network-based, integrated advertising and data searching system as recited in claim 94, further comprising, computer executable instructions to display the one or more groupings of transaction-enabling ADC elements in accordance with one or more geographic locations associated with a user to enhance exposure probability and increased awareness of the advertised transaction-enabling, location-related ADC elements of the grouping(s), and transaction-enabling information displayed to the user in response to user interactivity with any of the displayed ADC elements.

96. The network-based, integrated advertising and data searching system as recited in claim 94, further comprising, computer executable instructions to display the one or more groupings of transaction-enabling ADC elements in accordance with one or more geographic locations associated with a user to enhance exposure probability and increased awareness of the advertised transaction-enabling, location-related ADC elements of the grouping(s), and transaction-enabling information displayed to the user in response to user interactivity with any of the displayed ADC elements.

97. The network-based, integrated advertising and data searching system as recited in claim 45, further comprising, transaction-enabling ADC elements displayable in said one or more groupings being comprised of text and computer executable instructions, which, when executed, present a variety of text-editing or text-configuring choices to an advertiser/seller to configure any transaction-enabling ADC text to an advertiser's/seller's liking.

98. The network-based, integrated advertising and data searching system as recited in claim 45, further comprising, displaying and positioning transaction-enabling ADC elements more prominently within an ADC grouping, or ADC word-cloud like arrangement, in accordance with the amount of a ADC element display fee paid.

99. The network-based, integrated advertising and data searching system as recited in claim 45, further comprising, displaying and positioning transaction-enabling ADC elements more prominently within an ADC grouping, or ADC word-cloud like arrangement, in accordance with the amount of activity or user interaction an ADC element receives.

100. The network-based, integrated advertising and data searching system of claim 1 further comprising one or more co-locatable software application tools ‘CSATs’ selectively openable by a user and simultaneously displayable by said browser-equipped apparatus adjacent or proximate to said one or more groupings of proximately arranged transaction-enabling ADC elements and each CSAT of the system configured to accept, store, access and display digitally-storable content generated or inputted by a user.

101. A network-based, integrated advertising and data searching system for enhancing the exposure probability of transaction-facilitating, associative discernible content ‘ADC’ elements proximately displayable on a website, comprising:
data storing apparatus configured to store transaction-facilitating ADC element files;
computer executable instructions configured to associate geographic location-related data and one or more of the following types of data: subject matter-related data, advertiser/seller-related data and transaction-related data, with each of said transaction-facilitating ADC element files and store the associated data in said data storing apparatus;
browser-equipped apparatus and data managing software having communication with said network-based, integrated advertising and data searching system via a network connection, and one or more user interface elements displayable by said browser-equipped apparatus configured to accept search criteria;
said transaction-facilitating ADC elements configured for user interactivity to display ADC-associated information in response to input received from a user input device;
said data managing software configured to search and select among said transaction-facilitating ADC element files and said associated data to display one or more groupings of proximately arranged transaction-facilitating ADC elements on said website based on search criteria which includes geographic location-related data associated with a user and at least one other among said types of data; and
displaying the grouping(s) of transaction-facilitating ADC elements in accordance with a geographic location of interest to a user to enhance exposure probability and increased awareness of the advertised transaction-facilitating ADC elements and transaction-facilitating information displayed in response to user interactivity with any of the displayed ADC elements.

102. The network-based, integrated advertising and data searching system as recited in claim 101, further comprising, a CSAT equipped to accept and store one or more configurings of a transaction-facilitating ADC element made by an advertiser/seller; and,
computer executable instructions, which, when executed, display the advertiser/seller-configured transaction-facilitating ADC element within one or more groupings of proximately arranged transaction-facilitating ADC elements on said website.
